(19) United States
(12) Patent Application Publication
(10) Pub. No.: US 2020/0279708 A1
(43) Pub. Date: Sep. 3, 2020

(54) CONTACT DEVICE AND ELECTROMAGNETIC RELAY EQUIPPED WITH CONTACT DEVICE

(71) Applicant: PANASONIC INTELLECTUAL PROPERTY MANAGEMENT CO., LTD., Osaka (JP)

(72) Inventor: Masahiro ITO, Hyogo (JP)

(73) Assignee: PANASONIC INTELLECTUAL PROPERTY MANAGEMENT CO., LTD., Osaka (JP)

(21) Appl. No.: 16/651,237

(22) PCT Filed: Sep. 26, 2018
(86) PCT No.: PCT/JP2018/035596

§ 371 Date: Mar. 26, 2020

(30) Foreign Application Priority Data
Sep. 28, 2017 (JP) 2017-188532

(51) Int. Cl. H01H 50/54; H01H 50/56

(52) U.S. Cl. CPC H01H 50/546; H01H 50/56

(57) ABSTRACT

A contact device includes: a first fixed terminal; a movable contact that comes into contact with and away from the first fixed terminal by moving relative to the first fixed terminal; and a drive unit that moves the movable contact. The movable contact includes a movable contact main body having a first contact unit that comes into contact with the first fixed terminal. The first contact unit includes a plurality of first contact pieces that come into contact with the first fixed terminal.

### TECHNICAL FIELD

The present invention relates to a contact device and an electromagnetic relay equipped with the contact device.

### BACKGROUND ART

There has heretofore been known a contact device including a fixed terminal and a movable contact that comes into contact with and away from the fixed terminal by moving in the up-down direction relative to the fixed terminal (see, for example, Patent Literature 1).

### CITATION LIST

### Patent Literature

Patent Literature 1: Japanese Unexamined Patent Application Publication No. 2009-199893

### SUMMARY OF INVENTION

### Technical Problem

When a movable contact is brought into contact with a fixed terminal, a current flows between the fixed terminal and the movable contact. If a current flows between the first fixed terminal and the movable contact, such a current causes electromagnetic repulsion force between the first fixed terminal and the movable contact.

In terms of improving the reliability of contact, it is preferable to reduce the electromagnetic repulsion force acting between the fixed terminal and the movable contact.

Therefore, it is an object of the present invention to provide a contact device capable of further reducing electromagnetic repulsion force acting between a fixed terminal and a movable contact, and an electromagnetic relay equipped with the contact device.

### Solution to Problem

A contact device according to an aspect of the present invention includes a first fixed terminal and a movable contact that comes into contact with and away from the first fixed terminal by moving relative to the first fixed terminal. The contact device further includes a drive unit that moves the movable contact. The movable contact includes a movable contact main body having a first contact unit that comes into contact with the first fixed terminal. The first contact unit includes a plurality of first contact pieces that come into contact with the first fixed terminal.

An electromagnetic relay according to the present invention is equipped with the contact device.

### Advantageous Effects

The present invention can provide a contact device capable of further reducing electromagnetic repulsion force acting between a fixed terminal and a movable contact, and an electromagnetic relay equipped with the contact device.

### BRIEF DESCRIPTION OF DRAWINGS

FIG. 1 is a perspective view showing an electromagnetic relay according to an embodiment of the present invention.

FIG. 2 is an exploded perspective view showing the electromagnetic relay in an exploded state according to the embodiment of the present invention.

FIG. 3 is an exploded perspective view showing a part of a contact device in an exploded state according to the embodiment of the present invention.

FIG. 4 is a diagram showing the electromagnetic relay according to the embodiment of the present invention, (a) showing a side cross-sectional view of the electromagnetic relay taken along the left-right direction in a state where the contact is turned off, while (b) showing a side cross-sectional view of the electromagnetic relay taken along the left-right direction in a state where the contact is turned on.

FIG. 5 is a diagram schematically showing a part of the contact device according to the embodiment, (a) showing a partial side cross-sectional view of the contact device taken along a vertical plane including the left-right direction in a state where the contact is turned on, (b) showing a side cross-sectional view of a movable contact and a holder taken along a vertical plane including the front-rear direction, (c) showing a transverse cross-sectional view of the movable contact and the holder taken along a horizontal plane, and (d) showing a perspective view of the movable contact.

FIG. 6 is a diagram schematically showing a part of a contact device according to a first modified example, (a) showing a partial side cross-sectional view of the contact device taken along a vertical plane including the left-right direction in a state where the contact is turned off, while (b) showing a partial side cross-sectional view of the contact device taken along the vertical plane including the left-right direction in a state where the contact is turned on.

FIG. 7 is a transverse cross-sectional view of a movable contact and a holder taken along a horizontal plane, schematically showing a part of a contact device according to a second modified example.

FIG. 8 is a perspective view of a movable contact in a state where the contact is turned off, schematically showing a part of a contact device according to a third modified example.

FIG. 9 is a diagram schematically showing a part of a contact device according to a fourth modified example, (a) showing a partial side cross-sectional view of the contact device taken along a vertical plane including the left-right direction in a state where the contact is turned on, while (b) showing a perspective view of a biasing member.

FIG. 10 is a diagram schematically showing a part of a contact device according to a fifth modified example, (a) showing a side cross-sectional view of a movable contact and a biasing member taken along a vertical plane including the front-rear direction in a state where the contact is turned off, while (b) showing a side cross-sectional view of the movable contact and the biasing member taken along the vertical plane including the front-rear direction in a state where the contact is turned on.

FIG. 11 is a diagram schematically showing a part of a contact device according to a sixth modified example, (a) showing a perspective view of a biasing member, while (b) showing a side view of the biasing member.

FIG. 12 is a diagram schematically showing a part of a contact device according to a seventh modified example, (a) showing a perspective view of a biasing member, while (b) showing a side view of the biasing member.

FIG. 13 is a diagram schematically showing a part of a contact device according to an eighth modified example, (a) showing a perspective view of a biasing member, while (b) showing a side cross-sectional view of a movable contact and the biasing member taken along a vertical plane including the front-rear direction.

FIG. 14 is a diagram schematically showing a part of a contact device according to a ninth modified example, (a) showing a side cross-sectional view of a movable contact and a biasing member taken along a vertical plane including the front-rear direction in a state where the contact is turned off, while (b) showing a side cross-sectional view of the movable contact and the biasing member taken along the vertical plane including the front-rear direction in a state where the contact is turned on.

FIG. 15 is a side cross-sectional view of a movable contact and a biasing member taken along a vertical plane including the front-rear direction, schematically showing a part of a contact device according to a tenth modified example.

FIG. 16 is a side cross-sectional view of a movable contact and a biasing member taken along a vertical plane including the front-rear direction, schematically showing a part of a contact device according to an eleventh modified example.

FIG. 17 is a diagram schematically showing a part of a contact device according to a twelfth modified example, (a) showing a side cross-sectional view of a movable contact and a biasing member taken along a vertical plane including the front-rear direction in a state where the contact is turned off, (b) showing a side cross-sectional view of the movable contact and the biasing member taken along the vertical plane including the front-rear direction in a state where the contact is turned on, and (c) showing a side view of the movable contact and the biasing member as seen in the front-rear direction in the state where the contact is turned on.

FIG. 18 is a diagram schematically showing a part of a contact device according to a thirteenth modified example, (a) showing a rear view of a movable contact, (b) showing a side view of the movable contact as seen from the front-rear direction in a state where the contact is turned off, and (c) showing a rear view of the movable contact in a state where the contact is turned on.

FIG. 19 is a diagram schematically showing a part of a contact device according to a fourteenth modified example, (a) showing a partial side cross-sectional view of the contact device taken along a vertical plane including the left-right direction in a state where the contact is turned on, (b) showing a transverse cross-sectional view of a movable contact and a holder taken along a horizontal plane, and (c) showing a perspective view of the movable contact.

FIG. 20 is a transverse cross-sectional view of a movable contact and a holder taken along a horizontal plane, schematically showing a part of a contact device according to a fifteenth modified example.

FIG. 21 is a diagram schematically showing a part of a contact device according to a sixteenth modified example, (a) showing a partial side cross-sectional view of the contact device taken along a vertical plane including the left-right direction in a state where the contact is turned off, while (b) showing a partial side cross-sectional view of the contact device taken along the vertical plane including the left-right direction in a state where the contact is turned on.

FIG. 22 is a diagram schematically showing a part of a contact device according to a seventeenth modified example, (a) showing a partial side cross-sectional view of the contact device taken along a vertical plane including the left-right direction in a state where the contact is turned on, while (b) showing a transverse cross-sectional view of a movable contact and a holder taken along a horizontal plane.

FIG. 23 is a diagram schematically showing a part of a contact device according to an eighteenth modified example, (a) showing a partial side cross-sectional view of the contact device taken along a vertical plane including the left-right direction in a state where the contact is turned on, while (b) showing a transverse cross-sectional view of a movable contact and a holder taken along a horizontal plane.

FIG. 24 is a diagram schematically showing a part of a contact device according to a nineteenth modified example, (a) showing a side cross-sectional view of a movable contact and a holder taken along a vertical plane including the front-rear direction, while (b) showing a transverse cross-sectional view of the movable contact and the holder taken along a horizontal plane.

FIG. 25 is a diagram schematically showing a movable-side plate member and a biasing member, (a) is a perspective view showing an example of the movable-side plate member and the biasing member, (b) is a perspective view showing another example of the movable-side plate member and the biasing member, and (c) is a side view showing another example of the movable-side plate member and the biasing member.

FIG. 26 is a diagram schematically showing a part of a contact device according to a twentieth modified example, (a) showing a partial side cross-sectional view of the contact device taken along a vertical plane including the left-right direction in a state where the contact is turned on, (b) showing a side cross-sectional view of a movable contact and a yoke taken along a vertical plane including the front-rear direction, and (c) showing a transverse cross-sectional view of the movable contact and the yoke taken along a horizontal plane.

FIG. 27 is a diagram schematically showing a part of a contact device according to a twenty-first modified example, (a) showing a partial side cross-sectional view of the contact device taken along a vertical plane including the left-right direction in a state where the contact is turned off, (b) showing a partial side cross-sectional view of the contact device taken along the vertical plane including the left-right direction in a state where the contact is turned on, (c) showing a transverse cross-sectional view of a movable contact, and (d) showing an exploded perspective view of a movable contact piece.

FIG. 28 is a diagram schematically showing a part of a contact device according to a twenty-second modified example, (a) showing a partial side cross-sectional view of the contact device taken along a vertical plane including the left-right direction in a state where the contact is turned off, while (b) showing a partial side cross-sectional view of the contact device taken along the vertical plane including the left-right direction in a state where the contact is turned on.

FIG. 29 is a diagram schematically showing a part of a contact device according to a twenty-third modified example, (a) showing a partial side cross-sectional view of the contact device taken along a vertical plane including the left-right direction in a state where the contact is turned off, (b) showing a partial side cross-sectional view of the contact device taken along the vertical plane including the left-right direction in a state where the contact is turned on, (c) showing a transverse cross-sectional view of a movable contact, and (d) showing an exploded perspective view of a movable contact piece.

FIG. 30 is a diagram explaining how one plate member comes into contact with a fixed terminal in the contact device according to the twenty-third modified example, showing a side cross-sectional view of the contact device taken along the vertical plane including the left-right direction in the state where the contact is turned on.

FIG. 31 is a diagram schematically showing a part of a contact device according to a twenty-fourth modified example, (a) showing a perspective view of a movable contact, (b) showing a partially enlarged perspective view of the movable contact, and (c) showing a partial side cross-sectional view of the contact device taken along a vertical plane including the left-right direction in a state where the contact is turned on.

FIG. 32 is a diagram schematically showing an electromagnetic relay according to a twenty-fifth modified example, (a) showing a side cross-sectional view of the electromagnetic relay taken along a vertical plane including the left-right direction in a state where the contact is turned off, while (b) showing a side cross-sectional view of the electromagnetic relay taken along the vertical plane including the left-right direction in a state where the contact is turned on.

FIG. 33 is a transverse cross-sectional view schematically showing the electromagnetic relay according to the twenty-fifth modified example taken along a horizontal plane.

FIG. 34 is a diagram schematically showing an electromagnetic relay according to a twenty-sixth modified example, (a) showing a side cross-sectional view of the electromagnetic relay taken along a vertical plane including the front-rear direction in a state where the contact is turned off, while (b) showing a plan view of a movable contact and a fixed terminal.

FIG. 35 is a diagram schematically showing an electromagnetic relay according to a twenty-seventh modified example, (a) showing a side cross-sectional view of the electromagnetic relay taken along a vertical plane including the front-rear direction in a state where the contact is turned off, (b) showing a plan view of a movable contact and a fixed terminal, and (c) showing a side view of the electromagnetic relay as seen in the front-rear direction in a state where the contact is turned off.

FIG. 36 is a diagram schematically showing an electromagnetic relay according to a twenty-eighth modified example, (a) showing a side cross-sectional view of the electromagnetic relay taken along a vertical plane including the left-right direction in a state where the contact is turned off, while (b) showing a plan view of a movable contact and a fixed terminal.

FIG. 37 is a diagram schematically showing an electromagnetic relay according to a twenty-ninth modified example, (a) showing a side cross-sectional view of the electromagnetic relay taken along a vertical plane including the left-right direction in a state where the contact is turned off, while (b) showing a plan view of a movable contact and a fixed terminal.

FIG. 38 is a partially exploded perspective view schematically showing an electromagnetic relay according to a thirtieth modified example.

FIG. 39 is a side cross-sectional view schematically showing the electromagnetic relay according to the thirtieth modified example taken along a vertical plane including the left-right direction in a state where the contact is turned on.

FIG. 40 is a side cross-sectional view schematically showing the electromagnetic relay according to the thirtieth modified example taken along a vertical plane including the front-rear direction in the state where the contact is turned on.

FIG. 41 is a diagram schematically showing an electromagnetic relay according to a thirty-first modified example, (a) showing a side cross-sectional view of the electromagnetic relay taken along a vertical plane including the left-right direction in a state where the contact is turned off, while (b) showing a side cross-sectional view of the electromagnetic relay taken along the vertical plane including the left-right direction in a state where the contact is turned on.

FIG. 42 is a plan view schematically showing a movable contact and a fixed terminal in the electromagnetic relay according to the thirty-first modified example.

### DESCRIPTION OF EMBODIMENTS

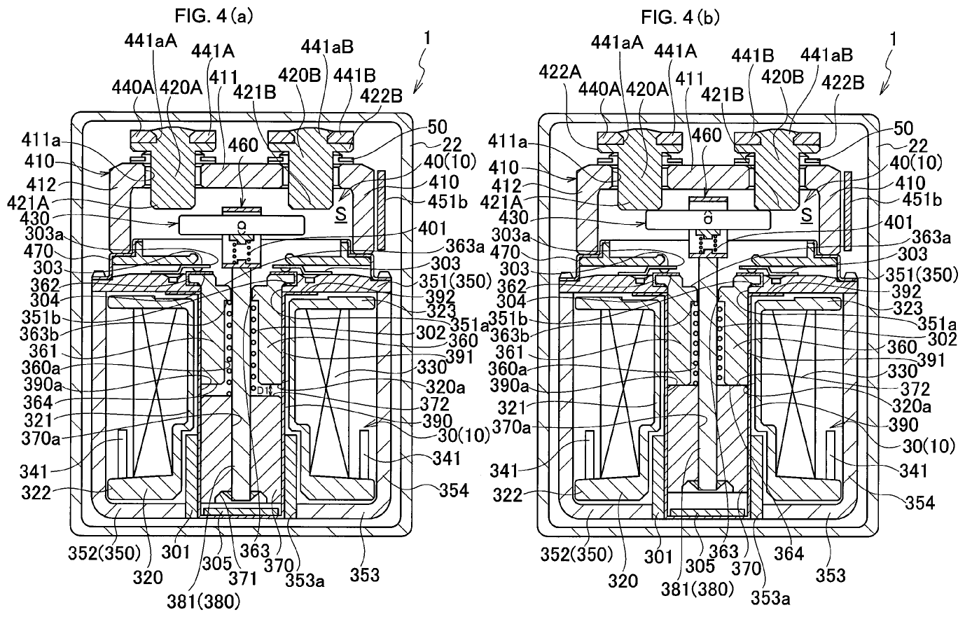

Hereinafter, embodiments of the present invention will be described in detail with reference to the drawings. Note that the following description is given assuming that a moving direction of a movable contact immediately before coming into contact with and away from a fixed terminal is an up-down direction, a direction in which a movable-side plate member of the movable contact extends is a left-right direction, and a direction orthogonal to the up-down direction and the left-right direction is a front-rear direction. Therefore, description is given assuming that up, down, left, and right in FIG. 4 indicate up, down, left, and right, and that a direction orthogonal to the page space in FIG. 4 indicates the front-rear direction.

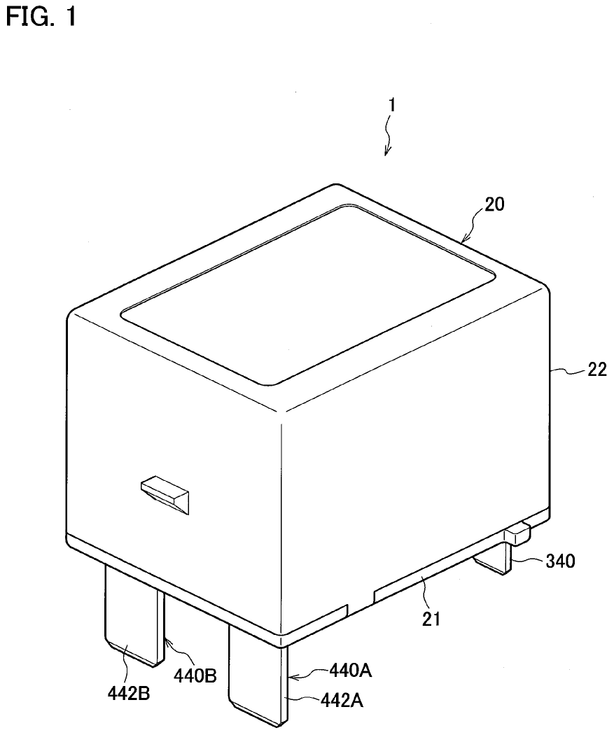

An electromagnetic relay 1 according to this embodiment is of a so-called normally-open type in which contact is turned off in an initial state. This electromagnetic relay 1 is equipped with a contact device 10 configured by integrally combining a drive block (drive unit) 30 located below and a contact block (contact unit) 40 located above, as shown in FIGS. 1 to 4. To be more specific, the electromagnetic relay 1 equipped with the contact device 10 is formed by housing the contact device 10 in a case 20 formed of a resin material into a hollow box shape. Note that it is also possible to use a so-called normally-closed electromagnetic relay in which contact is turned on in an initial state.

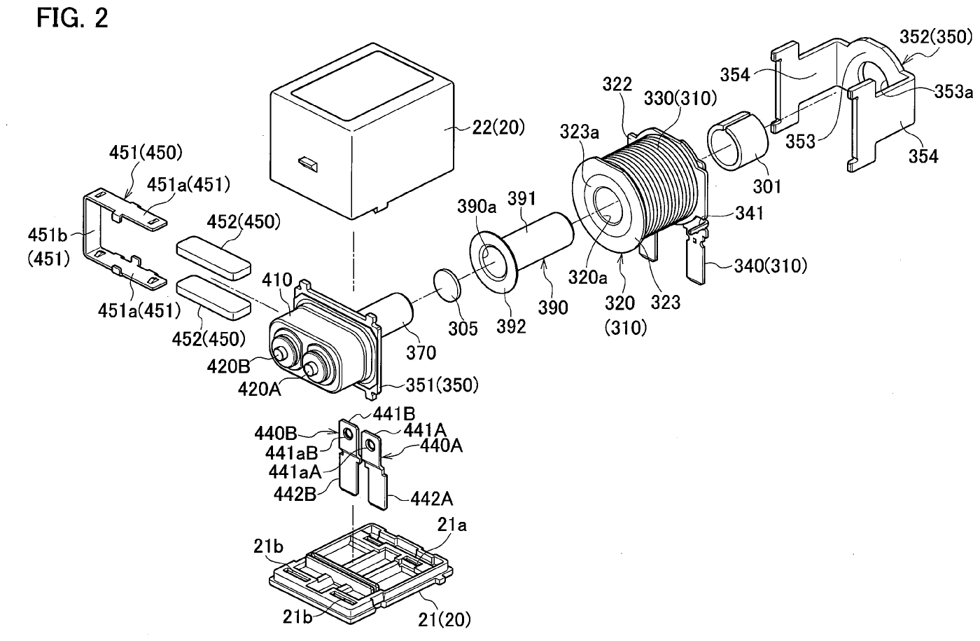

As shown in FIGS. 1 and 2, the case 20 includes an approximately rectangular case base 21 and a case cover 22 arranged to cover the case base 21. The case cover 22 is formed in a hollow box shape in which the case base 21 side is open. The mounted parts such as the drive block 30 and the contact block 40 are housed in the internal space of the case 20 formed with the case cover 22 attached to the case base 21.

A pair of slits 21a and 21a are provided on the lower side of the case base 21, into which a pair of coil terminals 340 and 340 are inserted, respectively. Meanwhile, a pair of slits 21b and 21b are provided on the upper side of the case base 21, into which a first terminal 442A of a first bus bar (first conductive member) 440A and a second terminal 442B of a second bus bar (second conductive member) 440B are inserted, respectively.

Note that one of the slits 21a has approximately the same shape as the cross-sectional shape of one of the coil terminals 340 inserted into the one slit 21a, and the other slit 21a has approximately the same shape as the cross-sectional shape of the other coil terminal 340 inserted into the other slit 21a. Here, in this embodiment, the coil terminals 340 having approximately the same cross-sectional shape in the portion inserted into the slits 21a are used. Therefore, the slits 21a and 21a also have approximately the same cross-sectional shape.

Likewise, one of the slits 21b has approximately the same shape as the cross-sectional shape of the first terminal 442A inserted into the one slit 21b, and the other slit 21b has approximately the same shape as the cross-sectional shape of the second terminal 442B inserted into the other slit 21b. Here, in this embodiment, the first and second terminals 442A and 442B have approximately the same cross-sectional shape in the portion inserted into the slits 21b. Therefore, the slits 21b and 21b also have approximately the same cross-sectional shape.

The drive block 30 includes a coil unit 310. This coil unit 310 includes: a coil 330 that generates a magnetic flux when energized; a hollow cylindrical coil bobbin 320 around which the coil 330 is wound; and a pair of coil terminals 340 and 340 fixed to the coil bobbin 320 and connected to both ends of the coil 330.

The coil bobbin 320 is formed of resin that is an insulating material, and has a vertically penetrating insertion hole 320a formed in the center thereof. The coil bobbin 320 includes an approximately cylindrical winding drum part 321 having the coil 330 wound on the outer surface thereof. The coil bobbin 320 further includes an approximately circular lower flange part 322 connected to the lower end of the winding drum part 321 so as to protrude radially outward of the winding drum part 321 and an approximately circular upper flange part 323 connected to the upper end of the winding drum part 321 so as to protrude radially outward of the winding drum part 321.

The coil terminal 340 can be formed in a flat plate shape using a conductive material such as copper, for example. The coil terminals 340 and 340 also have relay terminals 341 and 341 provided thereon, respectively. A lead wire at one end of the coil 330 wound around the winding drum part 321 of the coil bobbin 320 is soldered in a tangled state to the relay terminal 341 of one of the coil terminals 340. Likewise, a lead wire at the other end of the coil 330 wound around the winding drum part 321 of the coil bobbin 320 is soldered in a tangled state to the relay terminal 341 of the other coil terminal 340.

As described above, in this embodiment, the coil unit 310 is formed by electrically connecting the both ends of the coil 330 wound around the winding drum part 321 of the coil bobbin 320 to the pair of coil terminals 340 and 340 fixed to the coil bobbin 320. Thus, the drive block 30 is driven when the coil 330 is energized through the pair of coil terminals 340 and 340. When the drive block 30 is driven by energizing the coil 330, the contact of the contact block 40 to be described later is opened and closed. Note that, in this embodiment, a pair of contacts are formed in the contact block 40. A bottom surface 421aA of a first fixed terminal 420A and a portion that comes into contact with a bottom surface 421aA of a movable contact 430 form one of the contacts of the contact block 40, while a bottom surface 421aB of a second fixed terminal 420B and a portion that comes into contact with a bottom surface 421aB of the movable contact 430 form the other contact. Thus, in this embodiment, opening and closing of the contacts of the contact block 40 can be switched by driving the drive block 30 or stopping the drive of the drive block 30. That is, conduction and non-conduction between the first and second fixed terminals 420A and 420B can be switched by switching on and off of the drive block 30.

The drive block 30 includes a yoke 350 disposed around the coil 330. This yoke 350 can be formed using a magnetic material, for example. In this embodiment, the yoke 350 is arranged so as to surround the coil bobbin 320. The yoke 350 includes a rectangular yoke upper plate 351 arranged on the upper end surface side of the coil bobbin 320 and a rectangular yoke main body 352 arranged on the lower end surface side and the side surface side of the coil bobbin 320.

The yoke main body 352 is arranged between the coil 330 and the case 20. In this embodiment, the yoke main body 352 includes a bottom wall 353 and a pair of side walls 354 and 354 that rise from left and right end edges (peripheral edges) of the bottom wall 353, respectively, which are opened in the front-rear direction. Note that the bottom wall 353 and the pair of side walls 354 and 354 can be formed in a continuous and integrated manner by bending a single plate. An annular insertion hole 353a is formed in the bottom wall 353 of the yoke main body 352, and a bush 301 is mounted in the insertion hole 353a. This bush 301 can also be formed using a magnetic material, for example.

On the tip side (upper end side) of the pair of side walls 354 and 354 of the yoke main body 352, the yoke upper plate 351 described above is formed so as to cover the upper end surface of the coil bobbin 320 and the coil 330 wound around the coil bobbin 320.

The drive block 30 includes a fixed iron core (fixed-side member) 360 that is inserted into the cylinder part (into the insertion hole 320a) of the coil bobbin 320 and is magnetized by the energized coil 330 (through which a magnetic flux passes). The drive block 30 further includes a movable iron core (movable-side member) 370 that is opposed to the fixed iron core 360 in the vertical direction (axial direction) and is disposed inside the cylinder part (in the insertion hole 320a) of the coil bobbin 320.

In this embodiment, the fixed iron core 360 includes a cylindrical part 361 inserted into the cylinder part of the coil bobbin 320 (into the insertion hole 320a) and a flange part 362 protruding radially outward from the upper end of the cylindrical part 361. The fixed iron core 360 has an insertion hole 360a formed therein, into which a shaft 380 and a return spring 302 are inserted.

Note that, in this embodiment, a projection 363 projecting inward (radially inward) of the insertion hole 360a is formed across the entire lower periphery of the flange part 362. That is, the insertion hole 360a is formed such that the opening diameter above the projection 363 (on the upper surface 363a side) is larger than the opening diameter in the portion where the projection 363 is formed. The insertion hole 360a is also formed such that the opening diameter below the projection 363 (on the lower surface 363b side) is larger than the opening diameter in the portion where the projection 363 is formed. Furthermore, in this embodiment, the opening diameter above the projection 363 (on the upper surface 363a side) is slightly larger than the opening diameter below the projection 363 (on the lower surface 363b side).

Meanwhile, the movable iron core 370 is formed in an approximately cylindrical shape, and has an insertion hole 370a formed in the center thereof, into which the shaft 380 is inserted. The insertion hole 370a has an approximately constant opening diameter (opening diameter approximately the same as the diameter of a shaft main body 381), and has its lower end communicated with a recess part 371 formed in the lower center of the movable iron core 370.

The shaft 380 can be formed using, for example, a non-magnetic material. In this embodiment, the shaft 380 has a round rod-shaped shaft main body 381 that is elongated in the moving direction (up-down direction: drive shaft direction) of the movable iron core 370. A holder 460 that holds the movable contact 430 is connected to an upper end of the shaft main body 381.

The movable iron core 370 and the shaft 380 are connected by inserting the lower end of the shaft main body 381 into the insertion hole 370a of the movable iron core 370 from above.

In this embodiment, the drive block 30 further includes a plunger cap 390 formed in a cylindrical shape with a bottom and an open top. This plunger cap 390 can also be formed using a non-magnetic material, for example. The plunger cap 390 is disposed between the fixed iron core 360 and the coil bobbin 320, and between the movable iron core 370 and the coil bobbin 320.

In this embodiment, the plunger cap 390 includes: a main body part 391 having a cylindrical shape with a bottom and an open top; and a flange part 392 that protrudes radially outward from the upper end of the main body part 391. The main body part 391 of the plunger cap 390 is arranged in the insertion hole 320a formed at the center of the coil bobbin 320. An annular seat surface 323a is also formed on the upper side (upper flange part 323) of the coil bobbin 320, and the flange part 392 of the plunger cap 390 is placed on the seat surface 323a when the main body part 391 of the plunger cap 390 is inserted into the insertion hole 320a of the coil bobbin 320.

The cylindrical part 361 of the fixed iron core 360 and the movable iron core 370 are housed in a housing space 390a of the plunger cap 390 provided inside the cylindrical part of the coil bobbin 320 (inside the insertion hole 320a). In this embodiment, the fixed iron core 360 is arranged on the opening side of the plunger cap 390, while the movable iron core 370 is arranged below the fixed iron core 360 in the cylinder of the plunger cap 390.

Furthermore, the cylindrical part 361 of the fixed iron core 360 and the movable iron core 370 are each formed in a cylindrical shape whose outer diameter is approximately the same as the inner diameter of the plunger cap 390. The movable iron core 370 slides up and down (reciprocating direction: drive shaft direction) in the housing space 390a of the plunger cap 390.

In this embodiment, the flange part 392 formed on the opening side of the plunger cap 390 is fixed to the periphery of the insertion hole 351a on the lower surface of the yoke upper plate 351. The bottom part of the lower end of the plunger cap 390 is inserted into the bush 301 attached to the insertion hole 353a of the bottom wall 353.

Thus, the movable iron core 370 housed below the plunger cap 390 is magnetically joined to the periphery of the bush 301. That is, in this embodiment, the bush 301 forms a magnetic circuit together with the yoke 350 (the yoke upper plate 351 and the yoke main body 352), the fixed iron core 360, and the movable iron core 370.

In addition, an insertion hole 351a through which the fixed iron core 360 is inserted is formed in the center of the yoke upper plate 351. As for insertion of the fixed iron core 360, the cylindrical part 361 of the fixed iron core 360 is inserted from the upper surface side of the yoke upper plate 351. In this event, a recess part 351b having approximately the same diameter as the flange part 362 of the fixed iron core 360 is provided approximately at the center of the upper surface of the yoke upper plate 351. The flange part 362 of the fixed iron core 360 is fitted into the recess part 351b to prevent falling off.

A metal pressing plate 303 is further provided on the upper surface side of the yoke upper plate 351, and this pressing plate 303 has its left and right ends fixed to the upper surface of the yoke upper plate 351. A convex portion is provided at the center of the pressing plate 303 so as to form a space for housing the flange part 362 of the fixed iron core 360 protruding from the upper surface of the yoke upper plate 351.

In this embodiment, an iron core rubber 304 made of a material having rubber elasticity (for example, synthetic rubber) is provided between the fixed iron core 360 and the pressing plate 303 to prevent direct propagation of vibration from the fixed iron core 360 to the pressing plate 303. The iron core rubber 304 is formed in a disk shape and has an insertion hole 304a formed in its center, into which the shaft 380 is inserted. Furthermore, in this embodiment, the iron core rubber 304 is fitted to the fixed iron core 360 so as to surround the flange part 362.

The pressing plate 303 has an insertion hole 303a formed therein, into which the shaft 380 is inserted. Thus, the upper end side (head 382 side) of the shaft 380 can be extended to the contact block 40 through the insertion hole 360a of the fixed iron core 360 and the insertion hole 303a of the pressing plate 303.

When the movable iron core 370 is attracted to the fixed iron core 360 by energizing the coil 330, the shaft 380 connected and fixed to the movable iron core 370 is also moved upward together with the movable iron core 370.

Note that, in this embodiment, a range (movable range) within which the movable iron core 370 can move is set between an initial position spaced apart from the fixed iron core 360 by a gap D1 and a contact position where contact is made with the fixed iron core 360. Note that, in this embodiment, with the drive block 30 in its assembled state, a position where the movable iron core 370 is located farthest from the fixed iron core 360 is defined as an initial position, while a position where the movable iron core 370 is closest to the fixed iron core 360 is defined as a contact position.

As described above, the return spring 302 is disposed between the fixed iron core 360 and the movable iron core 370, which uses its elasticity to bias the movable iron core 370 in a direction of returning the movable iron core 370 to the initial position (direction in which the movable iron core 370 moves away from the fixed iron core 360). In this embodiment, the return spring 302 is configured using a coil spring arranged inside the insertion hole 360a of the fixed iron core 360 in a state of being wound around the shaft 380. The return spring 302 has its upper end in contact with the lower surface 363b of the projection 363 of the fixed iron core 360 and its lower end in contact with the upper surface 372 of the movable iron core 370. That is, the lower surface 363b of the projection 363 and the upper surface 372 of the movable iron core 370 serve as a spring receiving part of the return spring 302.

With the above configuration, when the coil 330 is energized, the surface (lower surface) 364 of the fixed iron core 360 facing the movable iron core 370 and the surface (upper surface) 372 of the movable iron core 370 facing the fixed iron core 360 have different polarities as a pair of magnetic pole parts. Then, the movable iron core 370 is attracted to the fixed iron core 360 and moved toward the contact position. Thus, in this embodiment, when the coil 330 is energized, the surface (lower surface) 364 of the fixed iron core 360 facing the movable iron core 370 and the surface (upper surface) 372 of the movable iron core 370 facing the fixed iron core 360 function as magnetic pole surfaces.

On the other hand, when the current supply to the coil 330 is stopped, the movable iron core 370 is returned to the initial position by the biasing force of the return spring 302.

As described above, the movable iron core 370 according to this embodiment is disposed opposed to the fixed iron core 360 with the gap D1 when the coil 330 is not energized, and is reciprocated so as to be attracted to the fixed iron core 360 side when the coil 330 is energized.

The shaft 380 is reciprocated in the up-down direction as the movable iron core 370 is reciprocated in the up-down direction. Furthermore, as the shaft 380 is reciprocated in the up-down direction, the movable contact 430 is moved relative to the first fixed terminal 420A and the second fixed terminal 420B. Thus, in this embodiment, the shaft 380 corresponds to the drive shaft that moves the movable contact 430 relative to the first fixed terminal 420A and the second fixed terminal 420B by reciprocating in the up-down direction (one direction).

Note that a damper rubber 305 made of a material having rubber elasticity and formed to have approximately the same diameter as the outer diameter of the movable iron core 370 is disposed at the bottom of the plunger cap 390 in the housing space 390a.

Above the drive block 30, the contact block 40 that opens and closes the contact according to the on/off state of the current supply to the coil 330.

The contact block 40 includes a base 410 formed of a heat-resistant material such as ceramic into a box shape with an open bottom. This base 410 includes a top wall 411 and an approximately rectangular cylindrical peripheral wall 412 extending downward from a peripheral portion of the top wall 411.

The top wall 411 of the base 410 has two insertion holes 411a and 411a provided therein so as to be aligned in the left-right direction. The first fixed terminal 420A is inserted into one (on the left side in FIG. 4) of the two insertion holes 411a and 411a, while the second fixed terminal 420B is inserted into the other (on the right side in FIG. 4) insertion hole 411a. In this embodiment, for the sake of convenience, the first fixed terminal 420A and the second fixed terminal 420B are used to distinguish between a pair of fixed terminals that are conducted to each other. However, it is not necessary that one fixed terminal (the left fixed terminal in FIG. 4) be the first fixed terminal 420A and the other fixed terminal (the right fixed terminal in FIG. 4) be the second fixed terminal 420B. That is, one fixed terminal (the left fixed terminal in FIG. 4) may be the second fixed terminal 420B and the other fixed terminal (the right fixed terminal in FIG. 4) may be the first fixed terminal 420A.

The first fixed terminal 420A is formed of a conductive material such as a copper-based material, and is arranged so as to be vertically elongated in the state shown in FIG. 4. In this embodiment, the first fixed terminal 420A includes an approximately cylindrical (approximately columnar) first fixed terminal main body 421A (vertically elongated first fixed terminal main body 421A) inserted into the insertion hole 411a from above. The bottom surface 421aA of the first fixed terminal main body 421A serves as a fixed contact with which the movable contact 430 comes into contact when the coil 330 is energized. Note that a fixed contact may be provided on the bottom surface 421aA of the first fixed terminal main body 421A separately from the first fixed terminal main body 421A. The first fixed terminal 420A includes an approximately disk-shaped first flange part 422A that protrudes radially outward from the upper end of the first fixed terminal main body 421A, and is fixed to the upper surface of the top wall 411 (upper surface of the peripheral portion of the insertion hole 411a).

Likewise, the second fixed terminal 420B is also formed of a conductive material such as a copper-based material, and is arranged so as to be vertically elongated in the state shown in FIG. 4. This second fixed terminal 420B includes an approximately cylindrical (approximately columnar) second fixed terminal main body 421B (vertically elongated second fixed terminal main body 421B) inserted into the insertion hole 411a from above. The bottom surface 421aB of the second fixed terminal main body 421B serves as a fixed contact with which the movable contact 430 comes into contact when the coil 330 is energized. Note that a fixed contact may be provided on the bottom surface 421aB of the second fixed terminal main body 421B separately from the second fixed terminal main body 421B. The second fixed terminal 420B includes an approximately disk-shaped second flange part 422B that protrudes radially outward from the upper end of the second fixed terminal main body 421B, and is fixed to the upper surface of the top wall 411 (upper surface of the peripheral portion of the insertion hole 411a).

In this embodiment, the first fixed terminal 420A and the second fixed terminal 420B are fixed to the top wall 411 via washers 50, respectively.

To be more specific, the first fixed terminal 420A is fixed to the top wall 411 by the following method. The first fixed terminal main body 421A of the first fixed terminal 420A is first inserted from above into the insertion hole of the washer 50 and one insertion hole 411a of the top wall 411 in a state where the washer 50 is arranged on the upper surface of the peripheral portion of the one insertion hole 411a in the top wall 411. Then, the upper surface of the washer 50 and the lower surface of the first flange part 422A are hermetically joined with a silver solder 51, and the lower surface of the washer 50 and the upper surface of the top wall 411 (the upper surface of the peripheral portion of the one insertion hole 411a) are hermetically joined with a silver solder 52. Thus, the first fixed terminal 420A is fixed to the top wall 411. Accordingly, the first fixed terminal 420A is fixed to the top wall 411. In this event, the first fixed terminal 420A is fixed to the top wall 411 in a state where the insertion hole 411a is hermetically sealed. Note that, although the first fixed terminal 420A is fixed to the top wall 411 in a state where the longitudinal direction approximately coincides with the up-down direction in this embodiment, it is not necessary to make the longitudinal direction of the first fixed terminal 420An approximately coincide with the up-down direction.

The second fixed terminal 420B is also fixed to the top wall 411 in the same manner. That is, first, the second fixed terminal main body 421B of the second fixed terminal 420B is inserted from above into the insertion hole of the washer 50 and the other insertion hole 411a of the top wall 411 in a state where the washer 50 is arranged on the upper surface of the peripheral portion of the other insertion hole 411a in the top wall 411. Then, the upper surface of the washer 50 and the lower surface of the second flange part 422B are hermetically joined with the silver solder 51, and the lower surface of the washer 50 and the upper surface of the top wall 411 (the upper surface of the peripheral portion of the other insertion hole 411a) are hermetically joined with the silver solder 52. Thus, the second fixed terminal 420B is fixed to the top wall 411. In this event, the second fixed terminal 420B is also fixed to the top wall 411 in a state where the insertion hole 411a is hermetically sealed. Note that, although the second fixed terminal 420B is fixed to the top wall 411 in a state where the longitudinal direction approximately coincides with the up-down direction in this embodiment, it is not necessary to make the longitudinal direction of the second fixed terminal 420B approximately coincide with the up-down direction.

As described above, in this embodiment, the first fixed terminal 420A and the second fixed terminal 420B are fixed (arranged) on the top wall 411 so as to be spaced apart from each other. Then, the upper and lower sides of the first fixed terminal 420A are partitioned by the top wall 411 in a state where the first fixed terminal 420A is fixed to the top wall 411. Likewise, the upper and lower sides of the second fixed terminal 420B are partitioned by the top wall 411 in a state where the second fixed terminal 420B is fixed to the top wall 411.

A first bus bar (first conductive member) 440A connected to an external load or the like is attached to the first fixed terminal 420A, and a second bus bar (second conductive member) 440B connected to an external load or the like is attached to the second fixed terminal 420B.

The first bus bar 440A has a shape obtained by bending a member formed of a conductive material, and includes a first fixed part 441A fixed to the first fixed terminal 420A and a first terminal 442A inserted into one slit 21b. The first fixed part 441A has a first insertion hole 441aA formed therein. A first projection 423A provided at the center of the first flange part 422A so as to project upward is caulked while being inserted into the first insertion hole 441aA. Thus, the first bus bar 440A is fixed to the first fixed terminal 420A.

Likewise, the second bus bar 440B also has a shape obtained by bending a member formed of a conductive material, and includes a second fixed part 441B fixed to the second fixed terminal 420B and a second terminal part 442B inserted into the other slit 21b. The second fixed part 441B has a second insertion hole 441aB formed therein. A second projection 423B provided at the center of the second flange part 422B so as to project upward is caulked while being inserted into the second insertion hole 441aB. Thus, the second bus bar 440B is fixed to the second fixed terminal 420B.

The movable contact 430 is arranged in the base 410 so as to be movable relative to the first and second fixed terminals 420A and 420B as the shaft (drive shaft) 380 is moved in the up-down direction (one direction).

In this embodiment, the movable contact 430 is held by the holder 460 integrally connected to the upper end of the shaft (drive shaft) 380 as described above.

This holder 460 can be formed using an insulating resin or the like, for example. The holder 460 has an approximately rectangular cylindrical shape with both sides opened in the left-right direction (direction in which the first and second fixed terminals 420A and 420B are arranged side by side), and includes a top wall 461, side walls 462 and 462, and a bottom wall 463. The shaft (drive shaft) 380 has its upper end connected to the center of the lower surface of the bottom wall 463. Note that the connection between the holder 460 and the shaft (drive shaft) 380 can be performed by various methods such as bonding and insert molding.

In this embodiment, the movable contact 430 is held by the holder 460 in a state of being movable relative to the holder 460 in the up-down direction (one direction).

To be more specific, long holes 462a and 462a elongated in the up-down direction are formed in both side walls 462 and 462 of the holder 460. A circular insertion hole (formed by connecting a plurality of insertion holes 433a to be described later) is also formed, which penetrates the movable contact 430 in the front-rear direction (width direction of the movable contact 430). In a state where the movable contact 430 is disposed between the side walls 462 and 462, and the circular insertion hole (formed by connecting the plurality of insertion holes 433a to be described later) is communicated with the pair of long holes 462a and 462a, respectively, a support shaft 465 is inserted into the respective holes. E-rings 466 are attached to the portions of the support shaft 465 protruding outward from the side walls 462. Accordingly, the movable contact 430 is held by the holder 460 so as to be relatively movable in the up-down direction in a state where the movable contact 430 is prevented from falling out of the holder 460.

In this embodiment, the contact pressure between the movable contact 430 and the first fixed terminal 420A and the contact pressure between the movable contact 430 and the second fixed terminal 420B are secured by a contact pressure spring 401. The contact pressure spring 401 is formed using a coil spring, and is arranged with the axial direction coinciding with the up-down direction.

In this embodiment, the contact pressure spring 401 is disposed between the holding member 464 for placing and holding the movable contact 430 thereon and the bottom wall 463 of the holder 460, and presses the movable contact 430 upward via the holding member 464.

Furthermore, a spring receiving projection 464a is formed at the center of the lower surface of the holding member 464, and a spring receiving projection 463a is formed at the center of the upper surface of the bottom wall 463. In a state where the upper portion of the contact pressure spring 401 is inserted into the spring receiving projection 464a, the upper end of the contact pressure spring 401 is brought into contact with the lower surface of the holding member 464. Meanwhile, in a state where the lower portion of the contact pressure spring 401 is inserted into the spring receiving projection 463a, the lower end of the contact pressure spring 401 is brought into contact with the upper surface of the bottom wall 463. Thus, in this embodiment, the lower surface of the holding member 464 and the upper surface of the bottom wall 463 serve as a spring receiving part of the contact pressure spring 401.

The movable contact 430 is biased upward by the contact pressure spring 401. To be more specific, even in a state where the movable contact 430 is moved upward relative to the holder 460 and the support shaft 465 is brought into contact with the upper ends of the pair of long holes 462a and 462a, the movable contact 430 is still biased upward by the contact pressure spring 401. Accordingly, the contact pressure between the movable contact 430 and the first fixed terminal 420A and the contact pressure between the movable contact 430 and the second fixed terminal 420B can be more reliably ensured.

In this embodiment, with such a configuration, when the shaft (drive shaft) 380 is moved upward (to one side) in the up-down direction (one direction), the movable contact 430 is also moved upward and comes into contact with the first and second fixed terminals 420A and 420B. On the other hand, when the shaft (drive shaft) 380 is moved downward (to the other side) in the up-down direction (one direction), the movable contact 430 is also moved downward and separated from at least one of the first and second fixed terminals 420A and 420B. In this embodiment, the movable contact 430 is separated from both of the first and second fixed terminals 420A and 420B (see FIG. 4(a)).

Here, in this embodiment, the movable contact 430 includes the movable contact main body 431, and the movable contact main body 431 includes a first contact unit 4311A that comes into contact with the first fixed terminal 420A. The movable contact main body 431 also includes a second contact unit 4311B that is electrically connected to the first contact unit 4311A and comes into contact with the second fixed terminal 420B. Note that the first contact unit 4311A is a part of the movable contact main body 431, which is moved upward (to one side) as the shaft (drive shaft) 380 is moved upward (to one side) in the up-down direction (one direction) and comes into contact with the first fixed terminal 420A. The second contact unit 4311B is another part of the movable contact main body 431 that is different from the first contact unit 4311A, which is moved upward (to one side) as the shaft (drive shaft) 380 is moved upward (to one side) in the up-down direction (one direction) and comes into contact with the second fixed terminal 420B. The first contact unit 4311A and the second contact unit 4311B are electrically connected to each other through another portion of the movable contact main body 431.

With the use of such a movable contact main body 431, when the shaft (drive shaft) 380 is moved upward (to one side) in the up-down direction (one direction), the first contact unit 4311A is moved relative to the first fixed terminal 420A and comes into contact with the bottom surface 421aA of the first fixed terminal 420A. At the same time, the second contact unit 4311B is moved relative to the second fixed terminal 420B and comes into contact with the bottom surface 421aB of the second fixed terminal 420B.

Thus, the first and second fixed terminals 420A and 420B are brought into a conductive state.

On the other hand, when the shaft (drive shaft) 380 is moved downward (to the other side) in the up-down direction (one direction), the first contact unit 4311A is moved relative to the first fixed terminal 420A and separated from the bottom surface 421aA of the first fixed terminal 420A. At the same time, the second contact unit 4311B is moved relative to the second fixed terminal 420B and separated from the bottom surface 421aB of the second fixed terminal 420B.

Thus, the first and second fixed terminals 420A and 420B are brought into a non-conductive state.

As described above, the drive block (drive unit) 30 according to this embodiment includes the shaft (drive shaft) 380 that drives (moves) the movable contact 430.

By moving the shaft (drive shaft) 380 upward (to one side) in the up-down direction (one direction), the movable contact 430 is relatively moved in the direction approaching the first and second fixed terminals 420A and 420B. Accordingly, the movable contact 430 is relatively moved so as to approach the first and second fixed terminals 420A and 420B, and thus the movable contact 430 comes into contact with the first and second fixed terminals 420A and 420B. Thus, the first and second fixed terminals 420A and 420B are brought into a conductive state.

On the other hand, by moving the shaft (drive shaft) 380 downward (to the other side) in the up-down direction (one direction), the movable contact 430 is relatively moved away from the first and second fixed terminals 420A and 420B. Accordingly, the movable contact 430 is relatively moved away from the first and second fixed terminals 420A and 420B, and thus the movable contact 430 is separated from the first and second fixed terminals 420A and 420B. Thus, the first and second fixed terminals 420A and 420B are brought into a non-conductive state.

As described above, in this embodiment, the movable contact 430 is moved relative to the first and second fixed terminals 420A and 420B as the shaft (drive shaft) 380 is moved in the up-down direction (one direction), thus making it possible to switch conduction and non-conduction between the first and second fixed terminals 420A and 420B.

Between the movable contact 430 and the pressing plate 303, an insulating plate 480 is provided, which is formed of an insulating material so as to cover the pressing plate 303, and the insulating plate 480 has an insertion hole 480a provided at its center, through which the shaft 380 is inserted.

In the contact device 10 configured as described above, the shaft 380 can be attached to the movable iron core 370 in the following manner, for example.

First, the movable iron core 370, the return spring 302, the yoke upper plate 351, the fixed iron core 360, the iron core rubber 304, the pressing plate 303, and the insulating plate 480 are arranged in this order from the lower side. In this event, it is preferable that the return spring 302 is inserted into the insertion hole 360a of the fixed iron core 360 in advance.

Then, the main body 381 of the shaft 380 is inserted into the respective insertion holes 480a, 303a, 304a, 360a, and 351a and the return spring 302 from above the insulating plate 480, and then inserted into the insertion hole 370a of the movable iron core 370 to be connected. Thus, the lower end of the shaft 380 is attached to the movable iron core 370.

In this embodiment, the connection of the shaft 380 to the movable iron core 370 is performed by crushing and riveting the tip in a protruding state into the recess part 371 as shown in FIG. 4. However, the shaft 380 may be connected to the movable iron core 370 using other methods. For example, the shaft 380 may be connected to the movable iron core 370 by forming a screw groove at the other end of the shaft 380 and screwing the movable iron core 370 into the screw groove. Alternatively, the shaft 380 may be connected to the movable iron core 370 by press-fitting the shaft 380 into the insertion hole 370a of the movable iron core 370.

In this embodiment, a gas is enclosed in the base 410 to suppress arc generated between the movable contact 430 and the first fixed terminal 420A or arc generated between the movable contact 430 and the second fixed terminal 420B. This arc is generated when the movable contact 430 is separated from the first fixed terminal 420A or when the movable contact 430 is separated from the second fixed terminal 420B. As such a gas to suppress the generation of arc, a mixed gas can be used, which is mainly composed of hydrogen gas having the highest heat conductivity in a temperature range where the arc is generated. In order to enclose this gas, an upper flange 470 is provided in this embodiment to cover a gap between the base 410 and the yoke upper plate 351.

To be more specific, the base 410 includes the top wall 411 in which the pair of insertion holes 411a and 411a are arranged in the left-right direction (width direction) and the rectangular cylindrical peripheral wall 412 that extends downward from the periphery of the top wall 411. That is, the base 410 is formed in a hollow box shape with an open bottom (on the movable contact 430 side). The base 410 is fixed to the yoke upper plate 351 through the upper flange 470 in a state where the movable contact 430 is housed inside the peripheral wall 412 from the open bottom.

In this event, the peripheral edge of the opening in the lower surface of the base 410 and the upper surface of the upper flange 470 are hermetically joined with a silver solder 53, while the lower surface of the upper flange 470 and the upper surface of the yoke upper plate 351 are hermetically joined by arc welding or the like. Furthermore, the lower surface of the yoke upper plate 351 and the flange part 392 of the plunger cap 390 are hermetically joined by arc welding or the like. Thus, a sealed space S with gas sealed therein is formed in the base 410.

In this embodiment, arc suppression using a capsule yoke block 450 is also performed in parallel with the arc suppression method using gas. The capsule yoke block 450 includes a capsule yoke 451 and a pair of permanent magnets 452 and 452. The capsule yoke 451 is formed in an approximately U-shape using a magnetic material such as iron. The capsule yoke 451 is formed by integrating a pair of side pieces 451a and 451a facing each other and a connecting piece 451b connecting base ends of the both side pieces 451a and 451a.

The permanent magnets 452 and 452 are attached to the side pieces 451a and 451a of the capsule yoke 451 so as to face the side pieces 451a and 451a, respectively. The permanent magnets 452 and 452 provide the base 410 with a magnetic field approximately perpendicular to the moving direction (up-down direction) of the shaft 380 (drive shaft). As a result, the arc is elongated in a direction perpendicular to the moving direction of the shaft (drive shaft) 380, and is cooled by the gas sealed in the base 410. Accordingly, the arc voltage rises sharply and the arc is interrupted when the arc voltage exceeds the voltage between the contacts. That is, in the electromagnetic relay 1 of this embodiment, arc measures are taken by magnetic blowing with the capsule yoke block 450 and cooling with the gas sealed in the base 410. Thus, the arc can be interrupted in a short time, making it possible to reduce the consumption of the movable contact 430 and the fixed terminals (first and second fixed terminals 420A and 420B).

When the movable contact 430 is brought into contact with the first fixed terminal 420A and the second fixed terminal 420B, a current flows between the first and second fixed terminals 420A and 420B through the movable contact 430. Such a current flowing between the first and second fixed terminals 420A and 420B through the movable contact 430 causes electromagnetic repulsion force to act between the first fixed terminal 420A and the movable contact 430 and between the second fixed terminal 420B and the movable contact 430.

From the viewpoint of improving the reliability of the contact, it is preferable to reduce the electromagnetic repulsion force acting between the fixed terminal (first and second fixed terminals 420A and 420B) and the movable contact 430.

Therefore, in this embodiment, the electromagnetic repulsion force acting between the fixed terminal (first and second fixed terminals 420A and 420B) and the movable contact 430 can be further reduced.

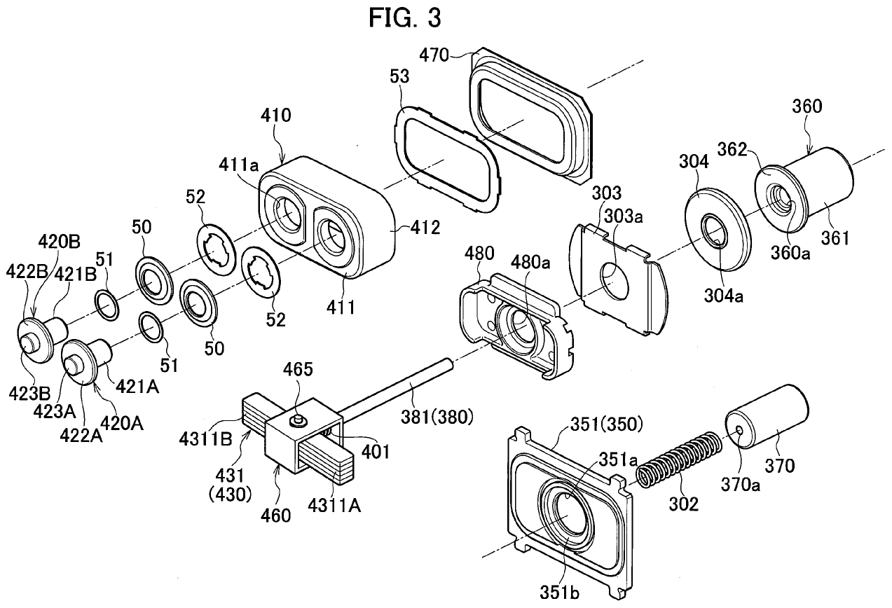

Hereinafter, a specific configuration of the movable contact 430 according to this embodiment will be described in detail with reference to FIGS. 3 to 5.

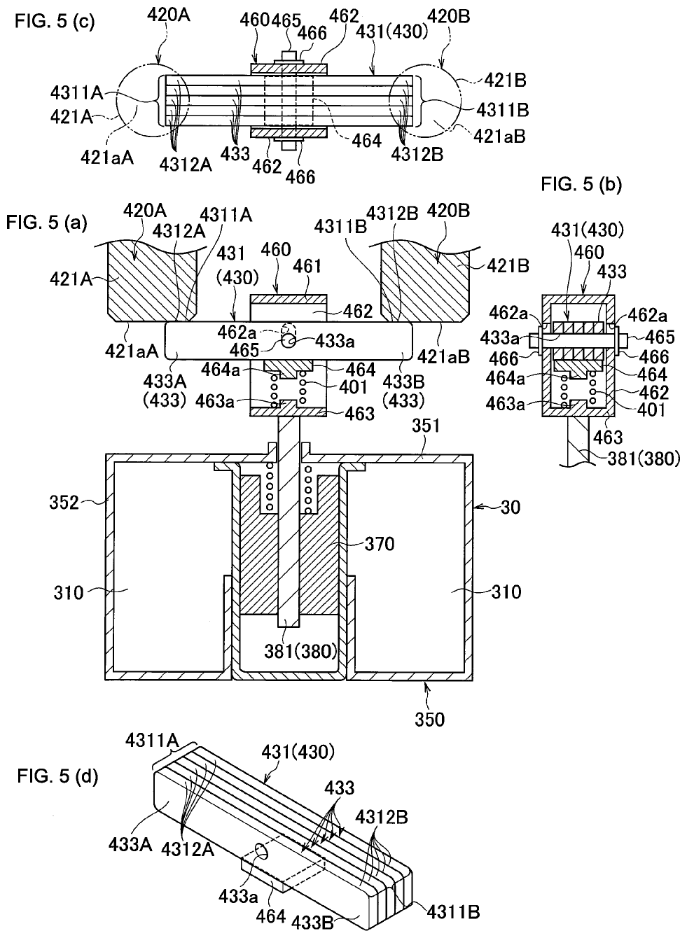

Although a drive block 30 shown in FIG. 5 has a configuration different from that of the drive block 30 shown in FIGS. 1 to 4, a contact device 10 can be formed using such a drive block 30. That is, the contact device 10 according to this embodiment can be formed using drive blocks 30 having various configurations.

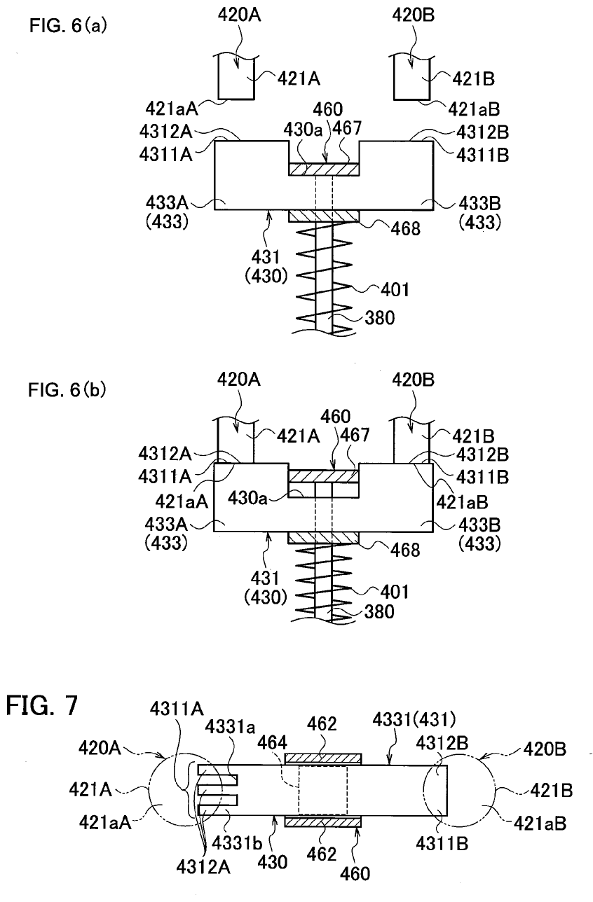

In FIG. 5(a), the drive block 30 is configured without using a fixed iron core. That is, a yoke upper plate 351 is used as a fixed-side member instead of the fixed iron core, and the movable iron core 370 is attracted to the yoke upper plate 351. A range (movable range) within which the movable iron core 370 can move is set between an initial position spaced apart from and below the yoke upper plate 351 and a contact position where contact is made with the yoke upper plate 351. Between the yoke upper plate 351 and the movable iron core 370, a return spring 302 is disposed, which uses its elasticity to bias the movable iron core 370 in a direction of returning the movable iron core 370 to the initial position (direction in which the movable iron core 370 moves away from the yoke upper plate 351). The drive block 30 shown in FIGS. 6 to 31 has the same configuration as that of the drive block 30 shown in FIG. 5(a). The drive block 30 shown in FIGS. 6 to 31 can also be the drive block 30 shown in FIGS. 1 to 4.

The movable contact 430 according to this embodiment includes the movable contact main body 431 having the first contact unit 4311A and the second contact unit 4311B as described above. The first contact unit 4311A of the movable contact main body 431 includes a plurality of first contact pieces 4312A that come into contact with the first fixed terminal 420A. The second contact unit 4311B of the movable contact main body 431 includes a plurality of second contact pieces 4312B that come into contact with the second fixed terminal 420B.

Here, in this embodiment, the movable contact main body 431 includes five (a plurality of) first movable-side plate members (first movable-side plate parts) 433A on which the first contact pieces 4312A are formed. The first contact unit 4311A is formed by stacking the five first movable-side plate members 433A in the front-rear direction (arranging the five first movable-side plate members 433A so as to be lined up in the front-rear direction). The movable contact main body 431 also includes five (a plurality of) second movable-side plate members (second movable-side plate parts) 433B on which the second contact pieces 4312B are formed. The second contact unit 4311B is formed by stacking the five second movable-side plate members 433B in the front-rear direction (arranging the five second movable-side plate members 433B so as to be lined up in the front-rear direction).

Furthermore, in this embodiment, each of the second movable-side plate members 433B is formed integrally with one corresponding first movable-side plate member 433A. That is, the second movable-side plate member 433B and the first movable-side plate member 433A located at the front in the front-rear direction are integrally formed, and the second movable-side plate member 433B and the first movable-side plate member 433A located at the end (fifth from the front) are integrally formed. Likewise, the second movable-side plate member 433B and the first movable-side plate member 433A located second from the front, the second movable-side plate member 433B and the first movable-side plate member 433A located at the center (third from the front), and the second movable-side plate member 433B and the first movable-side plate member 433A located second to the last (fourth from the front) are integrally formed, respectively.

As described above, in this embodiment, one approximately rectangular plate-shaped member (plate member) 433 that is elongated in the left-right direction is formed. One side of the plate member 433 in the left-right direction serves as the first movable-side plate member 433A having the first contact piece 4312A formed thereon, while the other side in the left-right direction serves as the second movable-side plate member 433B having the second contact piece 4312B formed thereon.

Such five (a plurality of) plate members 433 are formed, and the five plate members 433 are stacked in the front-rear direction (arranged so as to be lined up in the front-rear direction) to form the movable contact main body 431.

Thus, in this embodiment, the five approximately rectangular plate-shaped plate members 433 each having the first contact piece 4312A on one side and the second contact piece 4312B on the other side are stacked in the front-rear direction (arranged so as to be lined up in the front-rear direction) to form the movable contact main body 431. Accordingly, the movable contact main body 431 includes the plurality of first and second contact pieces 4312A and 4312B.

Furthermore, in this embodiment, the plate members 433 are stacked in the front-rear direction (arranged so as to be lined up in the front-rear direction) with the longitudinal direction approximately aligned with the left-right direction and the thickness direction approximately aligned with the front-rear direction, thus forming the movable contact main body 431. The upper end on one side in the left-right direction of each plate member 433 serves as the first contact piece 4312A that comes into contact with the first fixed terminal 420A, while the upper end on the other side serves as the second contact piece 4312B that comes into contact with the second fixed terminal 420B. As the plate member 433, a flat plate member made of a conductive material such as copper, for example, can be used. In this embodiment, description is given of an example using five plate members 433 having the same material and the same shape.

The front-rear direction in which the plate members 433 are stacked is a direction intersecting with the up-down direction (one direction: moving direction of the movable contact 430). The front-rear direction is also a direction intersecting with the left-right direction (direction in which the first and second fixed terminals 420A and 420B are arranged side by side).

Each plate member 433 also has an insertion hole 433a formed therein that penetrates in the thickness direction. The plate members 433 are stacked so that the respective insertion holes 433a are communicated with each other. Thus, the movable contact main body 431 (movable contact 430) having a round insertion hole penetrating in the front-rear direction is formed.

The movable contact main body 431 (movable contact 430) having such a configuration is supported by the support shaft 465 in a state of being arranged between the side walls 462 and 462 of the holder 460. That is, in a state where the round insertion holes formed in the movable contact main body 431 are communicated with the pair of long holes 462a and 462a, the support shaft 465 is inserted into the respective holes, and thus the movable contact main body 431 (movable contact 430) is held by the holder 460. In this event, the movable contact main body 431 (movable contact 430) is held by the holder 460 so as to be relatively movable in the up-down direction. Furthermore, in this embodiment, each plate member 433 is configured to be independently rotatable about the support shaft 465.

Therefore, in this embodiment, at least one of the plurality of first contact pieces 4312A is movable relative to the other first contact pieces 4312A. Likewise, at least one of the plurality of second contact pieces 43112B is movable relative to the other second contact piece 4312B.

In this embodiment, description is given of the example where the plurality of plate members 433 have the same shape as described above. Therefore, when the plate members 433 are stacked such that the respective insertion holes 433a are communicated with each other, the plurality of plate members 433 are stacked in a state of having their peripheral surfaces (surfaces that outline the contour as seen from the thickness direction) approximately flush with each other. However, the plurality of plate members 433 do not have to have the same shape, but at least one of the plate members 433 may have a different shape from the others. Furthermore, the contour shape of the plate member 433 does not have to be rectangular, but can be any shape. For example, a plate curved to have both ends face upward can be used as the plate member 433. Moreover, the material of at least one plate member 433 may be different from that of the other plate members 433.

Next, operations of the electromagnetic relay 1 (contact device 10) will be described.

First, when the coil 330 is not energized, the movable iron core 370 is moved in a direction away from the fixed iron core 360 by the elastic force (elastic restoring force) of the return spring 302. That is, the movable contact 430 is in the state of FIG. 4(a) where the movable contact 430 is separated from the first and second fixed terminals 420A and 420B. In this event, the movable contact 430 is moved to a position where the support shaft 465 comes into contact with the upper ends of the long holes 462a and 462a by the upward biasing force of the contact pressure spring 401 (see FIG. 4(a)).

When the coil 330 is energized from the off state, the movable iron core 370 is attracted to the fixed-side member (the fixed iron core 360 and the yoke upper plate 351) by the electromagnetic force against the elastic force (elastic restoring force) of the return spring 302 and moved (upward) so as to approach the fixed-side member. Then, as the movable iron core 370 is moved upward, the shaft 380 and the holder 460 are also moved upward, and the movable contact 430 is also moved upward. Then, as the movable contact 430 is moved upward, the first contact unit 4311A comes into contact with the bottom surface 421aA of the first fixed terminal 420A, and the second contact unit 4311B comes into contact with the bottom surface 421aB of the second fixed terminal 420B. Thus, the first and second fixed terminals 420A and 420B are electrically connected to turn on the electromagnetic relay 1 (contact device 10) (see FIG. 4(b)).

In this embodiment, force moving the shaft 380 and the holder 460 upward still acts when the movable contact 430 is in contact with the first and second fixed terminals 420A and 420B. Therefore, the holder 460 is moved upward relative to the movable contact main body 431 that is in contact with the first and second fixed terminals 420A and 420B. That is, in a state of being in contact with the first and second fixed terminals 420A and 420B, the movable contact main body 431 is moved downward relative to the holder 460 while contracting the contact pressure spring 401. In this embodiment, the movable contact 430 is moved relative to the holder 460 to a position where the support shaft 465 comes into contact with the lower ends of the long holes 462a and 462a (see FIG. 4(b)).

When the electromagnetic relay 1 (contact device 10) is turned on, the five first contact pieces 4312A formed on the first contact unit 4311A come into contact with the bottom surface 421aA of the first fixed terminal 420A. Meanwhile, the five second contact pieces 4312B formed on the second contact unit 4311B come into contact with the bottom surface 421aB of the second fixed terminal 420B.

Thus, in this embodiment, the movable contact 430 is configured to come into contact with the bottom surface 421aA of the first fixed terminal 420A and the bottom surface 421aB of the second fixed terminal 420B at five spots (a plurality of spots). Therefore, the magnitude (current value) of the current flowing through each of the five first contact pieces 4312A is smaller than the magnitude (current value) of the current flowing through the first fixed terminal 420A. In this embodiment, the movable contact main body 431 is formed using the five plate members 433 formed of the same material having the same shape. Therefore, the magnitude (current value) of the current flowing through each of the five first contact pieces 4312A is about one fifth of the magnitude (current value) of the current flowing through the first fixed terminal 420A. Likewise, the magnitude (current value) of the current flowing through each of the five second contact pieces 4312B is about one fifth of the magnitude (current value) of the current flowing through the second fixed terminal 420B.

Here, it is known that the magnitude of the electromagnetic repulsion force generated when a current flows through a contact portion between two members is proportional to the square of the current flowing through the contact portion. Therefore, the electromagnetic repulsion force generated on each of the five first contact pieces 4312A is 1/25 of the electromagnetic repulsion force generated on the first contact unit 4311A when the contact with the first fixed terminal 420A is made at one spot. As a result, as shown in FIGS. 1 to 5, when the contact with the first fixed terminal 420A is made at five spots, the electromagnetic repulsion force generated in the entire first contact unit 4311A is about one fifth of the electromagnetic repulsion force generated in the entire first contact unit 4311A when the contact with the first fixed terminal 420A is made at one spot. Likewise, on the second contact unit 4311B side, when the contact with the second fixed terminal 420B is made at five spots, the electromagnetic repulsion force generated in the entire second contact unit 4311B is about one fifth of the electromagnetic repulsion force generated in the entire second contact unit 4311B when the contact with the second fixed terminal 420B is made at one spot.

Thus, when the first contact unit 4311A is brought into contact with the first fixed terminal 420A at a plurality of spots, the magnitude of the electromagnetic repulsion force received by the first contact unit 4311A from the first fixed terminal 420A can be reduced compared with the case where the contact with the first fixed terminal 420A is made at one spot. Likewise, when the second contact unit 4311B is brought into contact with the second fixed terminal 420B at a plurality of spots, the magnitude of the electromagnetic repulsion force received by the second contact unit 4311B from the second fixed terminal 420B can be reduced compared with the case where the contact with the second fixed terminal 420B is made at one spot.

As a result, the contact between the first contact unit 4311A and the first fixed terminal 420A is prevented from being released, and the contact between the second contact unit 4311B and the second fixed terminal 420B is prevented from being released. Therefore, it is possible to more reliably maintain the conductive state between the first and second fixed terminals 420A and 420B.

On the other hand, when the current supply to the coil 330 is stopped, the movable iron core 370 is returned to the initial position by the biasing force (elastic restoring force) of the return spring 302. That is, the movable iron core 370 is moved downward. Then, as the movable iron core 370 is moved downward, the shaft 380 and the holder 460 are also moved downward, and the movable contact 430 is also moved downward. When the movable contact 430 is moved downward, the first contact unit 4311A is separated from the bottom surface 421aA of the first fixed terminal 420A, and the second contact unit 4311B is separated from the bottom surface 421aB of the second fixed terminal 420B. Thus, the first and second fixed terminals 420A and 420B are electrically insulated from each other to turn off the electromagnetic relay 1 (contact device 10) (see FIG. 4(a)).

As described above, in this embodiment, the contact device 10 includes the first fixed terminal 420A, the movable contact 430 that comes into contact with and away from the first fixed terminal 420A by moving relative to the first fixed terminal 420A, and the drive block (drive unit) 30 that moves the movable contact 430. The movable contact 430 includes the movable contact main body 431 having the first contact unit 4311A that comes into contact with the first fixed terminal 420A. The first contact unit 4311A includes the plurality of first contact pieces 4312A that come into contact with the first fixed terminal 420A.

Thus, the magnitude of the electromagnetic repulsion force received by the first contact unit 4311A from the first fixed terminal 420A can be reduced.

The electromagnetic relay 1 according to this embodiment is equipped with the contact device 10.

Therefore, according to this embodiment, the contact device 10 capable of further reducing the electromagnetic repulsion force acting between the first fixed terminal 420A and the movable contact 430 and the electromagnetic relay 1 equipped with the contact device 10 can be provided.

In this event, at least one of the plurality of first contact pieces 4312A may be configured to be movable relative to the other first contact pieces 4312A.

With this configuration, it is possible to prevent all the first contact pieces 4312A from being separated from the first fixed terminal 420A by the electromagnetic repulsion force acting between the first fixed terminal 420A and the movable contact 430. That is, the state where any one of the first contact pieces 4312A is in contact with the first fixed terminal 420A can be more reliably maintained. As a result, the conductive state between the first and second fixed terminals 420A and 420B can be more reliably maintained.

In this embodiment, the movable contact main body 431 includes five (a plurality of) first movable-side plate members (first movable-side plate parts) 433A having the first contact pieces 4312A formed thereon. The five movable-side plate members 433A are stacked in the front-rear direction (arranged so as to be lined up in the front-rear direction), that is, in the direction intersecting the up-down direction (moving direction of the movable contact 430). The stacking direction (front-rear direction) is also a direction that intersects with the left-right direction (direction in which the first and second fixed terminals 420A and 420B are arranged side by side).

With this configuration, the plurality of first contact pieces 4312A can be formed only by stacking the plurality of plate members (arranging the plurality of plate members in a line). Thus, the movable contact main body 431 having the plurality of first contact pieces 4312A can be obtained more easily. Moreover, by stacking the plurality of plate members (arranging the plurality of plate members in a line), at least one of the plurality of first contact pieces 4312A can be moved relative to the other first contact pieces 4312A with a simpler configuration. Furthermore, the plurality of first contact pieces 4312A are formed so as to be line up in the stacking direction (front-rear direction). Therefore, when the movable contact main body 431 is moved in the up-down direction (moving direction of the movable contact 430) to come into contact with the bottom surface 421aA, each of the first contact pieces 4312A can be brought into contact with the bottom surface 421aA without being obstructed by the other first contact pieces 4312A. As a result, all of the first contact pieces 4312A can be more reliably brought into contact with the bottom surface 421aA.

In this embodiment, the second fixed terminal 420B is provided, which is arranged in a separated state from the first fixed terminal 420A, and conduction and non-conduction between the first and second fixed terminals 420A and 420B is switched by the movable contact 430. The movable contact main body 431 includes a second contact unit 4311B that is electrically connected to the first contact unit 4311A and comes into contact with the second fixed terminal 420B.

Therefore, according to this embodiment, in the contact device 10 of a type that switches conduction and non-conduction between the first and second fixed terminals 420A and 420B, at least the electromagnetic repulsion force acting between the first fixed terminal 420A and the movable contact 430 can be further reduced.

In this event, the second contact unit 4311B may include a plurality of second contact pieces 4312B that come into contact with the second fixed terminal 420B.

Thus, it is possible to reduce the magnitude of the electromagnetic repulsion force received by the second contact unit 4311B from the second fixed terminal 420B.

Furthermore, at least one of the plurality of second contact pieces 4312B may be configured to be movable relative to the other second contact pieces 4312B.

With this configuration, it is possible to prevent all the second contact pieces 4312B from being separated from the second fixed terminal 420B by the electromagnetic repulsion force acting between the second fixed terminal 420B and the movable contact 430. That is, the state where any one of the second contact pieces 4312B is in contact with the second fixed terminal 420B can be more reliably maintained. As a result, the conductive state between the first and second fixed terminals 420A and 420B can be more reliably maintained.

In this embodiment, the movable contact main body 431 includes five (a plurality of) second movable-side plate members (second movable-side plate parts) 433B having the second contact pieces 4312B formed thereon. The five (plurality of) second movable-side plate members 433A are stacked (arranged in a line) in the front-rear direction, that is, in the direction intersecting with the up-down direction (moving direction of the movable contact 430). The stacking direction (front-rear direction) is also a direction that intersects with the left-right direction (direction in which the first and second fixed terminals 420A and 420B are arranged side by side).

With this configuration, the plurality of second contact pieces 4312B can be formed only by stacking the plurality of plate members (arranging the plurality of plate members in a line). Thus, the movable contact main body 431 having the plurality of second contact pieces 4312B can be obtained more easily. Moreover, by stacking the plurality of plate members (arranging the plurality of plate members in a line), at least one of the plurality of second contact pieces 4312B can be moved relative to the other second contact pieces 4312B with a simpler configuration. Furthermore, the plurality of first contact pieces 4312A and the plurality of second contact pieces 4312B are formed so as to be arranged in the stacking direction (front-rear direction). Therefore, when the movable contact main body 431 is moved in the up-down direction (moving direction of the movable contact 430) to come into contact with the bottom surface 421aB, each of the second contact pieces 4312B can be brought into the bottom surface 421aB without being obstructed by the other second contact pieces 4312B. As a result, all of the second contact pieces 4312B can be more reliably brought into contact with the bottom surface 421aB.

Furthermore, in this embodiment, the second movable-side plate member 433B and the movable-side plate member 433A are integrally formed. That is, five (a plurality of) plate members (plate members) 433 are formed, each having the first contact piece 4312A on one side and the second contact piece 4312B on the other side. The five (plurality of) plate members 433 are stacked in the front-rear direction (direction intersecting with the moving direction of the movable contact 430 and the direction in which the first and second fixed terminals 420A and 420B are arranged side by side) to form the movable contact main body 431.

Accordingly, a plurality of first contact pieces 4312A and a plurality of second contact pieces 4312B can be formed only by stacking the plate members 433 (arranging the plate members 433 in a line). That is, the movable contact main body 431 having the plurality of first contact pieces 4312A and the plurality of second contact pieces 4312B can be manufactured more easily. Furthermore, the plurality of first contact pieces 4312A and the plurality of second contact pieces 4312B are formed so as to be arranged in the stacking direction (front-rear direction). Therefore, when the movable contact main body 431 is moved in the up-down direction (moving direction of the movable contact 430) to come into contact with the respective bottom surfaces 421aA and 421aB, the respective contact pieces can be brought into contact with the bottom surfaces 421aA and 421aB without being obstructed by the other contact pieces. As a result, all the contact pieces can be more reliably brought into contact with the bottom surfaces 421aA and 421aB.

In the above embodiment, the description is given of the example where the five (plurality of) plate members 433 are held by the holder 460 using the support shaft 465. However, the present invention is not limited thereto. For example, as shown in FIG. 6, a configuration in which a plurality of plate members 433 are held by the holder 460 itself is also possible.

In FIG. 6, again, the movable contact 430 includes a movable contact main body 431 formed by stacking a plurality of plate members (plate members) 433 in the front-rear direction (arranging the plate members in a line), each having the first contact piece 4312A on one side and the second contact piece 4312B on the other side. A holder 460 is provided so as to surround the movable contact 430.

To be more specific, an approximately rectangular plate-shaped upper member 467 fixed to the shaft 380 and arranged above the movable contact 430 and an approximately U-shaped lower member 468 surrounding the lower side and the side of the movable contact 430 form the holder 460 surrounding the upper and lower surfaces and side surfaces of the movable contact 430. In FIG. 6, the lower surface of the bottom wall of the lower member 468 is pressed upward by the contact pressure spring 401. The contact pressure spring 401 is formed of a coil spring, and the shaft 380 is inserted inside the contact pressure spring 401.

Furthermore, in FIG. 6, a recess part 430a opened upward and on both sides in the front-rear direction is formed in the upper part of the center of the movable contact 430 in the left-right direction. The upper member 467 is arranged inside the recess part 430a when the movable contact 430 is held by the holder 460. Thus, it is possible to prevent the plate member 433 from falling out of the holder 460 opened on both sides in the left-right direction. It is preferable that the upper member 467 fixed to the shaft 380 is configured such that at least the lower part thereof is located inside the recess part 430a in a state where the movable contact 430 is in contact with the fixed terminals (first and second fixed terminals 420A and 420B) as shown in FIG. 6(b). Thus, even when the movable contact 430 is in contact with the fixed terminals (first and second fixed terminals 420A and 420B), the plate member 433 can be prevented from falling out of the holder 460.

It is also possible to form the upper and lower members 467 and 468 using a magnetic material, and to make the holder 460 function as a yoke.

Moreover, in the above embodiment, the description is given of the example where the movable contact main body 431 is formed by stacking the five (plurality of) plate members 433, each having the first and second contact pieces 4312A and 4312B formed thereon, in the front-rear direction (arranged the plate members in a line). However, the configuration of the movable contact main body 431 is not limited thereto.

For example, as shown in FIG. 7, a movable contact main body 431 can be configured by forming a plurality of first contact pieces 4312A on the side of a single plate member to be the first contact unit 4311A, whose both ends in the left-right direction serve as the first contact unit 4311A and the second contact unit 4311B.

In FIG. 7, the movable contact main body 431 is formed by using a plate member 4331 having an approximately rectangular shape when viewed from the thickness direction. This plate member 4331 has a shape in which notches 4331a having openings on the tip side and both sides in the thickness direction (up-down direction) are arranged in the transverse direction (front-rear direction) on one side in the longitudinal direction (left-right direction). Thus, a plurality of protruding pieces 4331b separated by the notches 4331a are formed on one side in the longitudinal direction. When the plurality of protruding pieces 4331b on one side in the longitudinal direction are opposed to the first fixed terminal 420A while the other side in the longitudinal direction is opposed to the second fixed terminal 420B, the plate member 4331 serves as the movable contact main body 431 having a plurality of first contact pieces 4312A. In this case, the movable contact main body 431 comes into contact with the first fixed terminal 420A at a plurality of spots, and comes into contact with the second fixed terminal 420B at one spot.

This also makes it possible to reduce the magnitude of the electromagnetic repulsion force received by the first contact unit 4311A from the first fixed terminal 420A.

Note that it is also possible that the plate member 4331 has a shape in which a plurality of notches are also provided on the other side in the longitudinal direction, and the movable contact main body 431 includes a plurality of first contact pieces 4312A and a plurality of second contact pieces 4312B formed therein. That is, it is also possible for the movable contact main body 431 to have a shape in which the plurality of first contact pieces 4312A and the plurality of second contact pieces 4312B are connected by a single central plate portion. In this case, the movable contact main body 431 comes into contact with the first fixed terminal 420A at a plurality of spots, and also comes into contact with the second fixed terminal 420B at a plurality of spots.

This also makes it possible to reduce the magnitude of the electromagnetic repulsion force received by the movable contact 430 from the fixed terminals (first and second fixed terminals 420A and 420B).

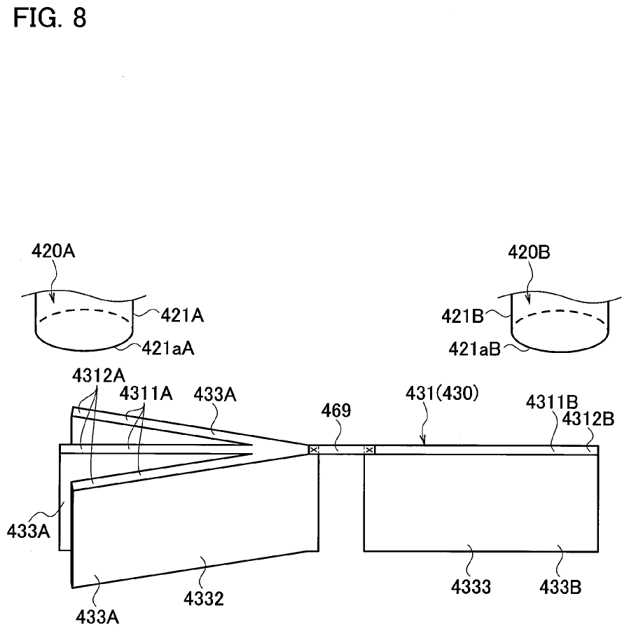

The movable contact main body 431 may also be configured as shown in FIG. 8. In FIG. 8, the movable contact main body 431 is formed by electrically connecting a one side member 4332 having a first contact unit 4311A having a plurality of first contact pieces 4312A formed therein to the other side member 4333 that is provided separately from the one side member 4332 and includes a second contact unit 4311B.

In FIG. 8, the other side member 4333 is formed of a single second movable-side plate member (second movable-side plate part) 433B. The one side member 4332 has a shape in which one end side (left side in FIG. 8) is branched such that the plurality of first movable-side plate parts 433A are arranged in the front-rear direction. Thus, the one side member 4332 shown in FIG. 8 is formed of one member. The one side member 4332 and the other side member 4333 are electrically connected to each other.

FIG. 8 illustrates an example where the one side member 4332 and the other side member 4333 (the second movable-side plate member 433B) have their ends electrically connected by a connecting member 469 formed of a conductive material. However, a method of electrically connecting the one side member 4332 and the other side member 4333 is not limited thereto, and various methods can be used. For example, the one side member 4332 and the other side member 4333 can be directly connected to each other for electrical connection.

In the one side member 4332 shown in FIG. 8, a gap formed between the adjacent first contact pieces 4312A is branched so as to be gradually wider toward the tip. Alternatively, the gap may be branched such that the plurality of first contact pieces 4312A are arranged approximately in parallel.

Alternatively, a movable contact main body 431 may be configured to have one side member 4332 formed of a plurality of movable-side plate members 433A. For example, when three movable-side plate members 433A are used, the movable contact main body 431 may be formed as follows.

First, two movable-side plate members 433A, each having one end bent, and one flat movable-side plate member 433A whose ends are not bent are prepared. Next, the flat movable-side plate member 433A whose ends are not bent is arranged such that the thickness direction is approximately aligned with the front-rear direction. Then, the movable-side plate members 433A, each having one end bent, are arranged on either side of the flat movable-side plate member 433A in the front-rear direction in a state where one side end is on the right side and the other side end (unbent side) is separated from the flat movable-side plate member 433A. In this event, the three movable-side plate members 433A may have one side ends in contact with each other, or at least one movable-side plate member 433A may be separated. Next, the one side ends of the three movable-side plate members 433A are electrically connected to the other side member 4333 by using the connecting member 469 or the like. Thus, a movable contact main body 431 is formed, in which the one side member 4332 formed of the plurality of movable-side plate members 433A is electrically connected to the other side member 4333. Note that the one side member 4332 may be formed by stacking a plurality of flat movable-side plate members 433A in the front-rear direction.

The second movable-side plate member (second movable-side plate part) 433B that constitutes the other side member 4333 may be arranged in a state where the thickness direction is approximately aligned with the up-down direction. In this event, the second contact unit 4311B may be brought into contact with the second fixed terminal 420B at one spot or a plurality of spots.

Alternatively, the other side member 4333 may have a second contact unit 4311B having a plurality of second contact pieces 4312B formed therein. This other side member 4333 can have the same shape as that of the one side member 4332 shown in FIG. 8 and its modified example. It is also possible to form the other side member 4333 by using a plurality of second movable-side plate members 433B. This other side member 4333 can be formed by the same method as the method described above for forming the one side member 4332 using a plurality of movable-side plate members 433A. It is also possible to form the other side member 4333 by stacking a plurality of flat second movable-side plate members 433B in the front-rear direction.

The one side member 4332 and the other side member 4333 electrically connected to each other may be pressed upward by using one contact pressure spring or using two or more contact pressure springs.

The same advantageous effects as those achieved in the above embodiment can also be achieved with these movable contact main bodies 431.

In the contact device 10 described above, the movable contact main body 431 is pressed upward by one contact pressure spring 401. That is, the plurality of contact pieces (first and second contact pieces 4312A and 4312B) are not individually pressed. The movable contact main body 431 is formed such that the height positions of the plurality of contact pieces are approximately the same, and the plurality of contact pieces having the same height position come into contact with the flat bottom surface of the fixed terminal.

With such a configuration, there is a possibility that there is a contact piece that does not come into contact with the fixed terminal due to an error generated during manufacturing or assembly, a positional shift during use, or the like. For this reason, it is preferable that all the contact pieces can be more reliably brought into contact with the fixed terminal even when an error, a positional shift, or the like occurs.

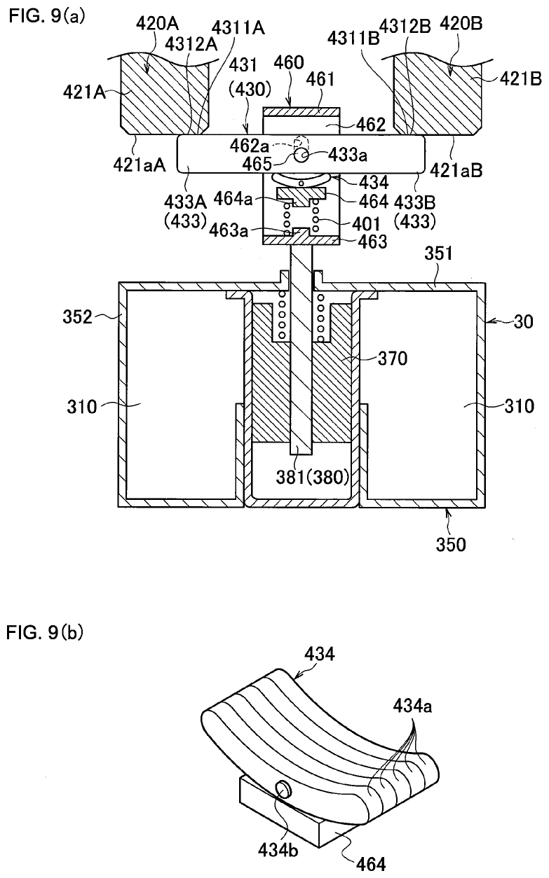

Such a contact device 10 can be realized by adopting a configuration shown in FIG. 9, for example.

To be more specific, a movable contact 430 shown in FIG. 9 includes a movable contact main body 431 including a first contact unit 4311A that comes into contact with a first fixed terminal 420A and a second contact unit 4311B that comes into contact with a second fixed terminal 420B.

In FIG. 9, again, the movable contact main body 431 is formed using five (a plurality of) plate-shaped members (plate members) 433, each having a first contact piece 4312A on one side and a second contact piece 4312B on the other side. That is, the movable contact main body 431 is formed by stacking the five plate members 433 in the front-rear direction (arranging the five plate members 433 so as to be lined up in the front-rear direction).

In FIG. 9, again, the movable contact 430 is held by the holder 460 in a state of being movable relative to the holder 460 in the up-down direction (one direction).

To be more specific, long holes 462a and 462a elongated in the up-down direction are formed on both side walls 462 and 462 of the holder 460, respectively. A round insertion hole (a plurality of insertion holes 433a communicated with each other) penetrating in the front-rear direction (width direction of the movable contact 430) is formed in the movable contact 430. The movable contact 430 is arranged between the side walls 462 and 462, and the support shaft 465 is inserted into the holes in a state where the round insertion hole is communicated with the pair of long holes 462a and 462a. E-rings 466 are attached to the portions of the support shaft 465 that protrude outward from the side walls 462. Thus, the movable contact 430 is held by the holder 460 so as to be relatively movable in the up-down direction in a state where the movable contact 430 is prevented from falling out of the holder 460.

A contact pressure spring 401 is disposed between a holding member 464 for placing and holding the movable contact 430 on top and a bottom wall 463 of the holder 460. The contact pressure spring 401 presses the movable contact 430 upward through the holding member 464.

Here, in the contact device 10 shown in FIG. 9, in a state where the first contact unit 4311A is in contact with the first fixed terminal 420A, a plurality of first contact pieces 4312A are pressed against the first fixed terminal 420A independently of the other first contact piece 4312A by a biasing member 434. At the same time, in a state where the second contact unit 4311B is in contact with the second fixed terminal 420B, the plurality of second contact pieces 43112B are pressed against the second fixed terminal 420B independently of the other second contact pieces 4312B by the biasing member 434.

In FIG. 9, the biasing member 434 is formed by stacking five leaf springs (biasing parts) 434a, each having its both ends curved upward, in the front-rear direction. In FIG. 9, the thickness of each leaf spring 434a is approximately the same as the thickness of the plate member 433, and each leaf spring 434a is held by a support shaft 434b so as to be rotatable independently. The biasing member 434 is disposed between the holding member 464 and the movable contact 430 in a state where one plate member 433 of the movable contact main body 431 is located above each leaf spring 434a. Thus, each leaf spring 434a is flexibly deformed independently to press the plate member 433 disposed thereabove in a state where the first contact unit 4311A comes into contact with the first fixed terminal 420A and the second contact unit 4311B comes into contact with the second fixed terminal 420B. That is, in FIG. 9, one leaf spring 434a presses one plate member 433, and thus the first contact piece 4312A formed on the one plate member 433 is pressed against the first fixed terminal 420A, and the second contact piece 4312B is pressed against the second fixed terminal 420B.

As described above, in FIG. 9, the five (plurality of) plate members 433 are separately and independently pressed by the biasing members 434. That is, the plurality of first contact pieces 4312A are separately and independently pressed, while the plurality of second contact pieces 43112B are separately and independently pressed.

Accordingly, the individual contact pieces (the plurality of first contact pieces 4312A and the plurality of second contact pieces 4312B) are pressed by the biasing member 434. Therefore, even if an error occurs during manufacturing or assembly, or a positional shift occurs during use, all of the plurality of first contact pieces 4312A can be more reliably brought into contact with the first fixed terminal 420A. At the same time, all of the plurality of second contact pieces 4312B can be more reliably brought into contact with the second fixed terminal 420B.

In FIG. 9, the biasing member 434 is arranged on the holding member 464 biased upward by the contact pressure spring 401. Alternatively, without using the contact pressure spring 401 and the holding member 464, the biasing member 434 may also be arranged on the bottom wall 463 of the holder 460.

FIG. 9 illustrates a biasing member 434 in which one biasing part (leaf spring 434a) presses the first contact piece 4312A and the second contact piece 4312B of one plate member 433. However, the biasing member 434 does not have to have the configuration shown in FIG. 9, but may also have a configuration in which a biasing part that presses the first contact piece 4312B of one plate member 433 and a biasing part that presses the second contact piece 4312B are provided separately.

As described above, when the individual contact pieces (the plurality of first contact pieces 4312A and the plurality of second contact pieces 4312B) are separately and independently pressed by the biasing member 434, the movable contact main body 431 can be configured to follow the shape of the fixed terminal (first and second fixed terminals 420A and 420B).

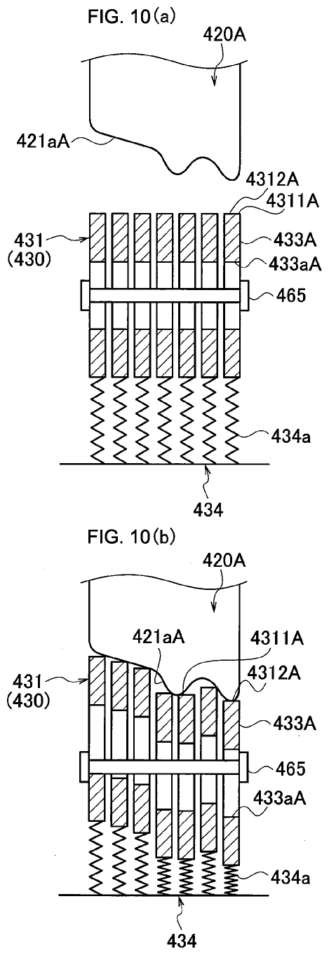

For example, as shown in FIG. 10, individual contact pieces (a plurality of first contact pieces 4312A and a plurality of second contact piece 4312B) can be brought into contact with an uneven surface (curved surface) 421aA of the fixed terminal (first and second fixed terminals 420A and 420B).

In FIG. 10, the movable contact main body 431 includes seven (a plurality of) first movable-side plate members (first movable-side plate parts) 433A having first contact pieces 4312A formed thereon. The seven movable-side plate members 433A are stacked (arranged so as to be lined up in the front-rear direction) in the front-rear direction (direction intersecting with the moving direction of the movable contact 430). The stacking direction (front-rear direction) is also a direction that intersects with the left-right direction (direction in which the first fixed terminals 420A and the second fixed terminals 420B are arranged side by side).

Long holes 433aA elongated in the up-down direction are formed in the seven movable-side plate members 433A, respectively, and a support shaft 465 is inserted into the long holes 433aA. Thus, the movable contact main body 431 is formed having the plurality of movable-side plate members 433A held so as to be relatively movable in the up-down direction.

In FIG. 10, the individual movable-side plate members 433A are separately and independently pressed by a coil spring (biasing part) 434a of the biasing member 434. Thus, the plurality of first contact pieces 4312A are brought into contact with the curved surface 421aA of the first fixed terminal 420A. That is, the movable contact main body 431 follows the shape of the curved surface 421aA of the first fixed terminal 420A.

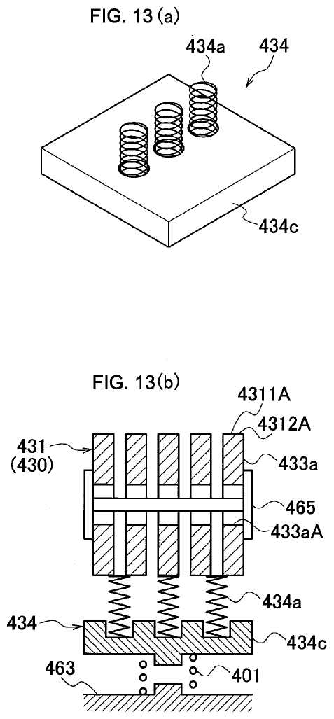

Although FIG. 10 illustrates the case where the plurality of first contact pieces 4312A are brought into contact with the curved surface 421aA of the first fixed terminal 420A, the same goes for the case where the plurality of second contact pieces 4312B are brought into contact with the curved surface of the second fixed terminal 420B. The same goes for the case where, by using a plurality of plate members 433, the plurality of second contact pieces 4312B are brought into contact with the curved surface of the second fixed terminal 420B while the plurality of first contact pieces 4312A are brought into contact with the curved surface 421aA of the first fixed terminal 420A. Although FIG. 10 illustrates an example where the biasing part 434a constituting a part of the biasing member 434 is a coil spring, the leaf spring 434a shown in FIG. 9 or another member having elastic restoring force may also be used as the biasing part. These also apply to FIGS. 13 to 16 to be described later.

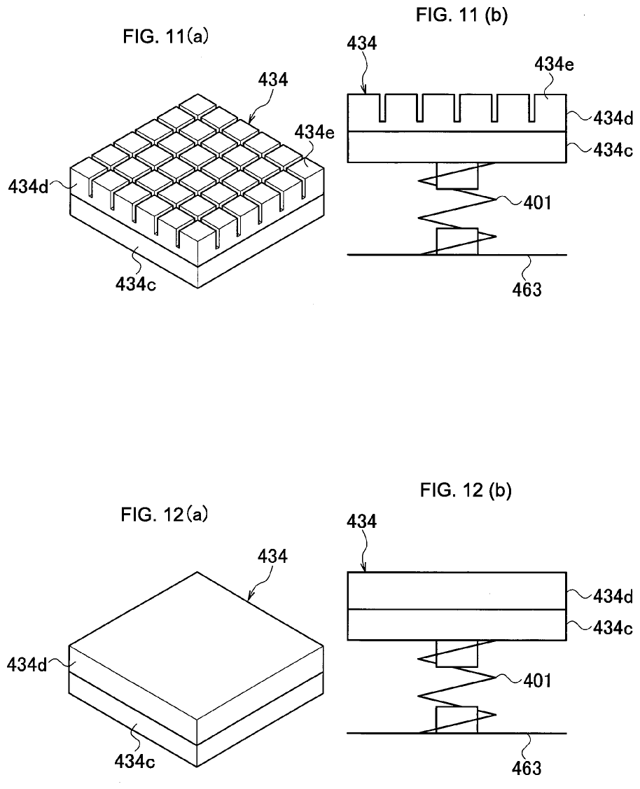

It is also possible to use one shown in FIG. 11 as the biasing member 434. In FIG. 11, a biasing member 434 is formed by mounting a flexible plate member 434d using a heat-resistant fluororesin or the like on a rigid base part 434c. Note that the base part 434c has approximately the same contour shape as the plate member 434d in a plan view. Therefore, the plate member 434d is placed on the upper surface of the base part 434c in a state where the entire shape is prevented from being significantly deflected.

Furthermore, slits are formed in a lattice pattern in the upper part of the plate member 434d. By forming slits in a lattice pattern in the upper part of the plate member 434d, a plurality of projections (biasing parts) 434e connected at the lower part are formed in the upper part of the plate member 434d. The plurality of projections 434e can be flexibly deformed separately and independently. Note that a method of forming the plurality of projections that can be flexibly deformed separately and independently is not limited to the above method, and the plurality of projections can be formed using various methods.

When the plurality of plate members 433 of the movable contact main body 431 are arranged, for example, on the plurality of projections 434e that can be flexibly deformed separately and independently, the plurality of plate members 433 are pressed separately and independently by the biasing member 434. In this case, the plurality of first contact pieces 4312A are separately and independently pressed, while the plurality of second contact pieces 43112B are separately and independently pressed.

For example, as shown in FIG. 11(b), the biasing member 434 can be disposed in a state of being pressed upward by the contact pressure spring 401 interposed between the base part 434c and the bottom wall 463 of the holder 460. As in the case of the biasing member 434 shown in FIG. 9, the biasing member 434 can also be disposed directly on the bottom wall 463 of the holder 460.

Alternatively, a biasing member shown in FIG. 12 can also be used. In FIG. 12, a biasing member 434 is formed by placing a plate member (biasing part) 434d having elastic restoring force on a rigid base part 434c. The plate member 434d having elastic restoring force can be obtained, for example, by molding a gel member, rubber, or the like into a plate shape. In FIG. 12, again, the base part 434c has approximately the same contour shape as the plate member 434d in plan view. Therefore, the plate member 434d is placed on the upper surface of the base part 434c in a state where the entire shape is prevented from being significantly deflected.

When the plurality of plate members 433 of the movable contact main body 431 are arranged, for example, on the plate member 434d having elastic restoring force, the plurality of plate members 433 are separately and independently pressed by the biasing member 434. In this case, the plurality of first contact pieces 4312A are separately and independently pressed, while the plurality of second contact pieces 43112B are separately and independently pressed.

Such a biasing member 434 can be disposed in a state of being pressed upward by a contact pressure spring 401 interposed between the base part 434c and the bottom wall 463 of the holder 460, for example, as shown in FIG. 12(b). As in the case of the biasing member 434 shown in FIG. 9, the biasing member 434 can also be disposed directly on the bottom wall 463 of the holder 460.

Alternatively, a biasing member 434 shown in FIG. 13 may also be used. In FIG. 13, the biasing member 434 is formed by arranging three coil springs (biasing parts) 434a on a rigid base part 434c so as to be arranged in the front-rear direction. For example, as shown in FIG. 13(b), the biasing member 434 can be disposed in a state of being pressed upward by a contact pressure spring 401 interposed between the base part 434c and the bottom wall 463 of the holder 460. As in the case of the biasing member 434 shown in FIG. 9, the biasing member 434 can also be disposed directly on the bottom wall 463 of the holder 460.

The biasing member 434 shown in FIG. 13 is configured such that the coil spring (biasing part) 434a disposed on the front side in the front-rear direction presses the two first contact pieces 4312A disposed on the front side in the front-rear direction, while the coil spring (biasing part) 434a disposed on the rear side in the front-rear direction presses the two first contact pieces 4312A disposed on the rear side in the front-rear direction. The coil spring (biasing part) 434a arranged at the center in the front-rear direction presses the single first contact piece 4312A arranged at the center in the front-rear direction.

As described above, in FIG. 13, the biasing member 434 has two (at least one) coil springs (biasing parts) 434a that separately and independently press the two first contact pieces 4312A. This makes it possible to reduce the number of coil springs (biasing parts) 434a used to press the plurality of contact pieces separately and independently.

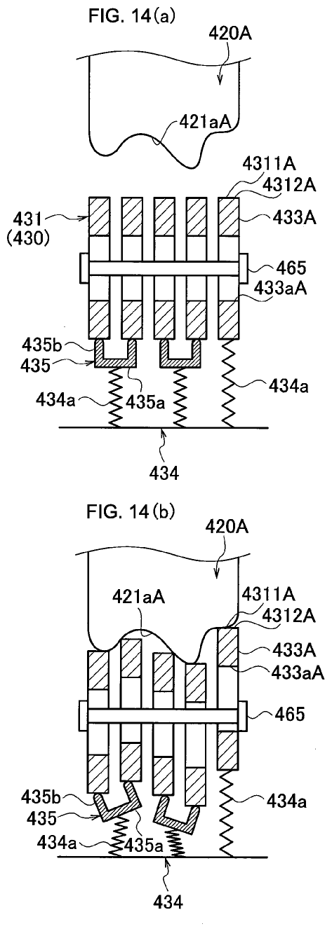

In this event, as shown in FIG. 14, it is preferable to interpose a balance member 435 between the coil spring (biasing part) 434a and the two first contact pieces 4312A. As shown in FIG. 14, the balance member 435 has an approximately U-shape, including a bottom wall 435a and a pair of side walls 435b and 435b connected to both ends in the front-rear direction of the bottom wall 435a.

The approximately U-shaped balance member 435 is arranged so that the bottom wall 435a is located above the coil spring 434a and the side walls 435b are located below the two first contact pieces 4312A. Thus, when the lower surface of the bottom wall 435a of the balance member 435 is pressed by the coil spring 434a, the elastic restoring force of the coil spring (biasing part) 434a is transmitted to the first contact piece 4312A via the respective side walls 435b.

Thus, with the balance member 435 interposed between the coil spring (biasing part) 434a and the two first contact pieces 4312A, the elastic restoring force of the coil spring (biasing part) 434a can be more reliably transmitted to the two first contact pieces 4312A.

The shape of the balance member 435 is not limited to the approximately U-shape, but may be any shape such as an approximately V-shape.

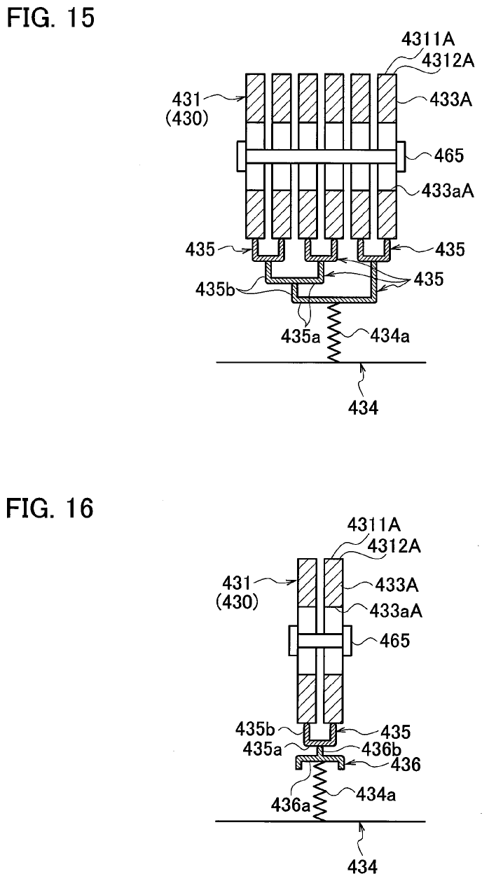

As shown in FIG. 15, it is also possible to adopt a configuration in which three or more first contact pieces 4312A are separately and independently pressed by one coil spring (biasing part) 434a. Such a configuration can be obtained by combining a plurality of balance members 435. For example, by connecting another balance member 435 to one side wall 435b of the balance member 435, the three first contact pieces 4312A can be separately and independently pressed by one coil spring 434a. Alternatively, by connecting another balance member 435 to the two side walls 435b, four first contact pieces 4312A can be separately and independently pressed by one coil spring 434a. Therefore, by combining a plurality of balance members 435, three or more first contact pieces 4312A can be separately and independently pressed by one coil spring 434a. FIG. 15 illustrates a configuration in which six first contact pieces 4312A can be separately and independently pressed by one coil spring 434a.

Thus, by combining a plurality of balance members 435, the number of coil springs (biasing parts) 434a used to press the plurality of contact pieces separately and independently can be further reduced.

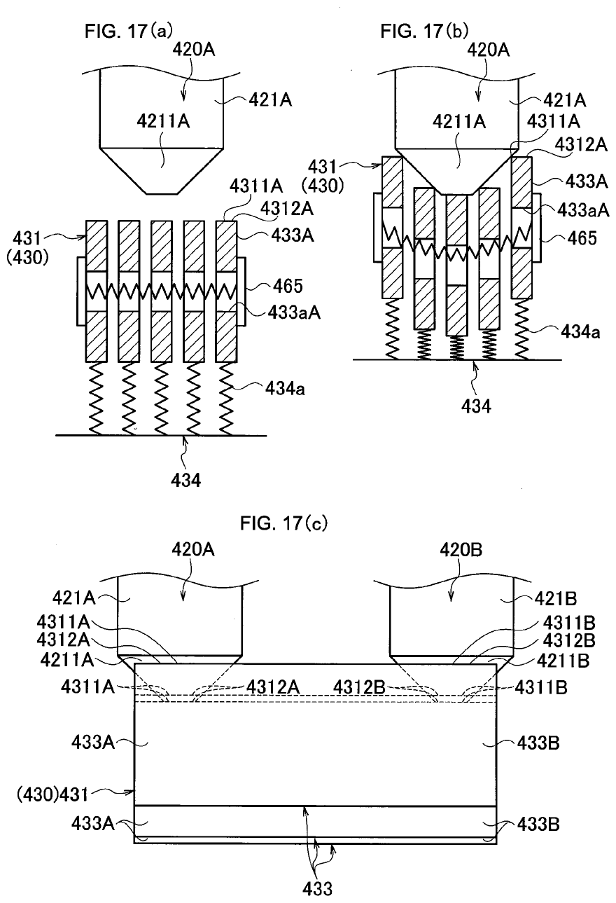

As shown in FIG. 16, a transmission member 436 may be interposed between the coil spring (biasing part) 434a and the balance member 435 to transmit the elastic restoring force of the coil spring (biasing part) 434a to the balance member 435 through the transmission member 436. In FIG. 16, the transmission member 436 includes a spring receiving part 436a that receives the coil spring (biasing part) 434a and a transmission projection 436b formed to project upward at the center of the spring receiving part 436a. By disposing the transmission projection 436b at the center of the bottom wall 435a of the balance member 435, the elastic restoring force of the coil spring (biasing part) 434a is transmitted to the center of the bottom wall 435a from the transmission projection 436b of the transmission member 436. This makes it possible to more evenly transmit the elastic restoring force of the coil spring (biasing part) 434a to the two first contact pieces 4312A.

Alternatively, the movable contact main body 431 may also be configured as shown in FIG. 17. In FIG. 17, a plurality of plate members 433 are held using a support shaft 465 formed of a flexibly deformable coil spring, instead of a rigid support shaft. In FIG. 17, the movable contact main body 431 is formed by holding the plurality of plate members 433 using the flexibly deformable support shaft 465.

With such a configuration, the individual contact pieces (first and second contact pieces 4312A and 4312B) can follow the shape of the fixed terminal (first and second fixed terminals 420A and 420B). FIG. 17 illustrates an example where five first contact pieces 4312A are brought into contact with a first fixed terminal 420A having a tapered portion 4211A formed in its lower portion, the tapered portion 4211A having a smaller diameter toward the lower side. FIG. 17 also illustrates an example where five second contact pieces 4312B are brought into contact with a second fixed terminal 420B having a tapered portion 4211B formed in its lower portion, the tapered portion 4211B having a smaller diameter toward the lower side.

Although FIG. 17 illustrates an example where the five plate members 433 are each pressed by one coil spring (biasing part) 434a, the configurations shown in FIGS. 9 and 11 to 16 may also be adopted.

With such a configuration, when the individual contact pieces (first and second contact pieces 4312A and 4312B) come into contact with the fixed terminals (first and second fixed terminals 420A and 420B), the support shaft 465 is flexibly deformed so as to follow the shape of the first fixed terminal 420A. As shown in FIGS. 17(b) and 17(c), the five plate members 433 are displaced such that the both ends are at the highest position and the central portion is at the lowest position.

In this event, the elastic restoring force generated on the support shaft 465 causes the two outer first contact pieces 4312A to sandwich the tapered portion 4211A of the first fixed terminal 420A, and the two outer second contact pieces 4312B to sandwich the tapered portion 4211B of the second fixed terminal 420B.

Thus, in FIG. 17, when the individual contact pieces (first and second contact pieces 4312A and 4312B) are brought into contact with the fixed terminals (first and second fixed terminals 420A and 420B), the two plate members 433 located on the outer side are arranged side by side in the front-rear direction. In this event, a current flows in the same direction through the two first contact pieces 4312A arranged side by side in the front-rear direction.

When a current in the same direction is applied to the juxtaposed members, force attracting each other acts on the juxtaposed members. Therefore, in a state where the individual contact pieces are in contact with the fixed terminal, force attracting each other acts on the two plate members 433 located outside. Therefore, with the configuration shown in FIG. 17, the two outer first contact pieces 4312A more firmly hold the tapered portion 4211A of the first fixed terminal 420A. As a result, the first contact piece 4312A can be prevented from being moved by the electromagnetic repulsion force acting between the first fixed terminal 420A and the first contact piece 4312A. Likewise, the two outer second contact pieces 4312B more firmly hold the tapered portion 4211B of the second fixed terminal 420B. As a result, the second contact piece 4312B can be prevented from being moved by the electromagnetic repulsion force acting between the second fixed terminal 420B and the second contact piece 4312B.

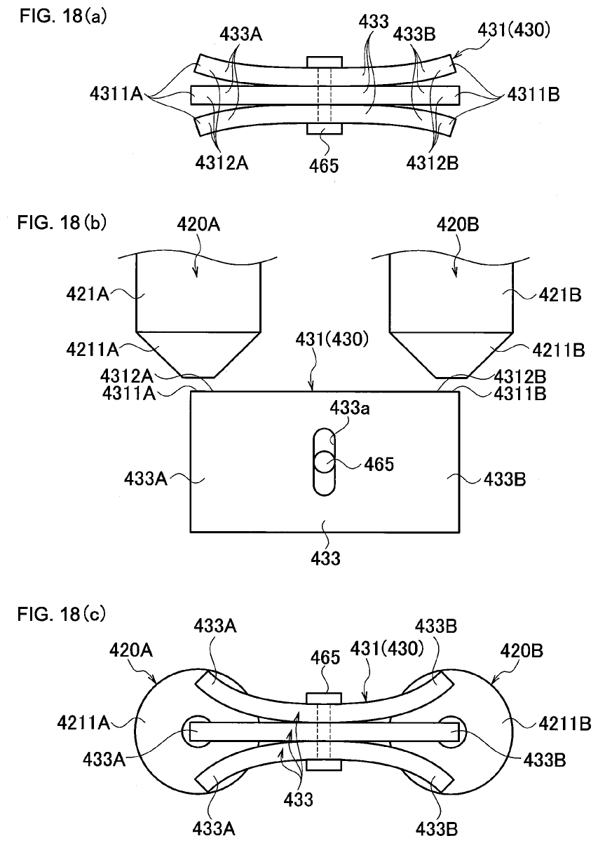

Alternatively, the movable contact main body 431 may also be configured as shown in FIG. 18. In FIG. 18, a flat plate member 433 is arranged at the center in the front-rear direction. A leaf spring curved so as to be elastically deformable in the thickness direction is used as the plate member 433. To be more specific, two elastically deformable plate members (leaf springs) 433 are disposed on both sides in the front-rear direction of the flat plate member 433 in a state where both ends in the left-right direction are separated from both ends of the flat plate member 433.

The three plate members 433 have long holes 433a formed therein, which are elongated in the up-down direction, and the support shaft 465 is inserted into the long holes 433a. Thus, the movable contact main body 431 is formed having the plurality of plate members 433 held so as to be relatively movable in the up-down direction.

With such a configuration, again, the individual contact pieces (first and second contact pieces 4312A and 4312B) can follow the shape of the fixed terminal (first and second fixed terminals 420A and 420B). FIG. 18 illustrates an example where three first contact pieces 4312A are brought into contact with a first fixed terminal 420A having a tapered portion 4211A formed in its lower portion, the tapered portion 4211A having a smaller diameter toward the lower side. FIG. 18 also illustrates an example where three second contact pieces 4312B are brought into contact with a second fixed terminal 420B having a tapered portion 4211B formed in its lower portion, the tapered portion 4211B having a smaller diameter toward the lower side.

In FIG. 18, again, the three plate members 433 can be each pressed by one coil spring (biasing part) 434a. It is also possible to use the biasing members 434 shown in FIGS. 9 and 11 to 16.

With such a configuration, when the individual contact pieces (first and second contact pieces 4312A and 4312B) come into contact with the fixed terminal (first and second fixed terminals 420A and 420B), the three plate members 433 are displaced so that both ends are located above and the center is located below.

In this event, the plate members 433 located at both ends in the front-rear direction slide on the tapered portions of the fixed terminals while being elastically deformed so that the tips on both sides in the left-right direction open outward in the front-rear direction. Therefore, the elastic restoring force generated at the plate members 433 located at both ends in the front-rear direction causes the two first contact pieces 4312A located outside to sandwich the tapered portion 4211A of the first fixed terminal 420A, and the two second contact pieces 4312B located outside to sandwich the tapered portion 4211B of the second fixed terminal 420B.

As described above, in FIG. 18, when the individual contact pieces (first and second contact pieces 4312A and 4312B) are brought into contact with the fixed terminals (first and second fixed terminals 420A and 420B), the two plate members 433 located outside are arranged side by side in the front-rear direction. In this event, a current flows in the same direction through the two first contact pieces 4312A arranged side by side in the front-rear direction.

Therefore, with the configuration shown in FIG. 18, again, the two first contact pieces 4312A located outside more firmly hold the tapered portion 4211A of the first fixed terminal 420A. As a result, the first contact piece 4312A can be prevented from being moved by the electromagnetic repulsion acting between the first fixed terminal 420A and the first contact piece 4312A. Likewise, the two second contact pieces 4312B located outside more firmly hold the tapered portion 4211B of the second fixed terminal 420B. As a result, the second contact piece 4312B can be prevented from being moved by the electromagnetic repulsion acting between the second fixed terminal 420B and the second contact piece 4312B.

The contact device 10 is not limited to the configurations described above but may have various configurations.

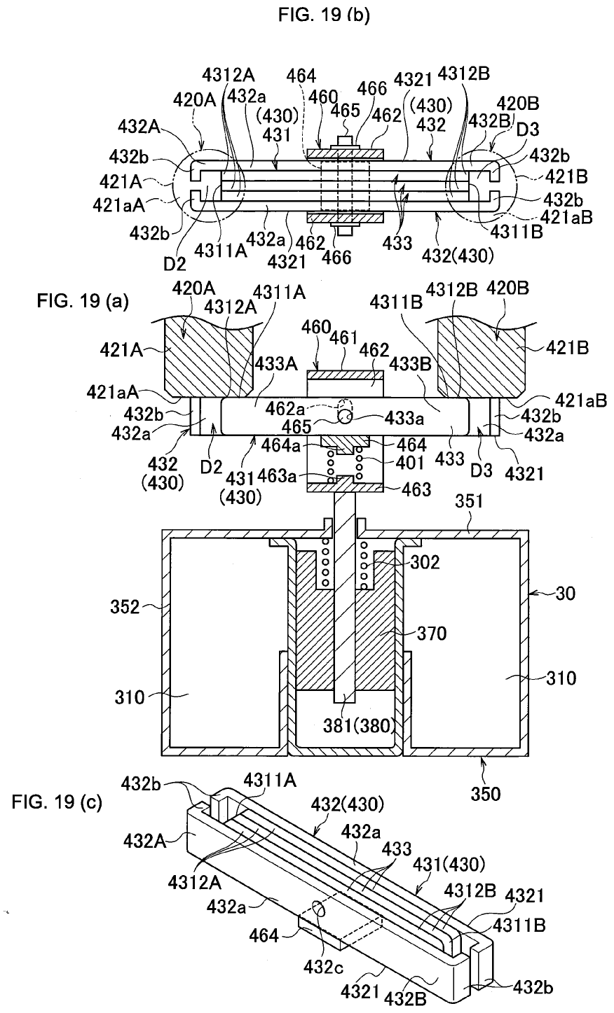

For example, the contact device 10 may also have a configuration shown in FIG. 19.

As in the case of the movable contact 430 described in the above embodiment, a movable contact 430 shown in FIG. 19 also includes a movable contact main body 431 including a first contact unit 4311A that comes into contact with a first fixed terminal 420A and a second contact unit 4311B that comes into contact with a second fixed terminal 420B.

As in the case of the above embodiment, the movable contact main body 431 shown in FIG. 19 is also formed by stacking a plurality of approximately rectangular plate members 433 in the front-rear direction (arranging the plate members so as to be lined up in the front-rear direction), each having a first contact piece 4312A on one side and a second contact piece 4312B on the other side. In FIG. 19, the movable contact main body 431 is formed by stacking three plate members 433 in the front-rear direction.

In the movable contact main body 431 shown in FIG. 19, again, the first contact unit 4311A includes a plurality of first contact pieces 4312A that come into contact with the first fixed terminal 420A. The plurality of first contact pieces 4312A are separately and independently movable in the up-down direction (rotatable about the support shaft 465). That is, at least one of the plurality of first contact pieces 4312A is movable relative to the other first contact pieces 4312A.

The second contact unit 4311B includes a plurality of second contact pieces 4312B that come into contact with the second fixed terminal 420B. The plurality of second contact pieces 4312B are separately and independently movable in the up-down direction (rotatable about the support shaft 465). That is, at least one of the plurality of second contact pieces 4312B is movable relative to the other second contact pieces 4312B.

Here, the movable contact 430 shown in FIG. 19 includes a first outer movable contact main body 432A arranged around the first contact unit 4311A of the movable contact main body 431, separately from the movable contact main body 431. The movable contact 430 also includes a second outer movable contact main body 432B arranged around the second contact unit 4311B of the movable contact main body 431, separately from the movable contact main body 431.

In FIG. 19, the first outer movable contact main body 432A and the second outer movable contact main body 432B are integrally formed.

That is, in FIG. 19, the movable contact 430 includes an outer movable contact main body 432 arranged around the first and second contact units 4311A and 4311B of the movable contact main body 431, separately from the movable contact main body 431.

To be more specific, the outer movable contact main body 432 is formed by using two plate members 4321 each having a shape in which both ends in the longitudinal direction of one plate member are bent in the same direction. That is, the outer movable contact main body 432 is formed by using two plate members 4321 formed in an approximately U-shape using a side wall part 432a and a pair of bent pieces 432b and 432b provided at both ends of the side wall part 432a. The length of the side wall part 432a in the longitudinal direction is longer than the length of the plate member 433 in the longitudinal direction.

The two plate members 4321 are arranged so as to sandwich the movable contact main body 431 in the front-rear direction. To be more specific, one plate member 4321 is disposed in front of the movable contact main body 431 so as to come into contact with the front surface of the movable contact main body 431, and the other plate member 4321 is arranged behind the movable contact main body 431 so as to come into contact with the rear surface of the movable contact main body 431. In this event, the one plate member 4321 is arranged in front of the movable contact main body 431 in a state where the thickness direction of the side wall part 432a is approximately aligned with the front-rear direction and the tips of the pair of bent pieces 432b and 432b face rearward. Meanwhile, the other plate member 4321 is arranged behind the movable contact main body 431 in a state where the thickness direction of the side wall part 432a is approximately aligned with the front-rear direction and the tips of the pair of bent pieces 432b and 432b face forward.

Thus, the outer movable contact main body 432 is arranged around the first and second contact units 4311A and 4311B of the movable contact main body 431. FIG. 19 illustrates an example where the bent piece 432b of the one plate member 4321 and the bent piece 432b of the other plate member 4321 are separated in the front-rear direction on both sides in the left-right direction. However, the bent piece 432b of the one plate member 4321 and the bent piece 432b of the other plate member 4321 do not have to be separated on both sides in the left-right direction. That is, the bent piece 432b of the one plate member 4321 and the bent piece 432b of the other plate member 4321 may be in contact with each other on at least one side in the left-right direction. Alternatively, a frame-shaped member may be used as the outer movable contact main body 432, and this outer movable contact main body 432 may be arranged so as to surround the entire circumference of the movable contact main body 431. Alternatively, an approximately C-shaped member that is partially notched may be used as the outer movable contact main body 432.

In FIG. 19, a gap is formed between the bent piece 432b and the movable contact main body 431. That is, a first gap D2 is provided between the first contact unit 4311A of the movable contact main body 431 and the outer movable contact main body 432. A second gap D3 is also provided between the second contact unit 4311B and the outer movable contact main body 432.

The movable contact 430 shown in FIG. 19 is also held by the holder 460 in a state of being movable relative to the holder 460 in the up-down direction (one direction). Note that a round insertion hole 432c is formed in the side wall part 432a of the outer movable contact main body 432. By inserting the support shaft 465 into the round insertion hole 432c, the outer movable contact main body 432 is held on the holder 460 by the support shaft 465 together with the movable contact main body 431. In FIG. 19, again, the support shaft 465 is held by the holder 460 in a state of being movable relative to the holder 460 in the up-down direction (one direction). Therefore, when the support shaft 465 is moved in the up-down direction (one direction) relative to the holder 460, the outer movable contact main body 432 is moved in the up-down direction (one direction) relative to the holder 460 together with the movable contact main body 431.

A contact pressure spring 401 is disposed between a holding member 464 for placing and holding the movable contact 430 on top and a bottom wall 463 of the holder 460. The contact pressure spring 401 presses the movable contact 430 upward through the holding member 464.

Here, in FIG. 19, in an assembled state of the contact device 10, the first contact unit 4311A of the movable contact main body 431 is opposed to the inner side in the left-right direction of the bottom surface 421aA of the first fixed terminal 420A. The inner side of the bottom surface 421aA in the left-right direction refers to a region located on the second fixed terminal 420B side in a region of the bottom surface 421aA that is divided by a straight line passing through the center of the bottom surface 421aA and extending in the front-rear direction. At the same time, the bent piece 432b defining the first gap D2 of the outer movable contact main body 432 is opposed to the outer side in the left-right direction of the bottom surface 421aA of the first fixed terminal 420A.

Furthermore, the second contact unit 4311B of the movable contact main body 431 is opposed to the inner side of the bottom surface 421aB of the second fixed terminal 420B in the left-right direction. The inner side of the bottom surface 421aB in the left-right direction refers to a region located on the first fixed terminal 420A side in a region of the bottom surface 421aB that is divided by a straight line passing through the center of the bottom surface 421aB and extending in the front-rear direction. At the same time, the bent piece 432b defining the second gap D3 of the outer movable contact main body 432 is opposed to the outer side in the left-right direction of the bottom surface 421aB of the second fixed terminal 420B.

With such a configuration, when the shaft (drive shaft) 380 is moved upward (to one side) in the up-down direction (one direction), the movable contact 430 is also moved upward and comes into contact with the first fixed terminal 420A and the second fixed terminal 420B.

In this event, the plurality of first contact pieces 4312A formed on the first contact unit 4311A of the movable contact main body 431 come into contact with the inner side of the bottom surface 421aA of the first fixed terminal 420A. The bent piece 432b that defines the first gap D2 of the outer movable contact main body 432 comes into contact with the outer side of the bottom surface 421aA of the first fixed terminal 420A.

Likewise, the plurality of second contact pieces 4312B formed on the second contact unit 4311B of the movable contact main body 431 come into contact with the inner side of the bottom surface 421aB of the second fixed terminal 420B. The bent piece 432b that defines the second gap D3 of the outer movable contact main body 432 comes into contact with the outer side of the bottom surface 421aB of the second fixed terminal 420B.

On the other hand, when the shaft (drive shaft) 380 is moved downward (to the other side) in the up-down direction (one direction), the movable contact 430 is also moved downward and separated from both of the first and second fixed terminals 420A and 420B. That is, the plurality of first contact pieces 4312A and the bent piece 432b that defines the first gap D2 of the outer movable contact main body 432 are separated from the bottom surface 421aA of the first fixed terminal 420A. At the same time, the plurality of second contact pieces 4312B and the bent piece 432b that defines the second gap D3 of the outer movable contact main body 432 are separated from the bottom surface 421aB of the second fixed terminal 420B.

Thus, the same advantageous effects as in the above embodiment can also be achieved with the contact device 10 having the configuration shown in FIG. 19.

FIG. 19 illustrates the example where two approximately U-shaped plate members 4321 elongated in the left-right direction are used to form the outer movable contact main body 432 disposed around the first and second contact units 4311A and 4311B of the movable contact main body 431.

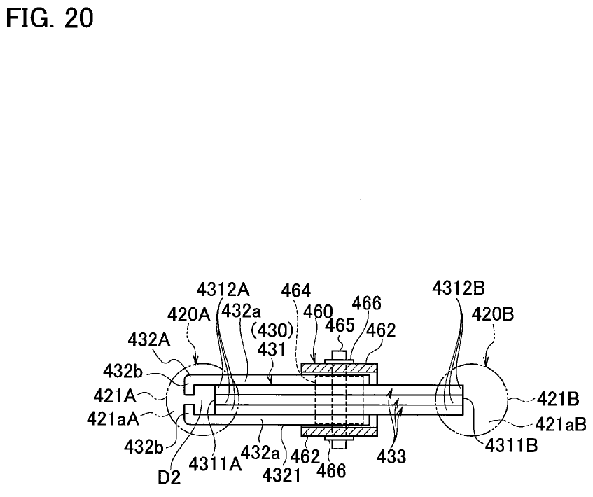

However, the outer movable contact main body 432 does not have to have such a configuration. For example, as shown in FIG. 20, only the first outer movable contact main body 432A of the first and second outer movable contact main bodies 432A and 432B may be formed. FIG. 20 illustrates an example where the first outer movable contact main body 432A is formed by using two plate members 4321, one of which has a shape in which one end in the longitudinal direction is bent.

An approximately U-shaped plate member having bent pieces formed at both ends of a side wall part extending in the front-rear direction may be disposed around the first contact unit 4311A of the movable contact main body 431 to form the first outer movable contact main body 432A. In this event, a first gap D2 may be provided between the first contact unit 4311A of the movable contact main body 431 and the first outer movable contact main body 432A.

Likewise, an approximately U-shaped plate member having bent pieces formed at both ends of a side wall part extending in the front-rear direction may be disposed around the second contact unit 4311B of the movable contact main body 431 to form the second outer movable contact main body 432B. In this event, a second gap D3 may be provided between the second contact unit 4311B of the movable contact main body 431 and the second outer movable contact main body 432B.

Alternatively, the first outer movable contact main body 432A and the second outer movable contact main body 432B formed separately from the first outer movable contact main body 432A may be provided.

Such a configuration is achieved, for example, by disposing an approximately U-shaped plate member having bent pieces formed at both ends of a side wall extending in the front-rear direction around the first and second contact units 4311A and 4311B of the movable contact main body 431. In this event, the first gap D2 may be provided between the first contact unit 4311A of the movable contact main body 431 and the first outer movable contact main body 432A, or the second gap D3 may be provided between the second contact unit 4311B and the second outer movable contact main body 432B.

Thus, the same advantageous effects as those achieved with the contact device 10 shown in FIG. 19 can be achieved.

It is also possible that the three plate members 433 constituting the movable contact main body 431 and the two plate members 4321 constituting the outer movable contact main body 432 are separately and independently pressed by the biasing member 434 described above.

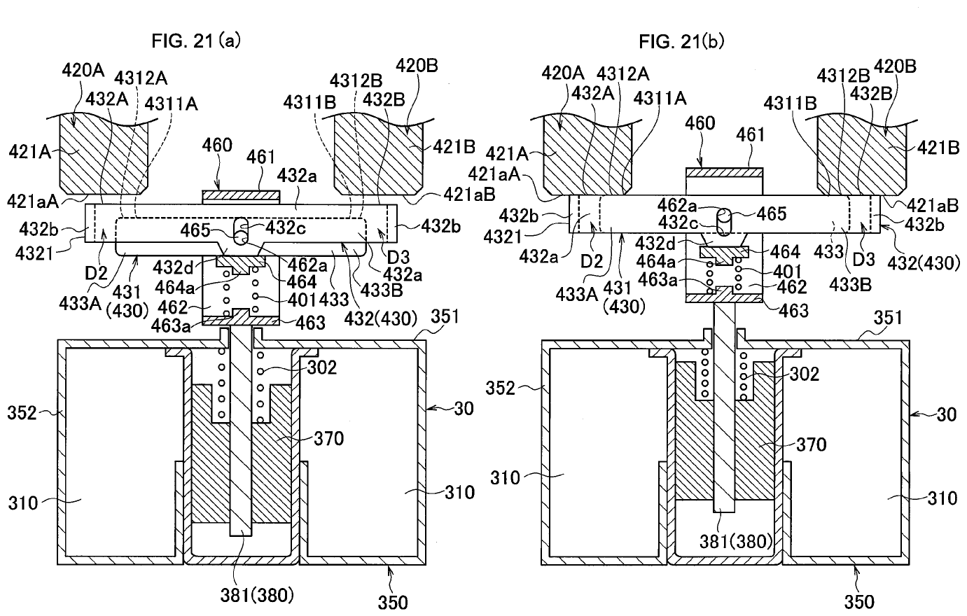

Alternatively, the contact device 10 may also have a configuration shown in FIG. 21.

In FIG. 21, again, a movable contact 430 includes a movable contact main body 431 and an outer movable contact main body 432 arranged around a first contact unit 4311A and a second contact unit 4311B of the movable contact main body 431. The movable contact main body 431 shown in FIG. 21 has the same configuration as the movable contact main body 431 shown in FIG. 19, and the outer movable contact main body 432 shown in FIG. 21 has approximately the same configuration as the outer movable contact main body 432 shown in FIG. 19.

Here, in FIG. 21, the first outer movable contact main body 432A is configured to be movable in the up-down direction (one direction) relative to the movable contact main body 431. In a non-conductive state (when the movable contact 430 is separated from the first fixed terminal 420A), the first outer movable contact main body 432A is located above the movable contact main body 431 (on the first fixed terminal 420A side).

Furthermore, the second outer movable contact main body 432B is configured to be movable in the up-down direction (one direction) relative to the movable contact main body 431. In a non-conductive state (when the movable contact 430 is separated from the second fixed terminal 420B), the second outer movable contact main body 432B is located above the movable contact main body 431 (on the second fixed terminal 420B side).

That is, the outer movable contact main body 432 is configured to be movable in the up-down direction (one direction) relative to the movable contact main body 431. In the non-conductive state, the outer movable contact main body 432 is arranged above the movable contact main body 431 (on the first fixed terminal 420A side and the second fixed terminal 420B side).

To be more specific, a long insertion hole 432c elongated in the up-down direction is formed in the side wall part 432a of the outer movable contact main body 432. By inserting the support shaft 465 into the long insertion hole 432c, the outer movable contact main body 432 is held on the holder 460 by the support shaft 465 together with the movable contact main body 431.

In FIG. 21, round holes 462a and 462a are formed in the both side walls 462 and 462 of the holder 460, respectively. Therefore, in a state where the outer movable contact main body 432 and the movable contact main body 431 are held on the holder 460 by the support shaft 465, the outer movable contact main body 432 is movable in the up-down direction (one direction) relative to the holder 460. That is, in FIG. 21, as the shaft (drive shaft) 380 is moved in the up-down direction (one direction), the holder 460 and the movable contact main body 431 are moved integrally.

A contact pressure spring 401 is disposed between a holding member 464 for placing and holding the movable contact 430 on top and a bottom wall 463 of the holder 460. The contact pressure spring 401 presses the movable contact 430 upward through the holding member 464.

In FIG. 21, an approximately trapezoidal projection 432d projecting downward is formed at the center in the left-right direction of the side wall part 432a of the outer movable contact main body 432. This projection 432d is placed in surface contact with the upper surface of the holding member 464. The projection 432d is formed so as to have its tip positioned below the lower surface of the movable contact main body 431 in a state where the upper surface of the outer movable contact main body 432 and the upper surface of the movable contact main body 431 are approximately flush with each other (see FIG. 21(b)).

With such a configuration, in the non-conductive state, the contact pressure spring 401 presses the outer movable contact main body 432 upward through the holding member 464, thereby the outer movable contact main body 432 is moved upward relative to the holder 460 and the movable contact main body 431. This relative movement is performed until the support shaft 465 comes into contact with the lower end of the long insertion hole 432c. In FIG. 21, the tip of the projection 432d is flush with the lower surface of the movable contact main body 431 in a state where the support shaft 465 is in contact with the lower end of the insertion hole 432c (see FIG. 21(a)).

In FIG. 21, again, when the shaft (drive shaft) 380 is moved upward (to one side) in the up-down direction (one direction), the movable contact 430 is also moved upward and comes into contact with the first and second fixed terminals 420A and 420B.

To be more specific, when the movable contact 430 is moved upward, both ends of the outer movable contact main body 432 in the left-right direction first comes into contact with the outer side of the bottom surface 421aA of the first fixed terminal 420A and the outer side of the bottom surface 421aB of the second fixed terminal 420B.

When the shaft 380 is further moved upward in a state where both ends of the outer movable contact main body 432 in the left-right direction are in contact with the respective fixed terminals, the holder 460 and the movable contact main body 431 are moved upward relative to the outer movable contact main body 432.

When the movable contact main body 431 is thus moved upward relative to the outer movable contact main body 432, the plurality of first contact pieces 4312A formed in the first contact unit 4311A of the movable contact main body 431 come into contact with the inner side of the bottom surface 421aA of the first fixed terminal 420A. At the same time, the plurality of second contact pieces 4312B formed in the second contact unit 4311B of the movable contact main body 431 come into contact with the inner side of the bottom surface 421aB of the second fixed terminal 420B.

On the other hand, when the shaft (drive shaft) 380 is moved downward (to the other side) in the up-down direction (one direction), the movable contact 430 is also moved downward and separated from both of the first and second fixed terminals 420A and 420B.

To be more specific, as the shaft 380 is moved downward, the holder 460 and the movable contact main body 431 are also moved downward. In this event, the outer movable contact main body 432 is pressed upward by the contact pressure spring 401. Therefore, when the shaft 380 is moved downward with the both ends of the outer movable contact main body 432 in the left-right direction in contact with the respective fixed terminals, the holder 460 and the movable contact main body 431 are moved downward relative to the outer movable contact main body 432.

When the shaft 380 is thus moved downward, the plurality of first contact pieces 4312A are first separated from the bottom surface 421aA of the first fixed terminal 420A, and the plurality of second contact pieces 4312B are separated from the bottom surface 421aB of the second fixed terminal 420B.

The downward movement of the holder 460 and the movable contact main body 431 relative to the outer movable contact main body 432 is performed until the support shaft 465 comes into contact with the lower end of the long insertion hole 432c. Therefore, when the support shaft 465 comes into contact with the lower end of the long insertion hole 432c, the outer movable contact main body 432 is also moved downward together with the holder 460 and the movable contact main body 431.

When the outer movable contact main body 432 is moved downward, the bent piece 432b defining the second gap D3 of the outer movable contact main body 432 is separated from the bottom surface 421aA of the first fixed terminal 420A. At the same time, the bent piece 432b defining the second gap D3 of the outer movable contact main body 432 is separated from the bottom surface 421aB of the second fixed terminal 420B.

Thus, the movable contact 430 is separated from both of the first and second fixed terminals 420A and 420B.

Accordingly, in the movable contact 430 shown in FIG. 21, the outer movable contact main body 432 comes into contact with the respective fixed terminals before the movable contact main body 431 and is separated from the respective fixed terminals after the movable contact main body 431. Thus, the arc can be mainly generated by the outer movable contact main body 432. That is, in the movable contact 430 shown in FIG. 21, the contact of the movable contact main body 431 serves as a contact mainly used for energization, and the contact of the outer movable contact main body 432 serves as a contact mainly used for arc generation.

Thus, the same advantageous effects as those achieved with the contact device 10 shown in FIG. 19 can also be achieved with the contact device 10 having the configuration shown in FIG. 21.

In FIG. 21, the outer movable contact main body 432 is configured to be movable in the up-down direction (one direction) relative to the movable contact main body 431. In the non-conductive state, the outer movable contact main body 432 is arranged above the movable contact main body 431 (on the first fixed terminal 420A side and the second fixed terminal 420B side).

Accordingly, the arc can be mainly generated by the outer movable contact main body 432, and the movable contact main body 431 can be more reliably prevented from being affected by the arc.

FIG. 21 also illustrates the example where the two approximately U-shaped plate members 4321 elongated in the left-right direction are used to form the outer movable contact main body 432 disposed around the first contact unit 4311A and the second contact unit 4311B of the movable contact main body 431. However, the configuration of the outer movable contact main body 432 is not limited thereto. For example, the first outer movable contact main body 432A shown in FIG. 20 and the first and second outer movable contact main bodies 432A and 432B described as a modified example of FIG. 19 may be used and configured to be movable in the up-down direction (one direction) relative to the movable contact main body 431. In the non-conductive state, the first and second outer movable contact main bodies 432A and 432B may be arranged on the upper side (on the first fixed terminal 420A side and the second fixed terminal 420B side).

Thus, the same advantageous effects as those achieved with the contact device 10 shown in FIG. 21 can also be achieved.

In FIG. 21, again, the three plate members 433 constituting the movable contact main body 431 and the two plate members 4321 constituting the outer movable contact main body 432 may be separately and independently pressed by the biasing member 434 described above.

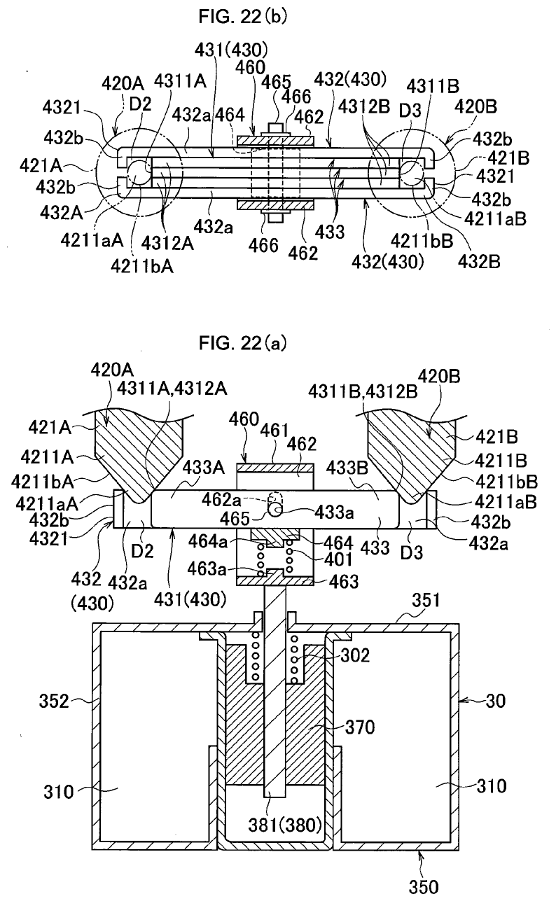

Alternatively, the contact device 10 may also have a configuration shown in FIG. 22.

In FIG. 22, again, a movable contact 430 includes a movable contact main body 431 and an outer movable contact main body 432 arranged around a first contact unit 4311A and a second contact unit 4311B of the movable contact main body 431. The movable contact main body 431 shown in FIG. 22 has the same configuration as the movable contact main body 431 shown in FIG. 19, and the outer movable contact main body 432 shown in FIG. 22 has the same configuration as the outer movable contact main body 432 shown in FIG. 19. That is, the movable contact 430 shown in FIG. 22 has the same configuration as the movable contact 430 shown in FIG. 19.

Here, in FIG. 22, a first defining part is formed in the first fixed terminal 420A. The first defining part enters the first gap D2 and defines the movable contact main body 431 and the outer movable contact main body 432 during the conductive state.

To be more specific, a tapered portion 4211A having a smaller diameter toward the lower side is formed below the first fixed terminal 420A.

When the coil 330 is energized to set the first and second fixed terminals 420A and 420B in a conductive state (when the movable contact 430 is in contact with the first fixed terminal 420A), the tapered portion 4211A has its tip 4211aA enter the first gap D2. The movable contact main body 431 and the outer movable contact main body 432 are defined by the tip 4211aA by making the tip 4211aA of the tapered portion 4211A enter the first gap D2. Accordingly, in FIG. 22, the tip 4211aA of the tapered portion 4211A serves as the first defining part that enters the first gap D2 to define the movable contact main body 431 and the outer movable contact main body 432.

When the first and second fixed terminals 420A and 420B are brought into a conductive state, the plurality of first contact pieces 4312A formed in the first contact unit 4311A of the movable contact main body 431 come into contact with the inner side of the tapered surface 4211bA of the tapered portion 4211A. Meanwhile, the bent piece 432b defining the first gap D2 of the outer movable contact main body 432 comes into contact with the outer side of the tapered surface 4211bA of the tapered portion 4211A.

In FIG. 22, a second defining part is formed in the second fixed terminal 420B. The second defining part enters the second gap D3 to define the movable contact main body 431 and the outer movable contact main body 432 during the conductive state.

To be more specific, a tapered portion 4211B having a smaller diameter toward the lower side is formed below the second fixed terminal 420B.

When the coil 330 is energized to set the first and second fixed terminals 420A and 420B in a conductive state (when the movable contact 430 is in contact with the second fixed terminal 420B), the tapered portion 4211B has its tip 4211aB enter the second gap D3. The movable contact main body 431 and the outer movable contact main body 432 are defined by the tip 4211aB by making the tip 4211aB of the tapered portion 4211B enter the second gap D3. Accordingly, in FIG. 22, the tip 4211aB of the tapered portion 4211B serves as the second defining part that enters the second gap D3 to define the movable contact main body 431 and the outer movable contact main body 432.

When the first and second fixed terminals 420A and 420B are brought into a conductive state, the plurality of second contact pieces 4312B formed in the second contact unit 4311B of the movable contact main body 431 come into contact with the inner side of the tapered surface 4211bB of the tapered portion 4211B. Meanwhile, the bent piece 432b defining the second gap D3 of the outer movable contact main body 432 comes into contact with the outer side of the tapered surface 4211bB of the tapered portion 4211B.

Thus, the same advantageous effects as those achieved with the contact device 10 shown in FIG. 19 can also be achieved with the contact device 10 having the configuration shown in FIG. 22.

In FIG. 22, a first gap D2 is provided between the first contact unit 4311A of the movable contact main body 431 and the first outer movable contact main body 432A. Meanwhile, a second gap D3 is provided between the second contact unit 4311B and the second outer movable contact main body 432B.

When the movable contact 430 is in contact with the first fixed terminal 420A, the tip 4211aA of the first fixed terminal 420A enters the first gap D2.

When the first and second fixed terminals 420A and 420B are in a conductive state, the tip 4211aB of the second fixed terminal 420B enters the second gap.

Accordingly, it is possible to prevent an arc generated during separation of the outer movable contact main body 432 that comes into contact outside of the first and second fixed terminals 420A and 420B from coming into contact with the inner movable contact main body 431. As a result, the movable contact main body 431 can be more reliably prevented from being affected by the arc.

In FIG. 22, a plurality of first contact pieces 4312A formed in the first contact unit 4311A of the movable contact main body 431 are brought into contact with the inner side of the tapered surface 4211bA of the tapered portion 4211A. Meanwhile, the bent piece 432b that defines the first gap D2 of the outer movable contact main body 432 is brought into contact with the outer side of the tapered surface 4211bA of the tapered portion 4211A.

Therefore, obliquely downward electromagnetic repulsion force is generated between the first fixed terminal 420A and the first contact piece 4312A and between the first fixed terminal 420A and the bent piece 432b defining the first gap D2.

Thus, component force of the electromagnetic repulsion force can be used as force transmitted to the shaft (drive shaft) 380 (force moving the shaft 380 downward). Therefore, the electromagnetic repulsion force acting on the shaft (drive shaft) 380 (force in the direction of setting the first and second fixed terminals 420A and 420B in a non-conductive state) can be further reduced.

Likewise a plurality of second contact pieces 4312B formed in the second contact unit 4311B of the movable contact main body 431 are brought into contact with the inner side of the tapered surface 4211bB of the tapered portion 4211B. Meanwhile, the bent piece 432b that defines the second gap D3 of the outer movable contact main body 432 is brought into contact with the outer side of the tapered surface 4211bB of the tapered portion 4211B.

Thus, the same advantageous effects achieved on the first fixed terminal 420A side can also be achieved on the second fixed terminal 420B side.

As shown in FIG. 21, a defining part may be provided in the fixed terminal after the outer movable contact main body 432 is configured to be movable in the up-down direction (one direction) relative to the movable contact main body 431. In this event, it is preferable that the outer movable contact main body 432 located outside comes into contact with the fixed terminal before the movable contact main body 431 and is separated from the fixed terminal after the movable contact main body 431.

This makes it possible to further reliably suppress the movable contact main body 431 from being affected by the arc.

FIG. 22 also illustrates the example where the two approximately U-shaped plate members 4321 elongated in the left-right direction are used to form the outer movable contact main body 432 disposed around the first contact unit 4311A and the second contact unit 4311B of the movable contact main body 431. However, the configuration of the outer movable contact main body 432 is not limited thereto. For example, the first outer movable contact main body 432A and the second outer movable contact main body 432B described as modified examples of FIGS. 19 and 21 may be used, and the tips are allowed to enter the gaps formed between the first and second outer movable contact main bodies 432A and 432B and the movable contact main body 431.

Thus, the same advantageous effects as those achieved with the contact device 10 shown in FIG. 22 can also be achieved.

In FIG. 22, again, three plate members 433 constituting the movable contact main body 431 and two plate members 4321 constituting the outer movable contact main body 432 can also be separately and independently pressed by the biasing member 434 described above.

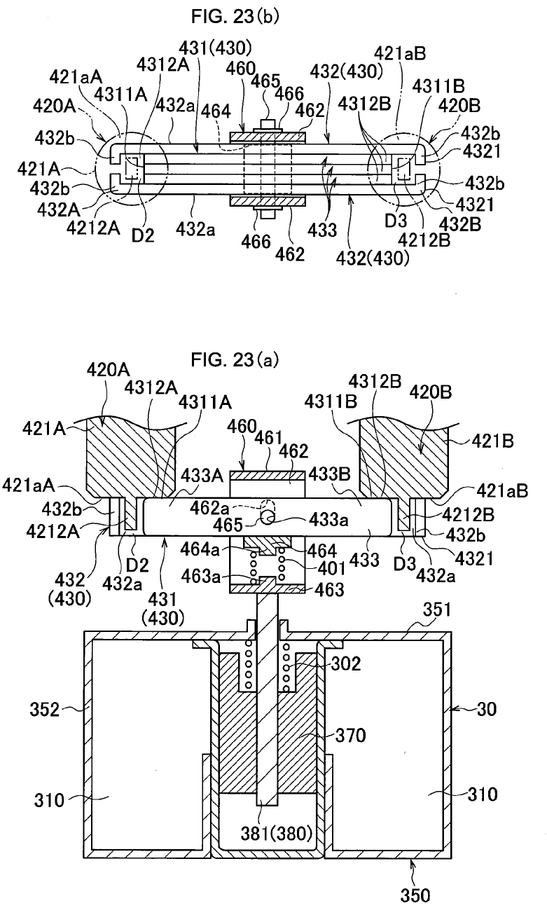

As shown in FIG. 23, a partition wall 4212A extending in the front-rear direction and protruding downward is provided on the bottom surface 421aA of the first fixed terminal 420A, and the partition wall 4212A may be allowed to function as a first defining part.

In FIG. 23, a partition wall 4212B extending in the front-rear direction and protruding downward is also provided on the bottom surface 421aB of the second fixed terminal 420B, and the partition wall 4212B is allowed to function as a second defining part.

Accordingly, when the first and second fixed terminals 420A and 420B are in a conductive state, the first fixed terminal 420A has its tip (partition wall 4212A) enter the first gap D2, and the second fixed terminal 420B has its tip (partition wall 4212B) enter the second gap D3.

Thus, the same advantageous effects as those achieved with the contact device 10 shown in FIG. 22 can also be achieved with the contact device 10 having the configuration shown in FIG. 22.

Further, the first outer movable contact main body 432A shown in FIG. 20 and the first outer movable contact main body 432A and the second outer movable contact main body 432B described as modified examples of FIGS. 19 and 21 may be used, and the fixed terminals may be configured to have their tips enter the gaps formed between the first and second outer movable contact main bodies 432A and 432B and the movable contact main body 431.

Thus, the same advantageous effects as those achieved with the contact device 10 shown in FIG. 23 can also be achieved.

In FIG. 23, again, three plate members 433 constituting the movable contact main body 431 and two plate members 4321 constituting the outer movable contact main body 432 can also be separately and independently pressed by the biasing member 434 described above.

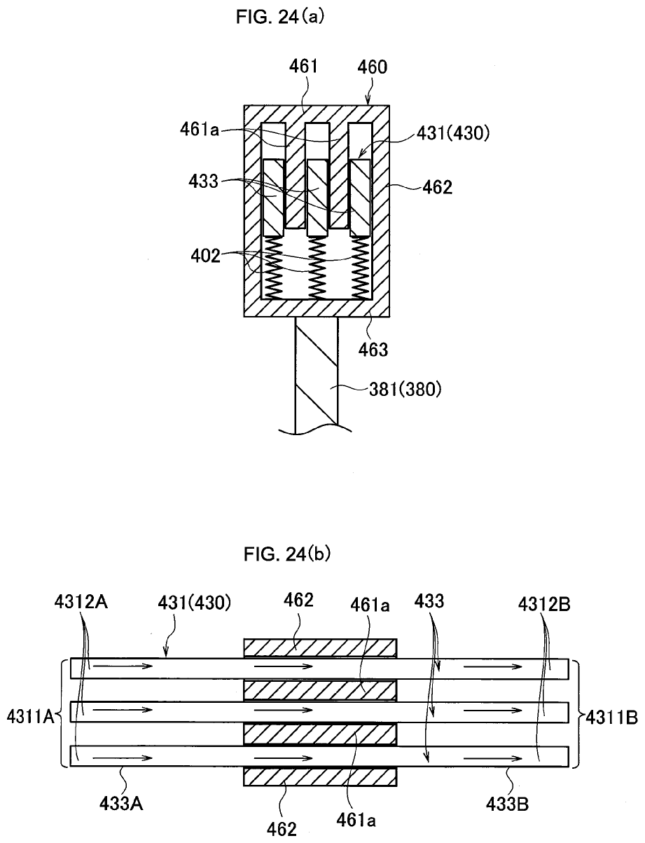

Alternatively, the contact device 10 may also have a configuration shown in FIG. 24.

As in the case of the movable contact 430 described in the above embodiment, a movable contact 430 shown in FIG. 24 also includes a movable contact main body 431 including a first contact unit 4311A that comes into contact with a first fixed terminal 420A and a second contact unit 4311B that comes into contact with a second fixed terminal 420B.

As in the above embodiment, the movable contact main body 431 shown in FIG. 24 is also formed by stacking plate members 433, on which a first contact piece 4312A and a second contact piece 4312B are formed, respectively, in the front-rear direction. In FIG. 24, the movable contact main body 431 is formed by stacking three plate members 433 in the front-rear direction.

In the movable contact main body 431 shown in FIG. 24, again, the first contact unit 4311A includes a plurality of first contact pieces 4312A that come into contact with the first fixed terminal 420A. The plurality of first contact pieces 4312A can be separately and independently moved in the up-down direction (rotated about the support shaft 465). That is, at least one of the plurality of first contact pieces 4312A can be moved relative to the other first contact pieces 4312A.

The second contact unit 4311B includes a plurality of second contact pieces 4312B that come into contact with the second fixed terminal 420B. The plurality of second contact pieces 4312B can be separately and independently moved in the up-down direction (rotated about the support shaft 465). That is, at least one of the plurality of second contact pieces 4312B can be moved relative to the other second contact pieces 4312B.

Here, in the movable contact 430 shown in FIG. 24, a partition wall 461a is interposed between two plate members 433 and 433 adjacent to each other in the front-rear direction (stacking direction).

Two adjacent first movable-side plate members 433A and 433A are partitioned by the partition wall 461a, while two adjacent second movable-side plate members 433B and 433B are partitioned by the partition wall 461a.

Thus, in FIG. 24, the partition wall 461a functions as a first partition wall interposed between the two adjacent first movable-side plate members 433A and 433A. The partition wall 461a also functions as a second partition wall interposed between the two adjacent second movable-side plate parts. That is, in FIG. 24, the partition wall 461a also serves as the first partition wall and the second partition wall. Note that the first and second partition walls can also be provided separately.

The movable contact 430 shown in FIG. 24 is also held by the holder 460 in a state of being movable in the up-down direction (one direction) relative to the holder 460.

Therefore, in FIG. 24, two partition walls 461a extending in the left-right direction and protruding downward are formed on the lower surface of the top wall 461 of the holder 460 so as to be arranged side by side in the front-rear direction.

Three plate members 433 are inserted into three spaces formed between the side wall 462 and the partition wall 461a. In this event, the side surfaces (front and rear surfaces) of the respective plate members 433 are brought into surface contact with the surface of the side wall 462 and the surface of the partition wall 461a.

It is preferable that a current is unlikely to flow between each plate member 433 and the side wall 462 or the partition wall 461a. Such side walls 462 and partition walls 461a can be formed using, for example, a material having higher conductor resistance than the plate member 433, or using an insulating material. The surface of the side wall 462 or the partition wall 461a may be subjected to an insulating coating process.

In FIG. 24, each of the plate members 433 is biased upward by a coil spring 402 as a biasing part. This biasing part is not limited to the coil spring, but may be a biasing part used in the biasing member 434 described above, for example.

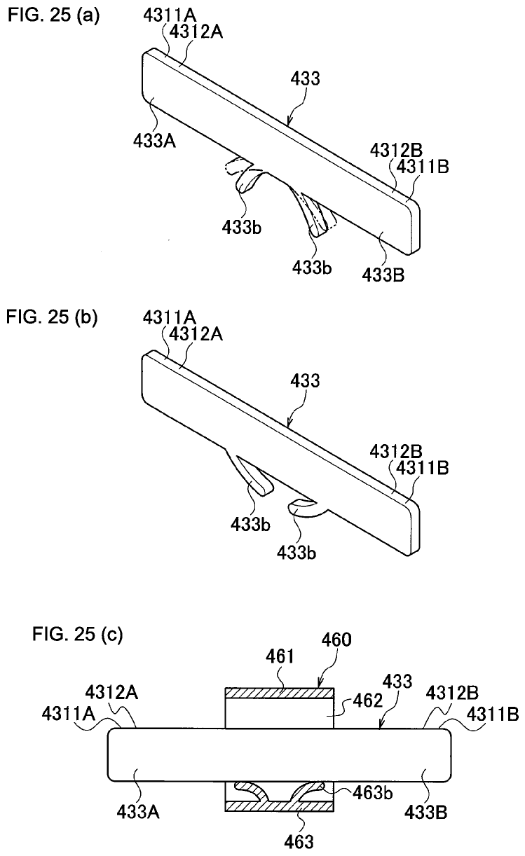

As shown in FIG. 25(a), it is also possible to provide an elastically deformable leg part 433b on the plate member 433, and use this leg part 433b as a biasing part. That is, by elastically deforming the leg part 433b, contact pressure between each plate member 433 and the first fixed terminal 420A and contact pressure between each plate member 433 and the second fixed terminal 420B may be ensured.

FIG. 25(a) illustrates the leg part 433b extending with its tip face outward. However, as illustrated in FIG. 25(b), the leg part 433b may also be configured to extend with its tip face inward.

As shown in FIG. 25(c), it is also possible to provide an elastically deformable leg part 463b on the bottom wall 463 of the holder 460, instead of the plate member 433. This leg part 463b can be formed, for example, by cutting and raising a part of the bottom wall 463 with its tip face outward. It is also possible to form a leg part 463b having its tip face inward.

With such a configuration, when the shaft (drive shaft) 380 is moved upward (to one side) in the up-down direction (one direction), the movable contact 430 is also moved upward and comes into contact with the first and second fixed terminals 420A and 420B.

That is, the plurality of first contact pieces 4312A formed in the first contact unit 4311A of the movable contact main body 431 come into contact with the bottom surface 421aA of the first fixed terminal 420A. Meanwhile, the plurality of second contact pieces 4312B formed in the second contact unit 4311B of the movable contact main body 431 come into contact with the bottom surface 421aB of the second fixed terminal 420B.

Thus, the first and second fixed terminals 420A and 420B are brought into a conductive state.

On the other hand, when the shaft (drive shaft) 380 is moved downward (to the other side) in the up-down direction (one direction), the movable contact 430 is also moved downward and separated from both of the first and second fixed terminals 420A and 420B. That is, the plurality of first contact pieces 4312A are separated from the bottom surface 421aA of the first fixed terminal 420A, while the plurality of second contact pieces 4312B are separated from the bottom surface 421aB of the second fixed terminal 420B.

When the first and second fixed terminals 420A and 420B are brought into a conductive state, a current in the same direction flows through the three plate members 433 arranged side by side in the front-rear direction. Although FIG. 24(b) illustrates an example where a current flows from left to right as indicated by the arrow, a current can also flow from right to left. In either case, a current flows in the same direction through the three plate members 433.

Thus, when a current in the same direction is applied to the juxtaposed members, force attracting each other acts on the juxtaposed members. Therefore, when three members (plate members 433) are arranged side by side in the front-rear direction as shown in FIG. 24, force attracting each other acts on the plate members 433 positioned at the front and rear in the front-rear direction. Accordingly, the partition wall 461a is more firmly sandwiched by the plate members 433, and frictional force generated between the plate members 433 and the partition wall 461a is increased. As a result, the plate members 433 are prevented from being moved by the electromagnetic repulsion force acting between the fixed terminals (first and second fixed terminals 420A and 420B) and the movable contact 430.

Thus, in FIG. 24, when the first and second fixed terminals 420A and 420B are brought into a conductive state by interposing the partition wall between two members adjacent to each other in the stacking direction, movement of each member is suppressed. Accordingly, the conductive state between the first and second fixed terminals 420A and 420B can be more reliably maintained.

Thus, the same advantageous effects as in the above embodiment can also be achieved with the contact device 10 having the configuration shown in FIG. 24.

Even if a plurality of plate members 433 are simply stacked without providing any partition wall, force attracting each other acts on the plate members 433 arranged at both ends in the stacking direction. Therefore, even in the case of the movable contact 430 described in the above embodiment and the like, the frictional force generated in the contact portion between the plate members 433 can be increased. Therefore, it is possible to prevent the plate members 433 from being moved by the electromagnetic repulsion force acting between the fixed terminals (first and second fixed terminals 420A and 420B) and the movable contact 430.

However, as shown in FIG. 24, if the partition wall 461a is interposed between two members adjacent to each other in the stacking direction, the frictional force generated in the contact portion between the plate members 433 and other members can be further increased. Therefore, it is possible to further prevent the plate members 433 from being moved by the electromagnetic repulsion force acting between the fixed terminals (first and second fixed terminals 420A and 420B) and the movable contact 430.

As described in the modified example of the above embodiment, when the first movable-side plate members 433A having the first contact pieces 4312A formed thereon are stacked in the front-rear direction, a first partition wall may be interposed between two first movable-side plate members 433A adjacent to each other in the stacking direction.

Likewise, when the second movable-side plate members 433B having the second contact pieces 4312B formed thereon are stacked in the front-rear direction, a second partition wall may be interposed between two second movable-side plate members 433B adjacent to each other in the stacking direction.

Thus, the same advantageous effects as those achieved with the contact device 10 shown in FIG. 24 can also be achieved.

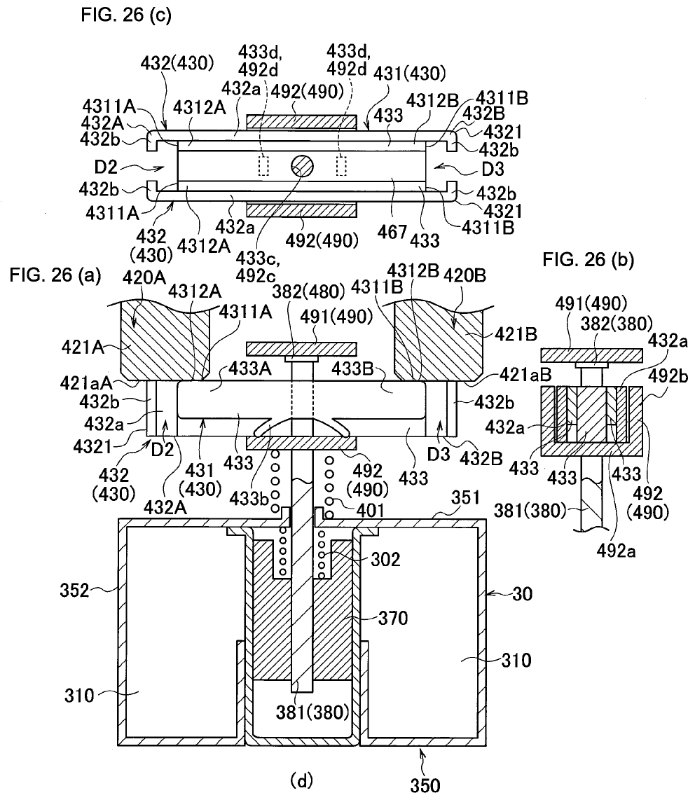

Alternatively, the contact device 10 may also have a configuration shown in FIG. 26.

As in the case of the movable contact 430 shown in FIG. 19, a movable contact 430 shown in FIG. 26 also includes a movable contact main body 431 including a first contact unit 4311A that comes into contact with a first fixed terminal 420A and a second contact unit 4311B that comes into contact with a second fixed terminal 420B.

As in the case of FIG. 19, the movable contact main body 431 shown in FIG. 26 is also formed by stacking plate members 433 having a first contact piece 4312A and a second contact piece 4312B formed thereon, respectively, in the front-rear direction.

In FIG. 26, however, the width in the front-rear direction of the plate member 433 arranged at the center in the front-rear direction is wider than the width in the front-rear direction of the plate members 433 arranged at the front and rear in the front-rear direction.

The narrower plate members 433 arranged at the front and rear in the front-rear direction are each provided with an elastically deformable leg part 433b. By elastically deforming the leg part 433b, contact pressure between each plate member 433 and the first fixed terminal 420A and contact pressure between each plate member 433 and the second fixed terminal 420B are secured.

On the other hand, no leg part is formed in the wider plate member 433 disposed at the center in the front-rear direction, and an insertion hole 433c is formed in the center so as to penetrate in the up-down direction, into which the shaft (drive shaft) 380 is inserted.

In FIG. 26, no support shaft 465 is used, and the plate members 433 are placed on a bottom wall 492a of a lower yoke 492 to be described later in a separate and independent state.

In the movable contact main body 431 shown in FIG. 26, again, the first contact unit 4311A includes a plurality of first contact pieces 4312A that come into contact with the first fixed terminals 420A. The plurality of first contact pieces 4312A can be moved in the up-down direction separately and independently of each other. That is, at least one of the plurality of first contact pieces 4312A can be moved relative to the other first contact pieces 4312A.

Likewise, the second contact unit 4311B includes a plurality of second contact pieces 4312B that come into contact with the second fixed terminal 420B. The plurality of second contact pieces 4312B can be moved in the up-down direction separately and independently of each other. That is, at least one of the plurality of second contact pieces 4312B can be moved relative to the other second contact pieces 4312B.

The movable contact 430 shown in FIG. 26 also includes an outer movable contact main body 432 disposed around the first contact unit 4311A and the second contact unit 4311B of the movable contact main body 431, separately from the movable contact main body 431.

The outer movable contact main body 432 shown in FIG. 26 has approximately the same configuration as the outer movable contact main body 432 shown in FIG. 19 and is formed by arranging approximately U-shaped plate members 4321 on either side of the movable contact main body 431 in the front-rear direction. In this event, the two plate members 4321 constituting the outer movable contact main body 432 are also placed on the bottom wall 492a of the lower yoke 492. The two plate members 4321 are also each provided with an elastically deformable leg part to ensure contact pressure between each plate member 4321 and the first fixed terminal 420A and contact pressure between each plate member 4321 and the second fixed terminal 420B.

Here, in the contact device 10 shown in FIG. 26, a yoke 490 is provided so as to surround the movable contact 430. To be more specific, the yoke 490 surrounding the upper and lower surfaces and side surfaces of the movable contact 430 is configured using an upper yoke (first yoke) 491 disposed above the movable contact 430 and a lower yoke (second yoke) 492 surrounding the lower and side portions of the movable contact 430. By surrounding the movable contact 430 with the upper yoke 491 and the lower yoke 492, a magnetic circuit is formed between the upper yoke 491 and the lower yoke 492.

By providing the upper yoke 491 and the lower yoke 492, when a current flows through the movable contact 430, the upper yoke 491 and the lower yoke 492 generate magnetic force that attracts each other based on the current. Accordingly, by generating the magnetic force attracting each other in the upper and lower yokes 491 and 492, the upper and lower yokes 491 and 492 are attracted to each other. When the upper and lower yokes 491 and 492 are attracted to each other, the movable contact 430 is pressed against the first and second fixed terminals 420A and 420B. With the movable contact 430 pressed against the first and second fixed terminals 420A and 420B, the movable contact 430 is prevented from being separated from the first and second fixed terminals 420A and 420B. Accordingly, the generation of arc is suppressed, and contact welding due to the generation of arc can be suppressed.

In FIG. 26, the upper yoke 491 is formed in an approximately rectangular plate shape, and the lower yoke 492 is formed into an approximately U-shape by a bottom wall 492a and side walls 492b formed upright from both ends of the bottom wall 492a. The upper yoke 491 is fixed to the upper surface of the head 382 of the shaft (drive shaft) 380. An insertion hole 492c into which the shaft main body 381 is inserted is formed in the bottom wall 492a of the lower yoke 492. In FIG. 26, the lower surface of the bottom wall portion 492a is pressed upward by the contact pressure spring 401. In FIG. 26, the bottom wall 492a and the wide plate member 433 are provided with a projection and a recess to be fitted together, and the lower yoke 492 is connected to the wide plate member by fitting the projection and the recess together. To be more specific, a fitting projection 492d protruding upward is formed on the upper surface of the bottom wall 492a, and this fitting projection 492d is fitted into a fitting recess 433d formed on the lower surface of the wide plate member 433. Thus, the lower yoke 492 is arranged so as to surround the movable contact 430 on three sides.

In FIG. 26, again, in an assembled state of the contact device 10, the first contact unit 4311A of the movable contact main body 431 is opposed to the inner side of the bottom surface 421aA of the first fixed terminal 420A in the left-right direction. Meanwhile, the bent piece 432b defining the first gap D2 of the outer movable contact main body 432 is opposed to the outer side of the bottom surface 421aA of the first fixed terminal 420A in the left-right direction.

Likewise, the second contact unit 4311B of the movable contact main body 431 is opposed to the inner side of the bottom surface 421aB of the second fixed terminal 420B in the left-right direction. Meanwhile, the bent piece 432b defining the second gap D3 of the outer movable contact main body 432 is opposed to the outer side of the bottom surface 421aB of the second fixed terminal 420B in the left-right direction.

With such a configuration, when the shaft (drive shaft) 380 is moved upward (to one side) in the up-down direction (one direction), the movable contact 430 is also moved upward and comes into contact with the first and second fixed terminals 420A and 420B.

In this event, the plurality of first contact pieces 4312A formed on the first contact unit 4311A of the movable contact main body 431 come into contact with the inner side of the bottom surface 421aA of the first fixed terminal 420A. Meanwhile, the bent piece 432b defining the first gap D2 of the outer movable contact main body 432 comes into contact with the outer side of the bottom surface 421aA of the first fixed terminal 420A.

Likewise, the plurality of second contact pieces 4312B formed on the second contact unit 4311B of the movable contact main body 431 comes into contact with the inner side of the bottom surface 421aB of the second fixed terminal 420B. Meanwhile, the bent piece 432b defining the second gap D3 of the outer movable contact main body 432 comes into contact with the outer side of the bottom surface 421aB of the second fixed terminal 420B.

In this event, the wide plate member 433 disposed at the center in the front-rear direction is pressed against the upper yoke 491 by the upper and lower yokes 491 and 492 being attracted to each other.

On the other hand, when the shaft (drive shaft) 380 is moved downward (to the other side) in the up-down direction (one direction), the movable contact 430 is also moved downward and separated from both of the first and second fixed terminals 420A and 420B. That is, the plurality of first contact pieces 4312A and the bent piece 432b defining the second gap D3 of the outer movable contact main body 432 are separated from the bottom surface 421aA of the first fixed terminal 420A. At the same time, the plurality of second contact pieces 4312B and the bent piece 432b defining the second gap D3 of the outer movable contact main body 432 are separated from the bottom surface 421aB of the second fixed terminal 420B.

Thus, the same advantageous effects as those achieved with the configuration shown in FIG. 19 can also be achieved with the contact device 10 having the configuration shown in FIG. 26.

Note that, instead of the outer movable contact main body 432, the first outer movable contact main body 432A shown in FIG. 20 and the first and second outer movable contact main bodies 432A and 432B described as the modified example of FIG. 19 may be used to provide the yoke 490 around the first and secondouter movable contact main bodies 432A and 432B.

Thus, the same advantageous effects as those achieved with the contact device 10 shown in FIG. 26 can also be achieved.

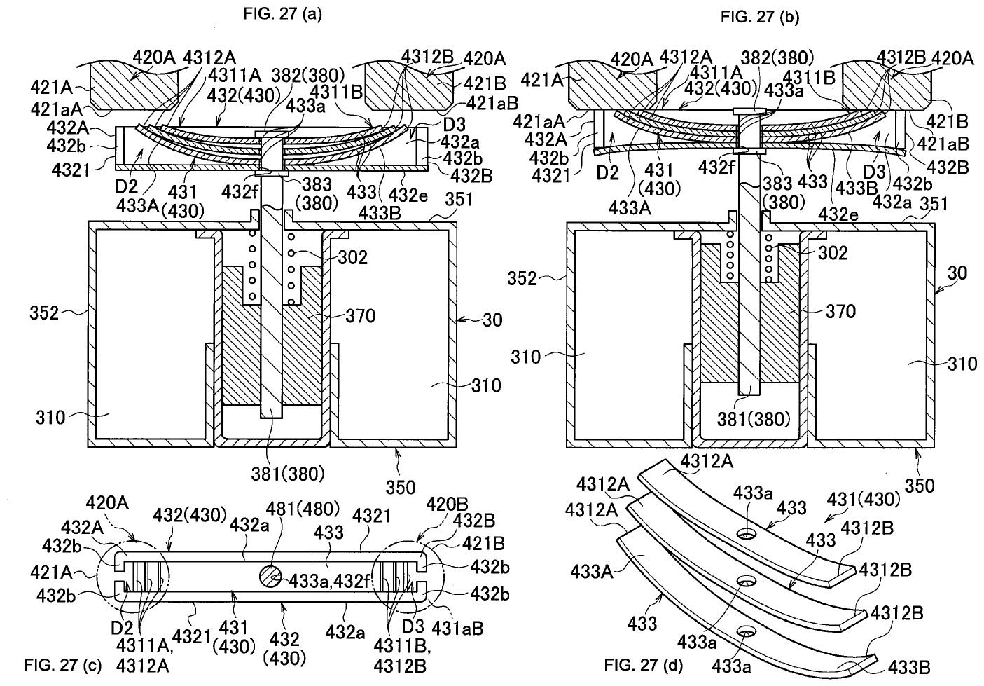

Alternatively, the contact device 10 may also have a configuration shown in FIG. 27.

A movable contact 430 shown in FIG. 27 includes a plurality of (three) conductive leaf springs, and a first contact piece 4312A and a second contact piece 4312B are formed at both ends of each leaf spring. That is, in FIG. 27, the conductive leaf springs serve as plate members 433 having first and second contact pieces 4312A and 4312B formed thereon, respectively. These plate members 433 have a shape that is curved so as to protrude downward in a state where the thickness direction is approximately aligned with the up-down direction.

A movable contact main body 431 is formed by stacking the three plate members 433 in the up-down direction in a state of being curved so as to protrude downward. The three plate members 433 have different lengths in the left-right direction, and the longer one is disposed on the lower side. Thus, when the movable contact main body 431 is formed, the tips of the plate members 433 in the left-right direction are arranged approximately at the same height position in the left-right direction.

An insertion hole 433a penetrating in the thickness direction is formed at the center of the plate member 433 in the left-right direction. By inserting a shaft (drive shaft) 380 into the insertion hole 433a, the movable contact main body 431 is attached to the shaft (drive shaft) 380. In this event, a gap is formed between the plate members 433 adjacent to each other in the up-down direction (stacking direction: one direction).

Thus, in the movable contact main body 431 shown in FIG. 27, one side of each plate member 433 in the left-right direction serves as the first contact unit 4311A and the first contact piece 4312A. Meanwhile, the other side of each plate member 433 in the left-right direction serves as the second contact unit 4311B and the second contact piece 4312B.

The movable contact 430 shown in FIG. 27 also includes an outer movable contact main body 432 disposed around the first contact unit 4311A and the second contact unit 4311B of the movable contact main body 431, separately from the movable contact main body 431.

The outer movable contact main body 432 shown in FIG. 27 is formed by integrating approximately U-shaped plate members 4321 disposed on either side of the movable contact main body 431 in the front-rear direction with a bottom wall 432e that is flexibly deformable in the up-down direction.

The approximately U-shaped plate member 4321 has the same configuration as the plate member 4321 shown in FIG. 19, and includes a side wall 432a and a pair of bent pieces 432b and 432b connected to both ends of the side wall 432a in the left-right direction.

An insertion hole 432f penetrating in the thickness direction is formed at the center of the bottom wall 432e. By inserting the shaft (drive shaft) 380 into the insertion hole 432f, the outer movable contact main body 432 is attached to the shaft (drive shaft) 380.

The shaft (drive shaft) 380 shown in FIG. 27 includes a shaft main body 381 and a head 382. The shaft (drive shaft) 380 shown in FIG. 27 is provided with a support member 383 attached around the shaft main body 381 to support the movable contact main body 431 and the outer movable contact main body 432 from below.

The support member 383 is attached around the shaft main body 381 after the shaft main body 381 is inserted into the insertion holes 433a and 432f of the movable contact main body 431 and the outer movable contact main body 432. Accordingly, the movable contact main body 431 and the outer movable contact main body 432 are attached to the shaft (drive shaft) 380 while being sandwiched between the head 382 and the support member 383.

In FIG. 27, the bottom wall 432e, the plate member 433 having the longest length in the left-right direction, the plate member 433 having an intermediate length, and the shortest plate member 433 are stacked in this order from the bottom. Then, in a state of being stacked in this order, the movable contact main body 431 and the outer movable contact main body 432 are attached to the shaft (drive shaft) 380 by inserting the shaft main body 381 into the respective insertion holes 433a and 432f from above. In FIG. 27, when the first and second fixed terminals 420A and 420B are set in a non-conductive state, the height position of the bent piece 432b is approximately the same as the height position of both ends of each plate member 433 in the left-right direction.

In FIG. 27, again, in an assembled state of the contact device 10, the first contact unit 4311A of the movable contact main body 431 is opposed to the inner side of the bottom surface 421aA of the first fixed terminal 420A in the left-right direction. Meanwhile, the bent piece 432b defining the first gap D2 of the outer movable contact main body 432 is opposed to the outer side of the bottom surface 421aA of the first fixed terminal 420A in the left-right direction.

Likewise, the second contact unit 4311B of the movable contact main body 431 is opposed to the inner side of the bottom surface 421aB of the second fixed terminal 420B in the left-right direction. Meanwhile, the bent piece 432b defining the second gap D3 of the outer movable contact main body 432 is opposed to the outer side of the bottom surface 421aB of the second fixed terminal 420B in the left-right direction.

With such a configuration, when the shaft (drive shaft) 380 is moved upward (to one side) in the up-down direction (one direction), the movable contact 430 is also moved upward and comes into contact with the first and second fixed terminals 420A and 420B.

To be more specific, when the shaft (drive shaft) 380 is moved upward (to one side) in the up-down direction (one direction), the entire movable contact 430 (the movable contact main body 431 and the outer movable contact main body 432) is first moved upward.

Then, by moving the entire movable contact 430 upward, a plurality of first contact pieces 4312A formed on the first contact unit 4311A of the movable contact main body 431 come into contact with the inner side of the bottom surface 421aA of the first fixed terminal 420A. At the same time, the bent piece 432b defining the first gap D2 of the outer movable contact main body 432 comes into contact with the outer side of the bottom surface 421aA of the first fixed terminal 420A. Likewise, a plurality of second contact pieces 4312B formed on the second contact unit 4311B of the movable contact main body 431 come into contact with the inner side of the bottom surface 421aB of the second fixed terminal 420B. At the same time, the bent piece 432b defining the second gap D3 of the outer movable contact main body 432 comes into contact with the outer side of the bottom surface 421aB of the second fixed terminal 420B.

That is, in FIG. 27, when the entire movable contact 430 is moved upward, the plurality of first contact pieces 4312A, the plurality of second contact pieces 4312B, and the four bent pieces 432b come into contact with the fixed terminal almost simultaneously. When the plurality of first contact pieces 4312A, the plurality of second contact pieces 4312B, and the four bent pieces 432b come into contact with the fixed terminal, upward movement of these members (the first contact pieces 4312A, the second contact pieces 4312B, and the bent pieces 432b) is restricted.

In FIG. 27, the shaft (drive shaft) 380 can be moved upward even when the upward movement of the first contact pieces 4312A, the second contact pieces 4312B, and the bent pieces 432b is restricted.

Therefore, the bottom wall 432e of the outer movable contact main body 432 is flexibly deformed so as to protrude upward by the upward pressing with the shaft 380. When the bottom wall 432e is flexibly deformed, each plate member 433 is elastically deformed by being pressed upward with both ends in contact with the bottom surface of the fixed terminal. That is, while the tip of the first contact piece 4312A slides on the bottom surface 421aA of the first fixed terminal 420A, the tip of the second contact piece 4312B is elastically deformed by sliding on the bottom surface 421aB of the second fixed terminal 420B.

By elastically deforming each plate member 433 in a direction in which the tips are separated from each other, upward pressing force caused by the elastic restoring force of each plate member 433 acts on the first and second contact pieces 4312A and 4312B. Therefore, the first contact piece 4312A comes into contact with the first fixed terminal 420A with a relatively large contact pressure. Likewise, the second contact piece 4312B also comes into contact with the second fixed terminal 420B with a relatively large contact pressure. Since the upward pressing force caused by the elastic restoring force of the bottom wall 432e also acts on the bent pieces 432b, each bent piece 432b also comes into contact with the fixed terminal with a relatively large contact pressure.

When the plate members 433 are elastically deformed, the gap formed between the adjacent plate members 433 is eliminated, and the adjacent plate members 433 come into surface contact with each other. When a current in the same direction flows through each plate member 433 in this state, force attracting each other acts on the plate member 433 disposed at the top and the plate member 433 disposed at the bottom. Thus, the frictional force generated between the plate members 433 adjacent to each other is increased, and the separation of the plate members 433 from the fixed terminals can be suppressed.

On the other hand, when the shaft (drive shaft) 380 is moved downward (to the other side) in the up-down direction (one direction), the first contact piece 4312A and the second contact piece 4312B are relatively moved in a direction of approaching each other by the elastic restoring force of each plate member 433 and the bottom wall 432e.

When the plate members 433 and the bottom wall 432e are returned to the initial state, the entire movable contact 430 is moved downward and separated from the first and second fixed terminals 420A and 420B. That is, the plurality of first contact pieces 4312A, the plurality of second contact pieces 4312B, and the four bent pieces 432b are almost simultaneously separated from the fixed terminal.

When the first and second fixed terminals 420A and 420B are in a non-conductive state, the height position of the bent piece 432b may be higher than the height position of both ends of each plate member 433 in the left-right direction. Thus, when the entire movable contact 430 is moved upward, the outer movable contact main body 432 can be brought into contact with each fixed terminal before the movable contact main body 431 and can be separated from each fixed terminal after the movable contact main body 431.

Thus, the same advantageous effects as those achieved with the configuration shown in FIG. 19 can also be achieved with the contact device 10 having the configuration shown in FIG. 27.

FIG. 27 also illustrates an example where two approximately U-shaped plate members 4321 elongated in the left-right direction are used to form the outer movable contact main body 432 disposed around the first contact unit 4311A and the second contact unit 4311B of the movable contact main body 431. However, the configuration of the outer movable contact main body 432 is not limited thereto. For example, the first outer movable contact main body 432A shown in FIG. 20 and the first and second outer movable contact main bodies 432A and 432B described as a modified example of FIG. 19 may be used.

FIG. 27 also illustrates an example where a plurality of plate members 433 having the first contact piece 432A and the first contact piece 432B formed thereon, respectively, are used, and a plurality of the plate members 433 are stacked in the up-down direction (one direction) to form the movable contact main body 431. However, the configuration of the movable contact main body 431 is not limited thereto.

For example, the first movable-side plate members 433A having the first contact pieces 4312A formed thereon are stacked in the up-down direction to form a stacked body including the first contact unit 4311A having the plurality of first contact pieces 4312A formed thereon. This stacked body may be used as the movable contact main body 431.

The movable contact main body 431 may be formed by electrically connecting the above stacked body to a member provided separately from the stacked body and having the second contact unit 4311B. As a method of electrically connecting the stacked body having the first contact unit 4311A to the member having the second contact unit 4311B, there are, for example, a method of directly connecting the two, a method of electrically connecting the both through a holding member 464 formed of a conductive material and a bottom wall 432e, and the like.

The member having the second contact unit 4311B may be a single plate member arranged in a state where the thickness direction is approximately aligned with the up-down direction. In this event, the contact with the second fixed terminal 420B may be made at one spot or at a plurality of spots.

The member having the second contact unit 4311B may be a stacked body formed by stacking the second movable-side plate members 433B having the second contact pieces 4312B formed thereon in the up-down direction. This stacked body includes a second contact unit 4311B having a plurality of second contact pieces 4312B formed thereon.

Thus, the same advantageous effects as those achieved with the configuration shown in FIG. 27 can also be achieved.

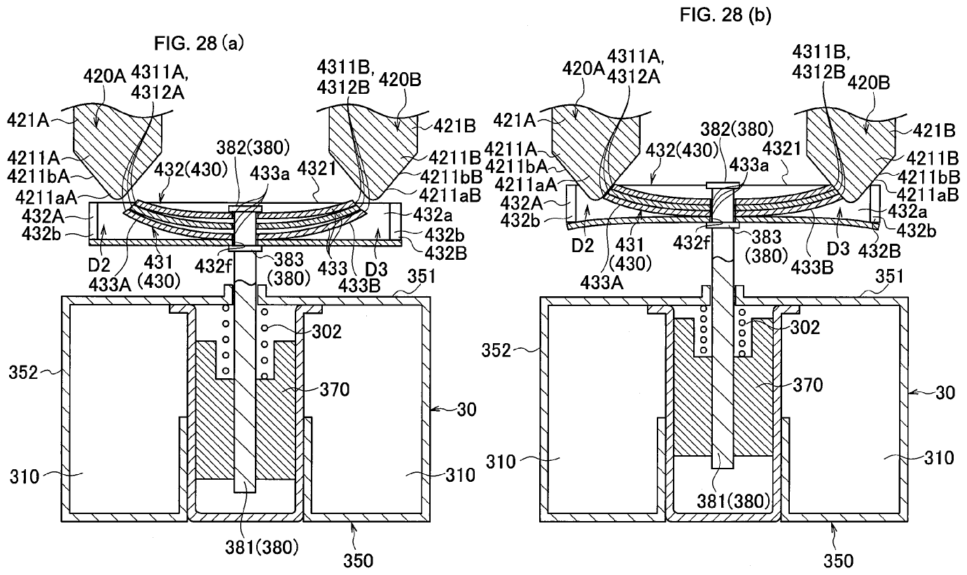

Alternatively, the contact device 10 may also have a configuration shown in FIG. 28.

In FIG. 28, again, a movable contact 430 includes a movable contact main body 431 and an outer movable contact main body 432 arranged around a first contact unit 4311A and a second contact unit 4311B of the movable contact main body 431. The movable contact main body 431 shown in FIG. 28 has the same configuration as the movable contact main body 431 shown in FIG. 27, and the outer movable contact main body 432 shown in FIG. 28 also has the same configuration as the outer movable contact main body 432 shown in FIG. 27. That is, the movable contact 430 shown in FIG. 28 has the same configuration as the movable contact 430 shown in FIG. 27.

In FIG. 28, a first defining part is formed in the first fixed terminal 420A. The first defining part enters the first gap D2 to define the movable contact main body 431 and the outer movable contact main body 432 during the conductive state. Likewise, a second defining part is formed in the second fixed terminal 420B. The second defining part enters the second gap D3 to define the movable contact main body 431 and the outer movable contact main body 432 during the conductive state.

To be more specific, a tapered portion 4211A having a smaller diameter toward the lower side is formed below the first fixed terminal 420A. Likewise, a tapered portion 4211B having a smaller diameter toward the lower side is formed below the second fixed terminal 420B.

That is, the first and second fixed terminals 420A and 420B shown in FIG. 28 have the same configurations as those of the first and second fixed terminals 420A and 420B shown in FIG. 22.

Thus, the same advantageous effects as those achieved with the configuration shown in FIGS. 22 and 27 can also be achieved with the contact device 10 having the configuration shown in FIG. 28.

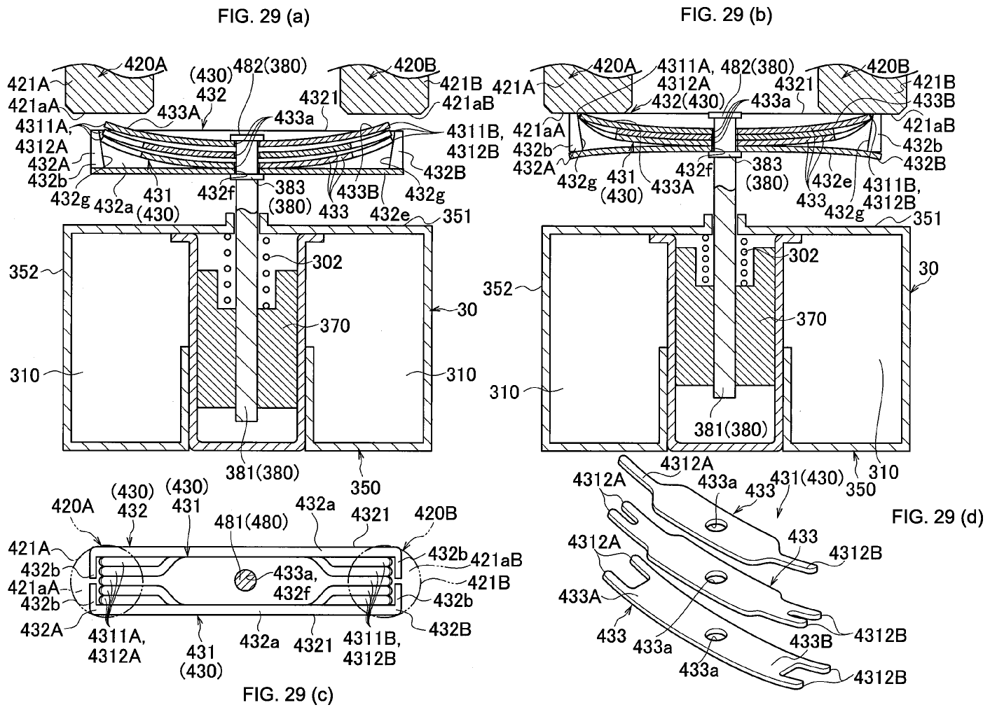

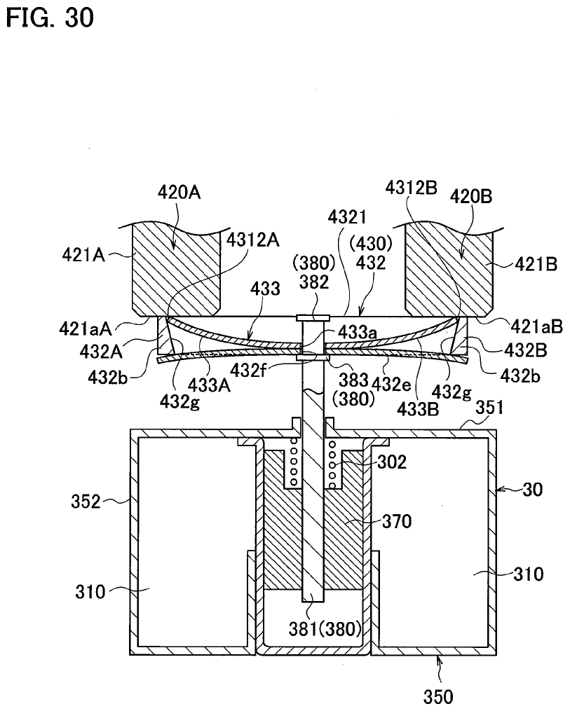

Alternatively, the contact device 10 may also have a configuration shown in FIGS. 29 and 30.

A movable contact 430 shown in FIGS. 29 and 30 includes a plurality of (three) conductive leaf springs, and a first contact piece 4312A and a second contact piece 4312B are formed at both ends of each leaf spring. That is, in FIGS. 29 and 30, the conductive leaf springs serve as the plate members 433 having the first and second contact pieces 4312A and 4312B formed thereon, respectively. These plate members 433 have a shape that is curved so as to protrude downward in a state where the thickness direction is approximately aligned with the up-down direction.

The movable contact main body 431 is formed by stacking the three plate members 433 in the up-down direction in a state of being curved so as to protrude downward.

In FIGS. 29 and 30, narrower pieces are formed at both ends of the three plate members 433 in the left-right direction, respectively, and these narrower pieces serve as the first contact piece 4312A and the second contact piece 4312B.

To be more specific, one plate member 433 has a shape in which one end protruding in the left-right direction from the center in the front-rear direction is formed by narrowing the both ends in the left-right direction.

The other plate member 433 has a shape in which both ends in the left-right direction are slightly narrowed, and a notch is formed at the center of the narrowed portion in the front-rear direction. This notch is formed so as to be slightly wider than the piece formed in the one plate member 433. Thus, the other one plate member 433 has a shape in which two pieces are formed protruding in the left-right direction from both ends in the front-rear direction in the narrow portion.

The remaining one plate member 433 has a shape in which a notch is formed at the center in the front-rear direction at both ends in the left-right direction. This notch is formed so as to be slightly wider than the narrow portion formed in the other one plate member 433. Thus, the remaining one plate member 433 has a shape in which two pieces are formed protruding in the left-right direction from both ends in the front-rear direction.

In FIGS. 29 and 30, one plate member 433, another plate member 433, and the remaining one plate member 433 are stacked in this order from the top to form the movable contact main body 431. Accordingly, when the movable contact main body 431 is formed, the tips of the plate members 433 in the left-right direction are arranged in the front-rear direction.

An insertion hole 433a penetrating in the thickness direction is formed at the center of the plate member 433 in the left-right direction. By inserting a shaft (drive shaft) 380 into the insertion hole 433a, the movable contact main body 431 is attached to the shaft (drive shaft) 380. In this event, a gap is formed between the plate members 433 adjacent to each other in the up-down direction (stacking direction: one direction).

In the movable contact main body 431 shown in FIGS. 29 and 30, the piece on one side in the left-right direction of each plate member 433 serves as the first contact unit 4311A and the first contact piece 4312A. Meanwhile, the piece on the other side in the left-right direction of each plate member 433 serves as the second contact unit 4311B and the second contact piece 4312B.

The movable contact 430 shown in FIGS. 29 and 30 also includes an outer movable contact main body 432 disposed around the first contact unit 4311A and the second contact unit 4311B of the movable contact main body 431, separately from the movable contact main body 431.

The outer movable contact main body 432 shown in FIGS. 29 and 30 is formed by integrating approximately U-shaped plate members 4321 disposed on both sides of the movable contact main body 431 in the front-rear direction with a bottom wall 432e that is flexibly deformable in the up-down direction.

The approximately U-shaped plate member 4321 has approximately the same configuration as the plate member 4321 shown in FIG. 19, and includes a side wall 432a and a pair of bent pieces 432b and 432b connected to both ends of the side wall 432a in the left-right direction. In the outer movable contact main body 432 shown in FIGS. 29 and 30, an inclined surface 432g is formed inside the bent piece 432b, which is inclined outward toward the upper side. When the movable contact 430 is moved in the up-down direction, each plate member 433 has its tip moved in the up-down direction while sliding on the inclined surface 432g.

An insertion hole 432f penetrating in the thickness direction is formed at the center of the bottom wall 432e. By inserting a shaft (drive shaft) 380 into the insertion hole 432f, the outer movable contact main body 432 is attached to the shaft (drive shaft) 380.

The shaft (drive shaft) 380 shown in FIGS. 29 and 30 includes a shaft main body 381 and a head 382. The shaft (drive shaft) 380 shown in FIG. 27 is also provided with a support member 383 attached around the shaft main body 381 to support the movable contact main body 431 and the outer movable contact main body 432 from below.

The support member 383 is attached around the shaft main body 381 after the shaft main body 381 is inserted into the insertion holes 433a and 432f of the movable contact main body 431 and the outer movable contact main body 432. Thus, the movable contact main body 431 and the outer movable contact main body 432 are attached to the shaft (drive shaft) 380 while being sandwiched between the head 382 and the support member 383.

In FIGS. 29 and 30, the bottom wall 432e, the remaining one plate member 433, the other one plate member 433, and the one plate member 433 are stacked in this order from below. In a state of being stacked in this order, the movable contact main body 431 and the outer movable contact main body 432 are attached to the shaft (drive shaft) 380 by inserting the shaft main body 381 into the respective insertion holes 433a and 432f from above.

In FIGS. 29 and 30, when the first and second fixed terminals 420A and 420B are in a non-conductive state, the both ends of each plate member 433 in the left-right direction have different height positions. To be more specific, the lower the plate member 433, the lower the height position of both ends in the left-right direction. However, the height positions of both ends of each plate member 433 in the left-right direction may be approximately the same when the first and second fixed terminals 420A and 420B are set in a non-conductive state.

In FIGS. 29 and 30, when the first and second fixed terminals 420A and 420B are brought into a non-conductive state, the height position of the bent piece 432b is set lower than the height positions of both ends in the left-right direction of the plate member 433 disposed at the top. However, when the first and second fixed terminals 420A and 420B are set in a non-conductive state, the height position of the bent piece 432b may also be set approximately the same as the height positions of the both ends in the left-right direction of the plate member 433 disposed at the top.

In FIGS. 29 and 30, again, in an assembled state of the contact device 10, the first contact unit 4311A of the movable contact main body 431 is opposed to the inner side of the bottom surface 421aA of the first fixed terminal 420A in the left-right direction. Meanwhile, the bent piece 432b defining the first gap D2 of the outer movable contact main body 432 is opposed to the outer side of the bottom surface 421aA of the first fixed terminal 420A in the left-right direction.

Likewise, the second contact unit 4311B of the movable contact main body 431 is opposed to the inner side of the bottom surface 421aB of the second fixed terminal 420B in the left-right direction. Meanwhile, the bent piece 432b defining the second gap D3 of the outer movable contact main body 432 is opposed to the outer side of the bottom surface 421aB of the second fixed terminal 420B in the left-right direction.

With such a configuration, when the shaft (drive shaft) 380 is moved upward (to one side) in the up-down direction (one direction), the movable contact 430 is also moved upward and comes into contact with the first and second fixed terminals 420A and 420B.

To be more specific, when the shaft (drive shaft) 380 is moved upward (to one side) in the up-down direction (one direction), the entire movable contact 430 (the movable contact main body 431 and the outer movable contact main body 432) is first moved upward.

When the entire movable contact 430 is moved upward, a plurality of first contact pieces 4312A formed on the first contact unit 4311A of the movable contact main body 431 come into contact with the inner side of the bottom surface 421aA of the first fixed terminal 420A. Meanwhile, the bent piece 432b that defining the first gap D2 of the outer movable contact main body 432 comes into contact with the outer side of the bottom surface 421aA of the first fixed terminal 420A. Likewise, a plurality of second contact pieces 4312B formed on the second contact unit 4311B of the movable contact main body 431 come into contact with the inner side of the bottom surface 421aB of the second fixed terminal 420B. Meanwhile, the bent piece 432b defining the second gap D3 of the outer movable contact main body 432 comes into contact with the outer side of the bottom surface 421aB of the second fixed terminal 420B.

In the case of the configuration shown in FIGS. 29 and 30, when the entire movable contact 430 is moved upward, the first and second contact pieces 4312A and 4312B of the plate member 433 disposed at the top come into contact with the fixed terminal almost simultaneously. Thereafter, the first and second contact pieces 4312A and 4312B of the plate member 433 disposed in the middle and the four bent pieces 432b come into contact with the fixed terminal almost simultaneously.

When the bent piece 432b comes into contact with the fixed terminal, the upward movement of the bent piece 432b is restricted.

In FIGS. 29 and 30, the shaft (drive shaft) 380 can be moved upward even when the upward movement of the bending piece 432b is restricted.

Therefore, the bottom wall 432e of the outer movable contact main body 432 is flexibly deformed so as to protrude upward by the upward pressing with the shaft 380. When the bottom wall 432e is flexibly deformed, the plate member 433 disposed at the bottom is elastically deformed by being pressed upward in a state of having both tips in sliding contact with the inclined surface 432g. That is, the first and second contact pieces 4312A and 4312B of the plate member 433 disposed at the bottom are elastically deformed while sliding on the inclined surface 432g.

Thus, the first and second contact pieces 4312A and 4312B of the plate member 433 disposed at the bottom come into contact with the first and second fixed terminals 420A and 420B.

In the configuration shown in FIGS. 29 and 30, the top plate member 433 and the middle plate member 433 are elastically deformed by being pressed upward in a state of having both tips in contact with the bottom surface of the fixed terminal.

As described above, when the plate members 433 are elastically deformed, the gap formed between the plate members 433 adjacent to each other is eliminated, and the plate members 433 adjacent to each other come into surface contact with each other. When a current in the same direction flows through the plate members 433 in this state, force attracting each other acts on the plate member 433 disposed at the top and the plate member 433 arranged at the bottom. Accordingly, the frictional force generated between the plate members 433 adjacent to each other is increased, and the separation of the plate members 433 from the fixed terminals can be suppressed.

On the other hand, when the shaft (drive shaft) 380 is moved downward (to the other side) in the up-down direction (one direction), the first and second contact pieces 4312A and 4312B are relatively moved in the direction of approaching each other by the elastic restoring force of each plate member 433 and the bottom wall 432e.

Then, when the plate members 433 and the bottom wall 432e are returned to the initial state, the entire movable contact 430 is moved downward and separated from the first and second fixed terminals 420A and 420B.

When the first and second fixed terminals 420A and 420B are set in a non-conductive state, the height position of the bent piece 432b may be set higher than the height positions of both ends of each plate member 433 in the left-right direction. With this configuration, when the entire movable contact 430 is moved upward, the outer movable contact main body 432 can be brought into contact with each fixed terminal before the movable contact main body 431 and separated from each fixed terminal after the movable contact main body 431.

Thus, the same advantageous effects as those achieved with the configuration shown in FIG. 27 can also be achieved with the contact device 10 having the configuration shown in FIGS. 29 and 30.

FIGS. 29 and 30 also illustrates an example where two approximately U-shaped plate members 4321 elongated in the left-right direction are used to form the outer movable contact main body 432 disposed around the first contact unit 4311A and the second contact unit 4311B of the movable contact main body 431. However, the configuration of the outer movable contact main body 432 is not limited thereto. For example, the first outer movable contact main body 432A shown in FIG. 20 and the first outer movable contact main body 432A or the second outer movable contact main body 432B described as a modified example of FIG. 19 may be used.

FIGS. 29 and 30 also illustrates an example where a plurality of plate members 433, each having the first contact piece 432A and the first contact piece 432B formed thereon, are used and a plurality of the plate members 433 are stacked in the up-down direction (one direction) to form the movable contact main body 431. However, the configuration of the movable contact main body 431 is not limited thereto.

For example, the first movable-side plate members 433A having the first contact pieces 4312A formed thereon are stacked in the up-down direction to form a stacked body including the first contact unit 4311A having the plurality of first contact pieces 4312A formed thereon, and the stacked body may be used as the movable contact main body 431.

The movable contact main body 431 may be formed by electrically connecting the above stacked body to a member that is provided separately from the stacked body and includes the second contact unit 4311B. As a method of electrically connecting the stacked body having the first contact unit 4311A and the member having the second contact unit 4311B, there are, for example, a method of directly connecting the two, a method of electrically connecting the both through a holding member 464 or a bottom wall 432e formed of a conductive material, and the like.

The member having the second contact unit 4311B may be a single plate member arranged in a state where the thickness direction is approximately aligned with the up-down direction. In this event, the contact with the second fixed terminal 420B may be made at one spot or at a plurality of spots.

The member having the second contact unit 4311B may be a stacked body formed by stacking the second movable-side plate members 433B having the second contact pieces 4312B formed thereon in the up-down direction. This stacked body includes the second contact unit 4311B having the plurality of second contact pieces 4312B formed thereon.

Thus, the same advantageous effects as those achieved with the configuration shown in FIGS. 29 and 30 can also be achieved.

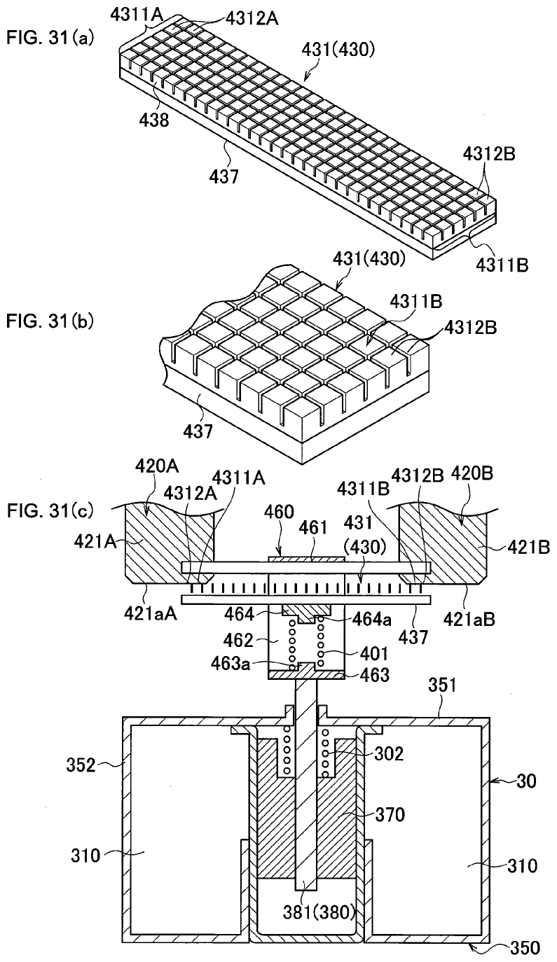

Alternatively, the contact device 10 may also have a configuration shown in FIG. 31.

To be more specific, a movable contact 430 shown in FIG. 31 also includes a movable contact main body 431 including a first contact unit 4311A that comes into contact with a first fixed terminal 420A and a second contact unit 4311B that comes into contact with a second fixed terminal 420B. In FIG. 31, a plate member 438 formed to be flexible by using a conductive resin or the like is provided on a base part 437 formed to be rigid using a conductive material, thereby forming a movable contact main body 431 elongated in the left-right direction. The contour shape of the base part 437 in plan view is approximately the same as that of the plate member 438. Therefore, the plate member 435 is placed on the upper surface of the base part 437 in a state where the entire plate member is prevented from being significantly deflected.

Furthermore, slits are formed in a lattice pattern in the upper part of the plate member 438. By forming slits in a lattice pattern in the upper part of the plate member 438, a plurality of projections connected at the lower part are formed in the upper part of the plate member 438. The plurality of projections can be flexibly deformed separately and independently.

The movable contact 430 shown in FIG. 31 is also held by the holder 460 in a state of being movable in the up-down direction (one direction) relative to the holder 460.

A contact pressure spring 401 is disposed between a holding member 464 for placing and holding the movable contact 430 on top and a bottom wall 463 of the holder 460. This contact pressure spring 401 presses the movable contact 430 upward through the holding member 464.

With such a configuration, when the shaft (drive shaft) 380 is moved upward (to one side) in the up-down direction (one direction), the movable contact 430 is also moved upward and comes into contact with the first and second fixed terminals 420A and 420B. In this event, the plurality of projections formed in the upper part on one side of the movable contact main body 431 in the left-right direction come into contact with the bottom surface 421aA of the first fixed terminal 420A. At the same time, the plurality of projections formed in the upper part on the other side of the movable contact main body 431 in the left-right direction also come into contact with the bottom surface 421aB of the second fixed terminal 420B.

On the other hand, when the shaft (drive shaft) 380 is moved downward (to the other side) in the up-down direction (one direction), the movable contact 430 is also moved downward and separated from both of the first and second fixed terminals 420A and 420B.

Thus, the movable contact 430 shown in FIG. 31 also includes the movable contact main body 431, and the movable contact main body 431 includes the first contact unit 4311A and the second contact unit 4311B. The first contact unit 4311A and the second contact unit 4311B are electrically connected to each other through another portion of the movable contact main body 431 (the central portion in the left-right direction of the plate member 438 or the base part 437).

In the movable contact 430 shown in FIG. 31, the plurality of projections formed on the upper part on one side of the movable contact main body 431 in the left-right direction correspond to the plurality of first contact pieces 4312A that come into contact with the first fixed terminal 420A. Likewise, the plurality of projections formed on the upper part on the other side of the movable contact main body 431 in the left-right direction correspond to the plurality of second contact pieces 4312B that come into contact with the second fixed terminal 420B.

In the movable contact 430 shown in FIG. 31, the projections are flexibly deformed separately and independently. That is, at least one of the plurality of first contact pieces 4312A can be moved relative to the other first contact pieces 4312A. Likewise, at least one of the plurality of second contact pieces 4312B can be moved relative to the other second contact pieces 4312B.

Thus, the same advantageous effects as in the above embodiment can also be achieved with the contact device 10 having the configuration shown in FIG. 31.

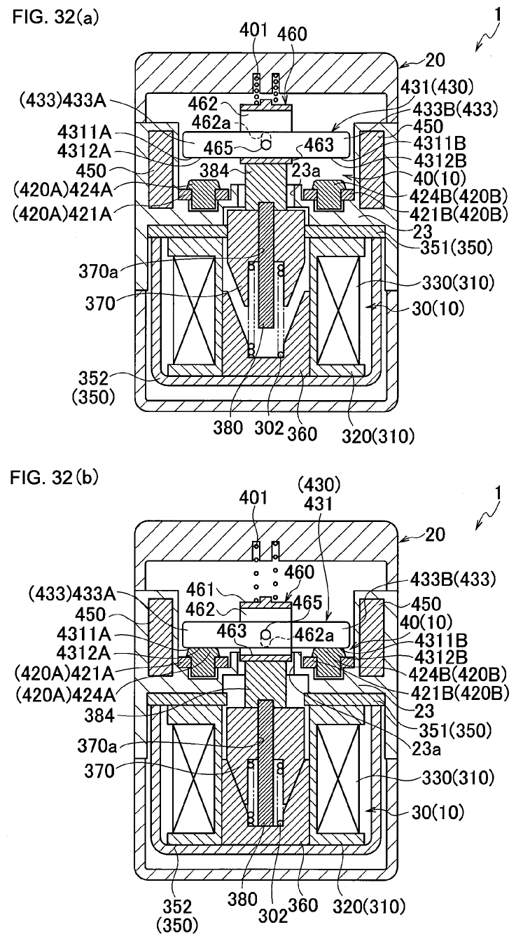

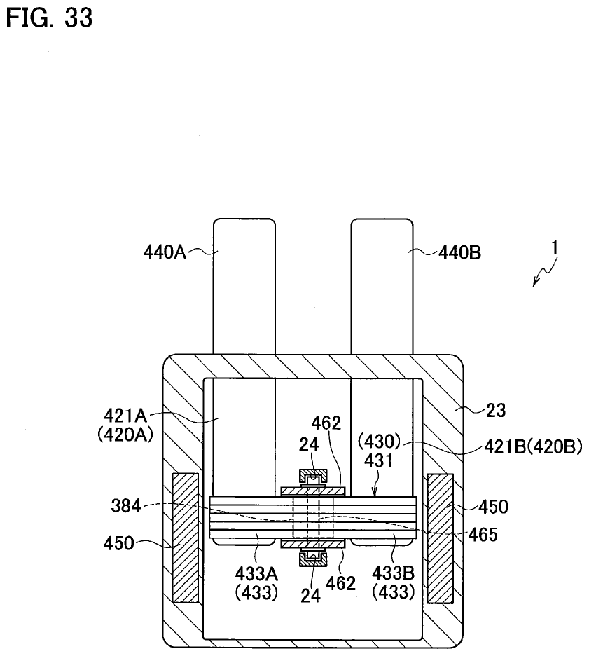

Alternatively, an electromagnetic relay 1 shown in FIGS. 32 and 33 may be realized.

The electromagnetic relay 1 shown in FIGS. 32 and 33 is equipped with a contact device 10 configured by integrally combining a lower drive block (drive unit) 30 and an upper contact block (contact unit) 40. To be more specific, the electromagnetic relay 1 equipped with the contact device 10 is formed by housing the contact device 10 in a case 20 formed of a resin material into an approximately hollow box shape.

The drive block 30 includes a coil unit 310. The coil unit 310 includes a coil 330 that generates a magnetic flux when energized, and a hollow cylindrical coil bobbin 320 around which the coil 330 is wound.

When the coil 330 is energized, the drive block 30 is driven, and the drive of the drive block 30 opens and closes the contacts of the contact block 40. In the electromagnetic relay 1 shown in FIGS. 32 and 33, again, the contact block 40 has a pair of contacts formed herein. In FIGS. 32 and 33, one of the contacts of the contact block 40 is formed by a first fixed contact 424A provided in the first fixed terminal 420A and a portion of the movable contact 430 that comes into contact with the first fixed contact 424A. On the other hand, the other contact is formed by a second fixed contact 424B provided in the second fixed terminal 420B and a portion of the movable contact 430 that comes into contact with the second fixed contact 424B. Thus, in FIGS. 32 and 33, again, opening and closing of the contacts of the contact block 40 can be switched by driving the drive block 30 or stopping the drive of the drive block 30. That is, conduction and non-conduction between the first fixed terminal 420A and the second fixed terminal 420B can be switched by switching on and off of the drive block 30.

The drive block 30 includes a yoke 350 disposed around the coil 330. The yoke 350 can be formed using a magnetic material, for example, and includes a rectangular yoke upper plate 351 disposed on the upper end surface side of the coil bobbin 320 and a rectangular yoke main body 352 disposed on a lower end surface side and a side surface side of the coil bobbin 320.

The drive block 30 includes a fixed iron core (fixed-side member) 360 that is inserted into the cylinder of the coil bobbin 320 and is magnetized by the energized coil 330. The drive block 30 further includes a movable iron core (movable-side member) 370 that is opposed to the fixed iron core 360 in the up-down direction (axial direction) and is disposed inside the cylinder of the coil bobbin 320.

Here, in FIGS. 32 and 33, the fixed iron core 360 is arranged below and the movable iron core 370 is arranged above. To be more specific, a return spring 302 is mounted on the upper surface of the fixed iron core 360, and the movable iron core 370 is disposed above the fixed iron core 360 in a state of being biased in a direction away from the fixed iron core 360 by the return spring 302.

There is also an insertion hole 370a formed in the center of the movable iron core 370, and a shaft (drive shaft) 380 is inserted into the insertion hole 370a. A regulating member 384 is connected to the upper end of the shaft 380 to regulate the movement toward the fixed terminals (first and second fixed terminals 420A and 420B) of the movable contact 430 when the first and second fixed terminals 420A and 420B are in a non-conductive state (see FIG. 32(a)).

Above the drive block 30, a contact block 40 is provided, which opens and closes the contact according to turning on and off of current supply to the coil 330.

The contact block 40 includes a first fixed terminal 420A and a second fixed terminal 420B spaced apart from the first fixed terminal 420A. The contact block 40 further includes a movable contact 430 that switches conduction and non-conduction between the first and second fixed terminals 420A and 420B by moving relative to the first and second fixed terminals 420A and 420B.

The first fixed terminal 420A is formed of a conductive material and arranged to be elongated in the front-rear direction in the state shown in FIG. 33. The first fixed terminal 420A includes an approximately rectangular plate-shaped (approximately columnar) first fixed terminal main body 421A, and a first fixed contact 424A is attached to one end of the first fixed terminal main body 421A.

In FIGS. 32 and 33, the case 20 is provided with a partition wall 23 that vertically defines an internal space. In the center of the partition wall 23, an insertion hole 23a is formed, through which the regulating member 384 can be inserted.

The first fixed terminal main body 421A having the first fixed contact 424A attached thereto is arranged on the partition wall 23. In this event, the first fixed terminal main body 421A is disposed on the partition wall 23 in a state of having the other end side penetrating through the case 20 and protruding outside the case 20. The portion protruding outside the case 20 serves as a first bus bar (first conductive member) 440A connected to an external load and the like.

On the other hand, the second fixed terminal 420B is also formed of a conductive material and arranged to be elongated in the front-rear direction in the state shown in FIG. 33. The second fixed terminal 420B also includes an approximately rectangular plate-shaped (approximately columnar) second fixed terminal main body 421B, and a second fixed contact 424B is attached to one end of the second fixed terminal main body 421B.

The second fixed terminal main body 421B having the second fixed contact 424B attached thereto is also arranged on the partition wall 23. To be more specific, the second fixed terminal main body 421B is arranged on the partition wall 23 in a state of having the other end side penetrating the case 20 and protruding outside the case 20. The portion protruding outside the case 20 serves as a second bus bar (second conductive member) 440B connected to the external load or the like.

As described above, in FIGS. 32 and 33, the first fixed terminal 420A and the second fixed terminal 420B are spaced apart from each other so as to be lined up in the left-right direction.

In the space formed above partition wall 23 of case 20, the movable contact 430 is disposed so as to be movable relative to the first and second fixed terminals 420A and 420B as the shaft 380 is moved in the up-down direction.

In FIGS. 32 and 33, the movable contact 430 is held by the holder 460. The holder 460 can be formed using, for example, an insulating resin or the like. The holder 460 has an approximately rectangular cylindrical shape with both sides opened in the left-right direction (direction in which the first and second fixed terminals 420A and 420B are arranged side by side), and includes a top wall 461, side walls 462 and 462, and a bottom wall 463.

In FIGS. 32 and 33, again, as in the above embodiment, the movable contact 430 is held by the holder 460 in a state of being movable in the up-down direction relative to the holder 460.

In FIGS. 32 and 33, again, a contact pressure spring 401 ensures contact pressure between the movable contact 430 and the first fixed terminal 420A and contact pressure between the movable contact 430 and the second fixed terminal 420B. The contact pressure spring 401 is formed of a coil spring and arranged with its axial direction directed in the up-down direction.

Here, in FIGS. 32 and 33, the contact pressure spring 401 is disposed between the top wall of the case 20 and the top wall 461 of the holder 460, and presses the movable contact 430 downward through the top wall 461. A regulating member 384 is disposed below the bottom wall 463. This regulating member 384 regulates downward movement of the movable contact 430 at least when the first and second fixed terminals 420A and 420B are in a non-conductive state.

With such a configuration, when the coil 330 is not energized, the movable iron core 370 is moved in a direction away from the fixed iron core 360 by the elastic force (elastic restoring force) of the return spring 302. In this event, the holder 460 is pushed upward by the regulating member 384, and the movable contact 430 is separated from the first and second fixed terminals 420A and 420B as shown in FIG. 32(a). The movable contact 430 is moved to a position where the support shaft 465 comes into contact with the lower ends of the long holes 462a and 462a by its own weight (see FIG. 32(a)). A biasing member may be arranged between the top wall 461 and the movable contact 430 to move the support shaft 465 to a position where the support shaft 465 comes into contact with the lower ends of the long holes 462a and 462a with the biasing force of the biasing member.

Then, when the coil 330 is energized from the off state, the movable iron core 370 is attracted to the fixed iron core 360 against the elastic force (elastic restoring force) of the return spring 302 by the electromagnetic force, and is moved downward so as to approach the fixed iron core 360. As the movable iron core 370 is moved downward, the shaft 380 and the regulating member 384 are also moved downward, and the holder 460 and the movable contact 430 are also moved downward. When the movable contact 430 is moved downward, the movable contact 430 comes into contact with the first fixed contact 424A of the first fixed terminal 420A and the second fixed contact 424B of the second fixed terminal 420B. Thus, the first and second fixed terminals 420A and 420B are electrically connected to turn on the electromagnetic relay 1 (contact device 10) (see FIG. 32(b)).

FIG. 32(b) illustrates an example where the regulating member 384 comes into contact with the holder 460 even when the movable contact 430 is in contact with the first and second fixed terminals 420A and 420B. However, the regulating member 384 may also be configured to be separated from the holder 460 when the movable contact 430 is in contact with the first and second fixed terminals 420A and 420B.

The contact pressure spring 401 is arranged so that force moving the holder 460 downward acts even when the movable contact 430 is in contact with the first and second fixed terminals 420A and 420B. The movable contact 430 is held by the holder 460 in a state of being movable in the up-down direction relative to the holder 460.

Therefore, the holder 460 is moved downward relative to the movable contact main body 431 in contact with the first and second fixed terminals 420A and 420B. That is, the movable contact main body 431 is moved upward relative to the holder 460 in a state of being in contact with the first and second fixed terminals 420A and 420B. In this event, the movable contact 430 is moved, relative to the holder 460, to a position where the support shaft 465 comes into contact with the upper ends of the long holes 462a and 462a (see FIG. 32(b)).

In FIGS. 32 and 33, a pair of guide grooves 24 and 24 for accommodating both ends of the support shaft 465 are formed to ensure that the movable contact 430 is more reliably moved in the up-down direction.

In FIGS. 32 and 33, an arc extinguishing magnet 450 is embedded in the case 20 to suppress an arc generated between the movable contact 430 and the first fixed terminal 420A and an arc generated between the movable contact 430 and the second fixed terminal 420B.

In FIGS. 32 and 33, again, the movable contact 430 includes a movable contact main body 431, and the movable contact main body 431 includes a first contact unit 4311A that comes into contact with the first fixed terminal 420A. The movable contact main body 431 further includes a second contact unit 4311B that is electrically connected to the first contact unit 4311A and comes into contact with the second fixed terminal 420B.

The first contact unit 4311A includes a plurality of first contact pieces 4312A that come into contact with the first fixed terminal 420A, and the second contact unit 4311B includes a plurality of second contact pieces 4312B that come into contact with the second fixed terminal 420B.

To be more specific, the movable contact main body 431 includes five (a plurality of) plate members 433 having the first contact piece 4312A on one side and the second contact piece 4312B on the other side. The five (plurality of) plate members 433 are stacked in the front-rear direction (direction intersecting with the moving direction of the movable contact 430 and the direction in which the first and second fixed terminals 420A and 420B are arranged side by side) to form the movable contact main body 431.

The same advantageous effects as those achieved with the electromagnetic relay 1 and the contact device 10 in the above embodiment can also be achieved.

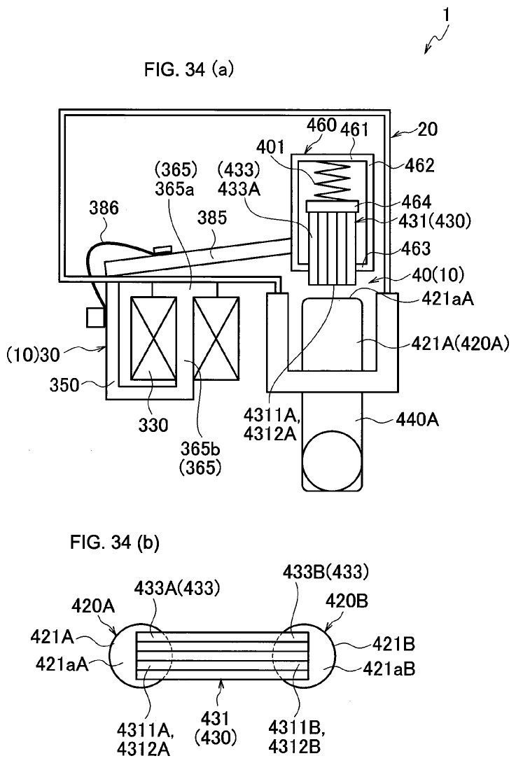

An electromagnetic relay 1 shown in FIG. 34 may also be realized.

The electromagnetic relay 1 shown in FIG. 34 is equipped with a contact device 10 configured by integrally combining a drive block (drive unit) 30 and a contact block (contact unit) 40. To be more specific, the electromagnetic relay 1 equipped with the contact device 10 is formed by attaching the contact device 10 to a case 20 formed in an approximately hollow box shape. In FIG. 34, the contact device 10 is attached to the case 20 in a state of being partially housed in the case 20 and partially arranged outside the case 20. The electromagnetic relay 1 equipped with the contact device 10 can be formed by housing the contact device 10 in the case 20.

In FIG. 34, the drive block 30 includes an iron core 365 having a head part 365a and a shaft part 365b, and a coil 330 wound around the shaft part 365b of the iron core 365.

When the coil 330 is energized, the drive block 30 is driven, and the drive of the drive block 30 opens and closes the contacts of the contact block 40.

In the electromagnetic relay 1 shown in FIG. 34, again, a pair of contacts are formed in the contact block 40. In FIG. 34, one contact of the contact block 40 is formed by an upper surface 421aA of the first fixed terminal 420A and a portion of the movable contact 430 that comes into contact with the upper surface 421aA. The other contact is formed by an upper surface 421aB of the second fixed terminal 420B and a portion of the movable contact 430 that comes into contact with the upper surface 421aB.

As described above, in FIG. 34, again, opening and closing of the contact of the contact block 40 can be switched by driving the drive block 30 or stopping the drive of the drive block 30. That is, by switching on/off of the drive block 30, conduction and non-conduction between the first and second fixed terminals 420A and 420B can be switched.

The drive block 30 includes a yoke 350 disposed around the coil 330. The yoke 350 is formed of a magnetic material into an approximately L-shape. The yoke 350 and the iron core 365 are integrally fixed (connected). An approximately cylindrical coil bobbin 320 may be used, and the iron core 365 may be inserted into the cylinder of the coil bobbin 320 and the coil 330 may be wound around the outer surface of the coil bobbin 320.

In FIG. 34, the iron core 365, the coil 330, and the yoke 350 are attached to the case 20 from outside.

The drive block 30 includes an approximately plate-shaped armature 385, and the armature 385 is disposed inside the case 20. The armature 385 is swingably supported on the yoke 350 by a hinge spring 386 bent into an approximately L-shape. Thus, in FIG. 34, the armature 385 and the head 365a of the iron core 365 are opposed to each other with the case 20 interposed therebetween.

Furthermore, a holder 460 for holding the movable contact 430 is connected to the tip of the armature 385.

The contact block 40 also includes a first fixed terminal 420A and a second fixed terminal 420B arranged apart from the first fixed terminal 420A. The contact block 40 further includes a movable contact 430 that switches conduction and non-conduction between the first and second fixed terminals 420A and 420B by moving relative to the first and second fixed terminals 420A and 420B.

The first fixed terminal 420A is made of a conductive material and arranged to be elongated in the up-down direction in a state shown in FIG. 34(a). The first fixed terminal 420A includes an approximately cylindrical (approximately columnar) first fixed terminal main body 421A, and an upper surface 421aA of the first fixed terminal main body 421A serves as a first fixed contact.

The first fixed terminal main body 421A is fixed to the case 20 in a state of having the other end side penetrating the case 20 and protruding outside the case 20. This portion protruding outside the case 20 serves as a first bus bar (first conductive member) 440A connected to an external load or the like.

On the other hand, the second fixed terminal 420B is also formed of a conductive material and arranged to be elongated in the up-down direction in a state shown in FIG. 34(a). The second fixed terminal 420B also includes an approximately cylindrical (approximately columnar) second fixed terminal main body 421B, and an upper surface 421aB of the second fixed terminal main body 421B serves as a second fixed contact.

The second fixed terminal main body 421B is fixed to the case 20 in a state of having the other end side penetrating the case 20 and protruding outside the case 20. This portion protruding outside the case 20 serves as a second bus bar (second conductive member) 440B connected to the external load or the like.

In FIG. 34, again, the first and second fixed terminals 420A and 420B are spaced apart from each other so as to be arranged in the left-right direction.

The case 20 can be formed entirely of an insulating material or can be formed partially of a conductive material. In this event, it is preferable that at least a portion of the case 20 to which the fixed terminals (first and second fixed terminals 420A and 420B) are fixed is formed of an insulating material. At least a portion of the case 20 interposed between the armature 385 and the head 365a of the iron core 365 can also be formed of a magnetic material.

In FIG. 34, the movable contact 430 is arranged in the case 20 so as to be movable relative to the first and second fixed terminals 420A and 420B as the armature 385 swings.

To be more specific, the movable contact 430 is held by the holder 60 connected to the tip of the armature 385, thus making the movable contact 430 movable relative to the first and second fixed terminals 420A and 420B as the armature 385 swings. The holder 460 can be formed of an insulating resin or the like, for example. The holder 460 has an approximately rectangular cylindrical shape with both sides opened in the left-right direction (direction in which the first and second fixed terminals 420A and 420B are arranged side by side), and includes a top wall 461, side walls 462 and 462, and a bottom wall 463.

In FIG. 34, again, the movable contact 430 is held by the holder 460 in a state of being movable in the up-down direction relative to the holder 460.

A contact pressure spring 401 ensures contact pressure between the movable contact 430 and the first fixed terminal 420A and contact pressure between the movable contact 430 and the second fixed terminal 420B. The contact pressure spring 401 is formed of a coil spring and arranged with its axial direction directed in the up-down direction.

Here, in FIG. 34, the contact pressure spring 401 is disposed between the top wall 461 of the holder 460 and the holding member 464 for holding the movable contact 430 disposed therebelow, and presses the movable contact 430 downward through the holding member 464.

With such a configuration, when the coil 330 is not energized, the armature 384 is held in a separated state from the head 365a of the iron core 365 by the biasing force (upward biasing force) of the hinge spring 386. In this event, the movable contact 430 is in a state (off state) of being separated from the first and second fixed terminals 420A and 420B.

When the coil 330 is energized from the off state, the armature 384 is attracted to the head 365a of the iron core 365 against the elastic force (elastic restoring force) of the hinge spring 386 by the electromagnetic force, and moved downward so as to approach the iron core 365. Then, as the armature 384 is moved downward, the holder 460 and the movable contact 430 are also moved downward. Then, as the movable contact 430 is moved downward, the movable contact 430 comes into contact with the first and second fixed terminals 420A and 420B. Thus, the first and second fixed terminals 420A and 420B are electrically connected to turn on the electromagnetic relay 1 (contact device 10).

In FIG. 34, again, the movable contact 430 includes a movable contact main body 431, and the movable contact main body 431 includes a first contact unit 4311A that comes into contact with the first fixed terminal 420A. The movable contact main body 431 further includes a second contact unit 4311B that is electrically connected to the first contact unit 4311A and comes into contact with the second fixed terminal 420B.

The first contact unit 4311A includes a plurality of first contact pieces 4312A that come into contact with the first fixed terminal 420A, and the second contact unit 4311B includes a plurality of second contact pieces 4312B that come into contact with the second fixed terminal 420B.

To be more specific, the movable contact main body 431 includes five (a plurality of) plate members 433 having the first contact piece 4312A on one side and the second contact piece 4312B on the other side. The five (plurality of) plate members 433 are stacked in the front-rear direction (direction intersecting with the moving direction of the movable contact 430 and the direction in which the first and second fixed terminals 420A and 420B are arranged side by side) to form the movable contact main body 431.

Thus, the same advantageous effects as those achieved with the electromagnetic relay 1 and the contact device 10 in the above embodiment can also be achieved.

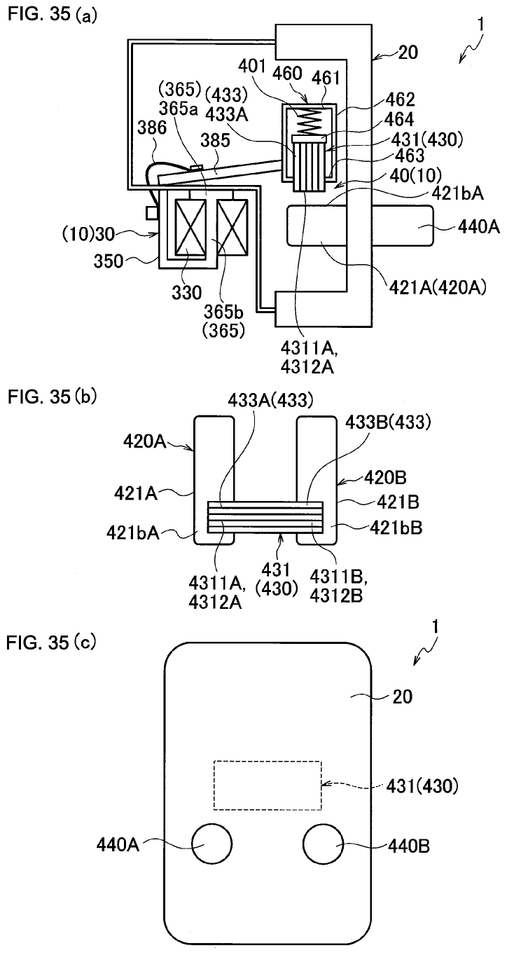

Alternatively, an electromagnetic relay 1 shown in FIG. 35 may also be realized.

The electromagnetic relay 1 shown in FIG. 35 has basically the same configuration as the electromagnetic relay 1 shown in FIG. 34. That is, the electromagnetic relay 1 (contact device 10) shown in FIG. 35 also switches on/off of the hinge type drive block (drive unit) 30, thus making it possible to switch conduction and non-conduction between the first and second fixed terminals 420A and 420B by moving the movable contact 430 relative to the first and second fixed terminals 420A and 420B.

Here, the first fixed terminal 420A is disposed in the case 20 so as to be elongated in the front-rear direction in a state shown in FIG. 35(a). The first fixed terminal 420A includes an approximately cylindrical (approximately columnar) first fixed terminal main body 421A, and a side surface 421bA of the first fixed terminal main body 421A serves as a first fixed contact.

The second fixed terminal 420B is also disposed in the case 20 so as to be elongated in the front-rear direction in the state shown in FIG. 35(a). The second fixed terminal 420B also includes an approximately cylindrical (approximately columnar) second fixed terminal main body 421B, and a side surface 421bB of the second fixed terminal main body 421B serves as a second fixed contact.

In FIG. 35, again, the first and second fixed terminals 420A and 420B are spaced apart so as to be arranged in the left-right direction.

Thus, the same advantageous effects as those achieved with the electromagnetic relay 1 and the contact device 10 shown in FIG. 34 can also be achieved.

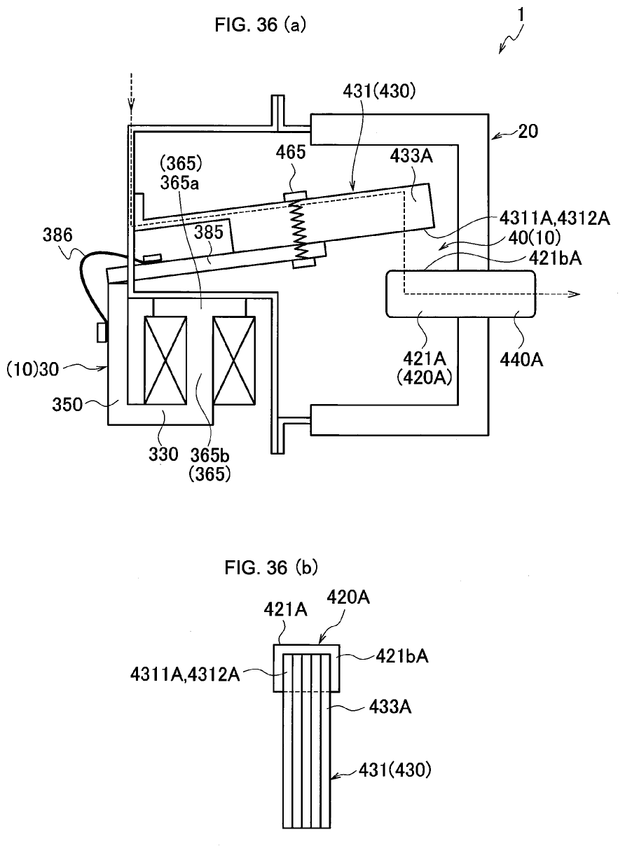

Alternatively, an electromagnetic relay 1 shown in FIG. 36 may also be realized.

In the electromagnetic relay 1 shown in FIG. 36, again, a hinge-type drive block (drive unit) 30 is used as in FIGS. 34 and 35. Here, no second fixed terminal 420B is provided in the electromagnetic relay 1 shown in FIG. 36. That is, in the electromagnetic relay 1 shown in FIG. 36, the movable contact 430 is brought into contact with and separated from the first fixed terminal 420A by switching on/off of the hinge-type drive block (drive unit) 30, thereby switching opening and closing of the contact of the contact block 40.

The first fixed terminal 420A is disposed in the case 20 so as to be elongated in the front-rear direction in a state shown in FIG. 36(a), and includes an approximately cylindrical (approximately columnar) first fixed terminal main body 421A. A side surface 421bA of the first fixed terminal main body 421A serves as a first fixed contact. The first fixed terminal main body 421A is fixed to the case 20 in a state of having the other end side penetrating the case 20 and protruding outside the case 20. This portion protruding outside the case 20 serves as a first bus bar (first conductive member) 440A connected to an external load or the like.

The drive block 30 includes a yoke 350 disposed around the coil 330. The yoke 350 is formed of a magnetic material into an approximately L-shape. The yoke 350 and the iron core 365 are integrally fixed (connected). An approximately cylindrical coil bobbin 320 may be used, and the iron core 365 may be inserted into the cylinder of the coil bobbin 320, and the coil 330 may be wound around the outer surface of the coil bobbin 320.

In FIG. 36, again, the iron core 365, the coil 330, and the yoke 350 are attached to the case 20 from outside.

A portion of the case 20 to which the first fixed terminal 420A is fixed is formed of an insulating material, and a portion of the iron core 365 to which the head 365a is attached is formed of a conductive material such as metal.

A movable contact 430 is mounted on the approximately plate-shaped armature 385 disposed in the case 20, and the movable contact 430 can be moved relative to the first fixed terminal 420A as the armature 385 swings.

Here, in FIG. 36, the movable contact 430 is attached to the armature 385 without using a holder. To be more specific, the movable contact 430 is directly attached to the armature 385 by using a support shaft 465 formed of a telescopic coil spring.

In FIG. 36, the movable contact 430 includes a movable contact main body 431, and the movable contact main body 431 includes a first contact unit 4311A that comes into contact with the first fixed terminal 420A. The first contact unit 4311A includes a plurality of first contact pieces 4312A that come into contact with the first fixed terminal 420A.

To be more specific, the movable contact main body 431 includes five (a plurality of) first movable-side plate members (first movable-side plate parts) 433A having the first contact piece 4312A on one side. The movable contact main body 431 is formed by stacking the five (plurality of) first movable-side plate members 433A in the front-rear direction (direction intersecting with the moving direction of the movable contact 430). Thus, in FIG. 36, the plurality of first movable-side plate members 433A are arranged so as to be lined up in the front-rear direction (direction intersecting with the moving direction of the movable contact 430).

The other ends of the five (plurality of) first movable-side plate members 433A are in contact with the portion of the case 20 formed of a conductive material, respectively. The first movable-side plate members 433A are electrically connected to an external load or the like through the portion of the case 20 formed of the conductive material.

With such a configuration, when the coil 330 is not energized, the armature 384 is held in a state of being separated from the head 365a of the iron core 365 by the biasing force (upward biasing force) of the hinge spring 386. In this event, the movable contact 430 is in a state (off state) of being separated from the first fixed terminal 420A.

When the coil 330 is energized from the off state, the armature 384 is attracted to the head 365a of the iron core 365 against the elastic force (elastic restoring force) of the hinge spring 386 by the electromagnetic force, and moved downward so as to approach the iron core 365. Then, as the armature 384 is moved downward, the movable contact 430 is also moved downward. When the movable contact 430 is moved downward, the movable contact 430 comes into contact with the first fixed terminal 420A. Thus, the movable contact 430 and the first fixed terminal 420A are electrically connected to turn on the electromagnetic relay 1 (contact device 10). The broken arrows in FIG. 36 indicate the flow of current.

In FIG. 36, the movable contact 430 comes into contact with the first fixed terminal 420A during the attraction of the armature 384 to the head 365a of the iron core 365. Therefore, after the movable contact 430 comes into contact with the first fixed terminal 420A, the armature 384 is attracted to the head 365a of the iron core 365 while the support shaft 465 is extended.

In FIG. 36, the armature 384 is attracted to the head 365a of the iron core 365 while the support shaft 465 is extended, and thus the elastic restoring force of the support shaft 465 ensures the contact pressure between the movable contact 430 and the first fixed terminal 420A. The movable contact 430 may be fixed to the armature 384 using a non-telescopic support shaft 465 (rigid support shaft 465), and the contact pressure between the movable contact 430 and the first fixed terminal 420A may be ensured by the force attracting the armature 384 to the head 365a of the iron core 365.

Thus, the same advantageous effects as those achieved with the electromagnetic relay 1 and the contact device 10 in the above embodiment can also be achieved.

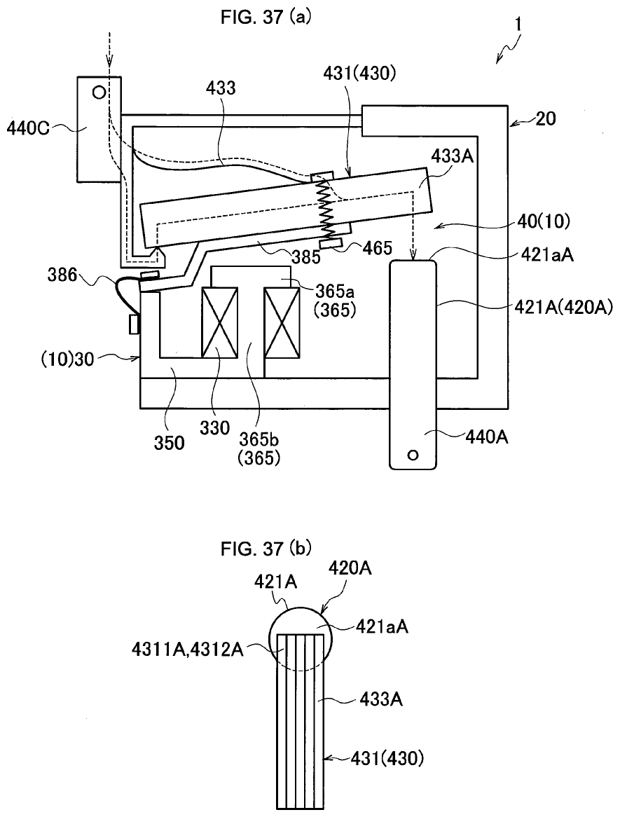

Alternatively, an electromagnetic relay 1 shown in FIG. 37 may also be realized.

As in FIG. 36, the electromagnetic relay 1 shown in FIG. 37 also switches on/off of a hinge type drive block (drive unit) 30 to bring he movable contact 430 into contact with and away from the first fixed terminal 420A, thereby switching opening and closing of the contact of the contact block 40.

Here, the first fixed terminal 420A is disposed in the case 20 so as to be elongated in the up-down direction in a state shown in FIG. 37(a). The first fixed terminal 420A includes an approximately cylindrical (approximately columnar) first fixed terminal main body 421A, and an upper surface 421aA of the first fixed terminal main body 421A serves as a first fixed contact. The first fixed terminal main body 421A is fixed to the case 20 in a state of having the other end side penetrating the case 20 and protruding outside the case 20. This portion protruding outside the case 20 serves as a first bus bar (first conductive member) 440A connected to an external load or the like.

The drive block 30 includes a yoke 350 disposed around the coil 330. The yoke 350 is formed of a magnetic material into an approximately L-shape. The yoke 350 and the iron core 365 are integrally fixed (connected). An approximately cylindrical coil bobbin 320 may be used, the iron core 365 may be inserted into the cylinder of the coil bobbin 320, and the coil 330 may be wound around the outer surface of the coil bobbin 320.

In FIG. 37, the drive block 30 is attached to the case 20 in a state where the yoke 350 forms a part of the case 20. A portion of the case 20 to which the first fixed terminal 420A is fixed is formed of an insulating material, and a part thereof is formed of a conductive material such as a metal.

A movable contact 430 is attached to an upper portion of the approximately plate-shaped armature 385 disposed in the case 20, and the movable contact 430 is movable relative to the first fixed terminal 420A along with the swing of the armature 385.

In FIG. 37, again, the movable contact 430 is directly attached to the armature 385 by using a support shaft 465 formed of a telescopic coil spring.

In FIG. 37, again, the movable contact 430 includes a movable contact main body 431, and the movable contact main body 431 includes a first contact unit 4311A that comes into contact with the first fixed terminal 420A. The first contact unit 4311A also includes a plurality of first contact pieces 4312A that come into contact with the first fixed terminal 420A.

To be more specific, the movable contact main body 431 includes five (a plurality of) first movable-side plate members (first movable-side plate parts) 433A, each having a first contact piece 4312A on one side. The movable contact main body 431 is formed by stacking the five (plurality of) first movable-side plate members 433A in the front-rear direction (direction intersecting with the moving direction of the movable contact 430). Thus, in FIG. 37, again, the plurality of first movable-side plate members 433A are arranged so as to be lined up in the front-rear direction (direction intersecting with the moving direction of the movable contact 430).

The five (plurality of) first movable-side plate members 433A have their other ends in contact with a portion of the case 20 formed of a conductive material. Further, a third bus bar (third conductive member) 440C is arranged so as to come into contact with the outside of the portion of the case 20 made of the conductive material. The movable contact main body 431 is electrically connected to the third bus bar (third conductive member) 440C through a lead wire 443. Thus, in FIG. 37, the movable contact 430 is electrically connected to an external load or the like through the third bus bar 440C and the portion of the case 20 formed of the conductive material, and is also electrically connected to the external load or the like through the third bus bar 440C and the lead wire 443. This can ensure more reliable electrical connection between the movable contact 430 and the external load or the like.

With such a configuration, when the coil 330 is not energized, the armature 384 is held in a state of being separated from the head 365a of the iron core 365 by the biasing force (upward biasing force) of the hinge spring 386. In this event, the movable contact 430 is in a state (off state) of being separated from the first fixed terminal 420A.

When the coil 330 is energized from the off state, the armature 384 is attracted to the head 365a of the iron core 365 against the elastic force (elastic restoring force) of the hinge spring 386 by the electromagnetic force, and moved downward so as to approach the iron core 365. Then, as the armature 384 is moved downward, the movable contact 430 is also moved downward. When the movable contact 430 is moved downward, the movable contact 430 comes into contact with the first fixed terminal 420A. Thus, the movable contact 430 and the first fixed terminal 420A are electrically connected to turn on the electromagnetic relay 1 (contact device 10). Note that the broken arrows in FIG. 37 indicate the flow of current.

In FIG. 37, again, the movable contact 430 comes into contact with the first fixed terminal 420A during the attraction of the armature 384 to the head 365a of the iron core 365. Therefore, after the movable contact 430 comes into contact with the first fixed terminal 420A, the armature 384 is attracted to the head 365a of the iron core 365 while the support shaft 465 is extended.

In FIG. 37, the armature 384 is attracted to the head 365a of the iron core 365 while the support shaft 465 is extended, and thus the elastic restoring force of the support shaft 465 ensures the contact pressure between the movable contact 430 and the first fixed terminal 420A. The movable contact 430 may be fixed to the armature 384 using a non-telescopic support shaft 465 (rigid support shaft 465), and the contact pressure between the movable contact 430 and the first fixed terminal 420A may be ensured by the force attracting the armature 384 to the head 365a of the iron core 365.

Thus, the same advantageous effects as those achieved with the electromagnetic relay 1 and the contact device 10 shown in FIG. 36 can also be achieved.

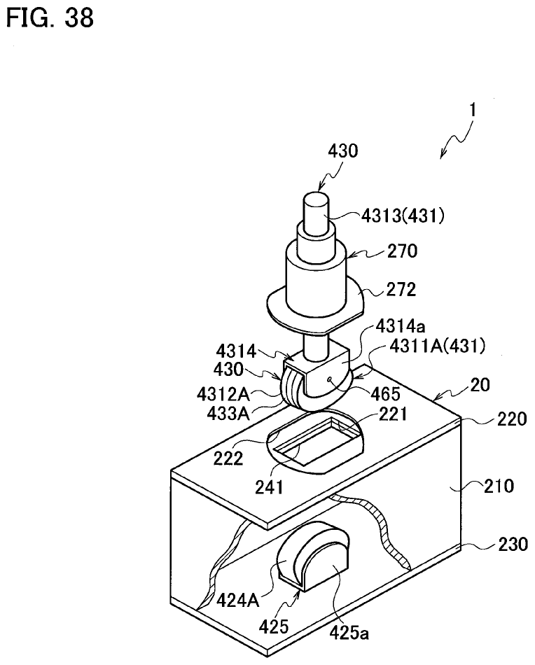

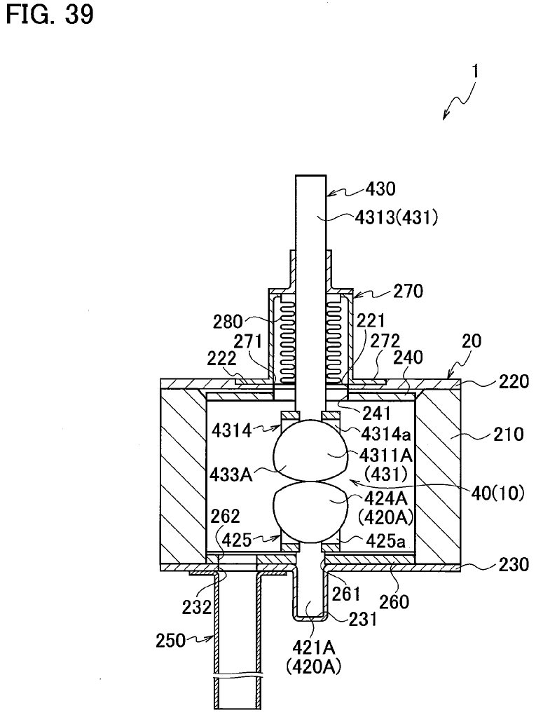

Alternatively, an electromagnetic relay 1 shown in FIGS. 38 to 40 may also be realized.

The electromagnetic relay 1 shown in FIGS. 38 to 40 is equipped with a contact device 10 configured by integrally combining a drive block (drive unit) and a contact block (contact unit) 40 (not shown). To be more specific, the contact block 40 is housed in a case 20 formed in an approximately hollow box shape, and the drive block connected to the contact block 40 is arranged outside the case 20. Thus, the electromagnetic relay 1 equipped with the contact device 10 is formed. The electromagnetic relay 1 equipped with the contact device 10 can also be formed by housing the contact device 10 in the case 20.

The electromagnetic relay 1 shown in FIGS. 38 to 40 switches on/off of the drive block to bring a movable contact 430 into contact with and away from a first fixed terminal 420A by moving the movable contact 430 in the up-down direction, thereby switching opening and closing of the contact of the contact block 40.

The case 20 includes an approximately rectangular cylindrical body part 210 made of a material such as ceramic or alumina, and a top wall 220 and a bottom wall 230 which are made of a material such as acid-free copper or 4-2 alloy and fixed so as to cover both ends of the body part 210 in the axial direction (up-down direction in FIG. 39).

A through-hole 221 is formed in the top wall 220, and the movable contact 430 is inserted into the through-hole 221.

An approximately oval fitting recess 222 is formed in an outer peripheral portion of the through-hole 221 on the outer surface (upper surface) side of the top wall 220.

An insulating plate 240 made of, for example, a ceramic material is disposed on the inner surface (lower surface) of the top wall 220. A communication hole 241 communicated with the through-hole 221 is formed in the insulating plate 240.

On the other hand, a fitting recess 231 protruding outward (downward) is formed in the bottom wall 230, and the first fixed terminal main body 421A of the first fixed terminal 420A is fitted into the fitting recess 231 in a state of extending in the up-down direction. The first fixed terminal main body 421A is formed in an approximately rod shape (approximately columnar shape) using a material such as acid-free copper.

A through-hole 232 is formed in the bottom wall 230, and an air supply pipe 250 for supplying hydrogen gas or the like is connected to the through-hole 232. The air supply pipe 250 is disconnected to seal the case 20 after supplying hydrogen gas or the like into the case 20.

An insulating plate 260 made of, for example, a ceramic material is arranged on the inner surface (upper surface) of the bottom wall 230. The insulating plate 260 has a communication hole 261 communicated with the fitting recess 231 and a communication hole 262 communicated with the through-hole 232.

In FIGS. 38 to 40, an approximately cylindrical guide member 270 having an insertion opening 271 formed at one end, into which the movable contact main body 431 is inserted, is provided on the top wall 220 so as to protrude outward. The guide member 270 has a flange part 272 formed at the other end, having a shape (approximately oval shape) corresponding to the fitting recess 222. By fitting the flange part 272 into the fitting recess 222, the guide member 270 is provided on the top wall 220 with the inside communicated with the through-hole 221.

In FIGS. 38 to 40, the first fixed terminal 420A includes a first fixed terminal main body 421A formed in an approximately rod shape (approximately columnar shape) and a first fixed terminal contact 424A formed at a tip (upper end) of the first fixed terminal main body 421A. The first fixed contact 424A is formed in an approximately disc shape using a material such as tungsten, and is connected to the first fixed terminal main body 421A with a fixing jig 425 having a pair of holding pieces 425a and 425a.

On the other hand, the movable contact 430 includes a movable contact main body 431. The movable contact main body 431 includes a columnar part 4313 formed in an approximately rod shape (approximately columnar shape) using a material such as acid-free copper, and a first contact unit 4311A that comes into contact with the first fixed terminal 420A. The first contact unit 4311A is also formed in an approximately disc shape using a material such as tungsten, and is connected to the columnar part 4313 with a fixing jig 4314 having a pair of holding pieces 4314a and 4314a.

In FIGS. 38 to 40, the first contact unit 4311A includes a plurality of first contact pieces 4312A that come into contact with the first fixed terminal 420A.

To be more specific, by stacking three (a plurality of) first movable-side plate members 433A in the front-rear direction (direction intersecting with the moving direction of the movable contact 430), the movable contact main body 431 having the plurality of first contact pieces 4312A is formed. Thus, in FIGS. 38 to 40, again, the plurality of first movable-side plate members 433A are arranged so as to be lined up in the front-rear direction (direction intersecting with the moving direction of the movable contact 430). The three (plurality of) first movable-side plate members 433A are attached to the fixing jig 4314 using the support shaft 465.

A bellows member 280 is disposed in the guide member 270 so as to surround the entire circumference of the movable contact main body 431. The bellows member 280 has its one end airtightly connected to the guide member 270 and the other end airtightly connected to the movable contact main body 431.

Thus, in FIGS. 38 to 40, after the air supply pipe 250 is disconnected in an airtight manner, the internal space of the case 20 is hermetically sealed from the outside.

The bellows member 280 is configured to bias the movable contact 430 toward the first fixed terminal 420A even when the plurality of first contact pieces 4312A are separated from the first fixed contact 424A.

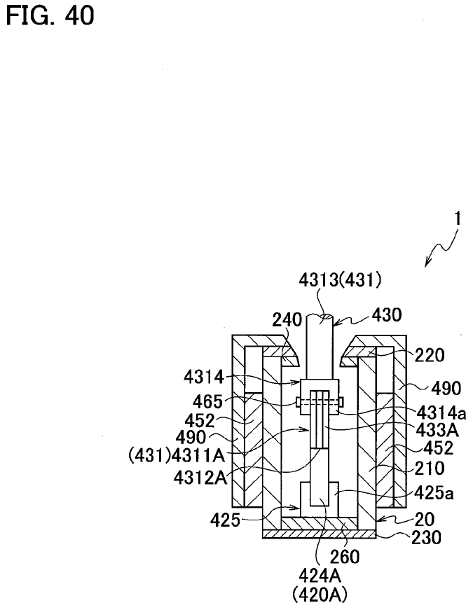

As shown in FIG. 40, permanent magnets 452 are disposed on either side of the case 20 in the front-rear direction (stacking direction of the plurality of first contact pieces 4312A). A yoke 490 is arranged outside the permanent magnets 452 so as to surround the permanent magnets 452.

With this configuration, when the drive block is not driven, the movable contact 430 is set in a state (off state) of being separated from the first fixed terminal 420A.

When the drive block is driven from the off state, the movable contact 430 is moved downward, and the three (plurality of) first contact pieces 4312A come into contact with the first fixed terminal main body 421A of the first fixed terminal 420A. Thus, the movable contact 430 and the first fixed terminal 420A are electrically connected to turn on the electromagnetic relay 1 (contact device 10).

In this event, the movable contact 430 is biased downward by the bellows member 280, and the contact pressure between the movable contact 430 and the first fixed terminal 420A is ensured by the bellows member 280.

Thus, the same advantageous effects as those achieved with the electromagnetic relay 1 and the contact device 10 in the above embodiment can also be achieved.

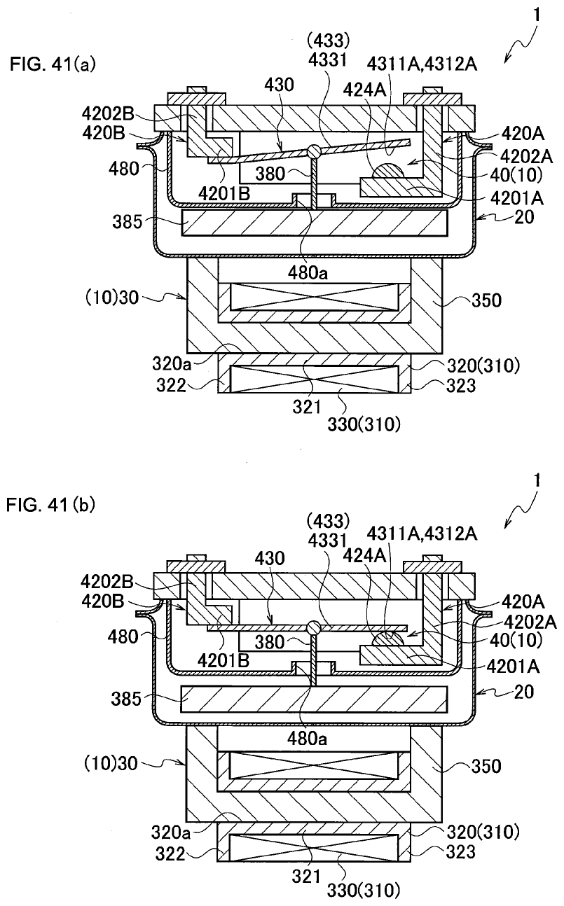

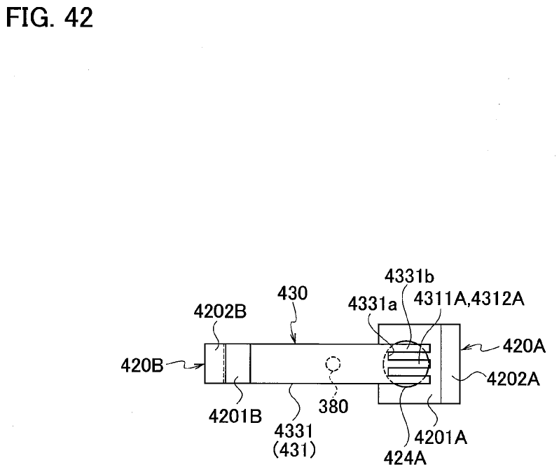

Also, an electromagnetic relay 1 shown in FIGS. 41 and 42 may also be realized.

The electromagnetic relay 1 shown in FIGS. 41 and 42 is equipped with a contact device 10 configured by integrally combining a drive block (drive unit) 30 and a contact block (contact unit) 40. To be more specific, the electromagnetic relay 1 equipped with the contact device 10 is formed by attaching the contact device 10 to a case 20 formed in an approximately hollow box shape. In FIGS. 41 and 42, the contact device 10 is attached to the case 20 in a state where the contact device 10 is partially housed in the case 20 and partially arranged outside the case 20. The electromagnetic relay 1 equipped with the contact device 10 can be formed by housing the contact device 10 in the case 20.

In FIGS. 41 and 42, the drive block 30 includes a coil unit 310. The coil unit 310 includes a coil 330 that generates a magnetic flux when energized, and a hollow cylinder coil bobbin 320 around which the coil 330 is wound.

When the coil 330 is energized, the drive block 30 is driven, and the drive of the drive block 30 opens and closes the contacts of the contact block 40. Thus, in FIGS. 41 and 42, again, opening and closing of the contacts of the contact block 40 can be switched by driving the drive block 30 or stopping the drive of the drive block 30.

The coil bobbin 320 is formed of a resin which is an insulating material, and an insertion hole 320a penetrating in the left-right direction is formed at the center of the coil bobbin 320. The coil bobbin 320 includes an approximately cylindrical winding drum part 321 on the outer surface, around which the coil 330 is wound. The coil bobbin 320 includes: an approximately circular first flange part 322 that is connected to one end of the winding drum part 321 and protrudes radially outward of the winding drum part 321; and an approximately circular second flange part 323 that is connected to the other end of the winding drum part 321 and protrudes radially outward of the winding drum part 321.

The drive block 30 includes a yoke 350 formed of a magnetic material into an approximately U-shape. The yoke 350 is arranged in a state of having its central portion housed in the insertion hole 320a of the coil bobbin 320 and both ends follow the first and second flange parts 322 and 323, respectively.

In FIGS. 41 and 42, the coil unit 310 and the yoke 350 are attached to the case 20 from outside.

The drive block 30 includes an approximately plate-shaped armature 385, and the armature 385 is disposed inside the case 20. The armature 385 is coupled to the movable contact 430 via an approximately rod-like (approximately columnar) shaft 380. The connection between the shaft 380 and the armature 385 and the connection between the shaft 380 and the movable contact 430 can be performed using a method such as welding.

The contact block 40 further includes a first fixed terminal 420A and a second fixed terminal 420B arranged apart from the first fixed terminal 420A.

In FIGS. 41 and 42, the first fixed terminal 420A is formed in an approximately L-shape. To be more specific, the first fixed terminal 420A includes a first horizontal terminal piece 4201A and a first vertical terminal piece 4202A. The first horizontal terminal piece 4201A and the first vertical terminal piece 4202A are continuously and integrally formed. In FIGS. 41 and 42, the first horizontal terminal piece 4201A and the first vertical terminal piece 4202A are formed in a rectangular plate shape.

As a material of the first fixed terminal 420A, for example, conductive metal or the like can be used. As the conductive metal, for example, copper, copper alloy, or the like can be used.

A first fixed contact 424A having an approximately circular shape in plan view is provided on the upper surface of one end (left end in FIGS. 41 and 42) of the first horizontal terminal piece 4201A. Note that the shape of the first fixed contact 424A in plan view is not limited to a circular shape.

On the other hand, the second fixed terminal 420B is also formed in an approximately L-shape in FIGS. 41 and 42. To be more specific, the second fixed terminal 420B includes a second horizontal terminal piece 4201B and a second vertical terminal piece 4202B. The second horizontal terminal piece 4201B and the second vertical terminal piece 4202B are continuously and integrally formed. In FIGS. 41 and 42, the second horizontal terminal piece 4201B and the second vertical terminal piece 4202B are also formed in a rectangular plate shape. As a material of the second fixed terminal 420B, conductive metal or the like can be used. As the conductive metal, for example, copper, a copper alloy, or the like can be used.

The contact block 40 further includes a movable contact 430 that switches conduction and non-conduction between the first and second fixed terminals 420A and 420B by relatively moving relative to the first fixed terminal 420A.

In FIGS. 41 and 42, the movable contact 430 is formed in an approximately flat plate shape using a leaf spring made of a conductive metal, and has spring properties. As the conductive metal, for example, copper, a copper alloy, or the like can be used.

In FIGS. 41 and 42, one end (left side in FIGS. 41 and 42) of the movable contact 430 in the longitudinal direction (left-right direction) is fixed to the second horizontal terminal piece 4202B of the second fixed terminal 420B. As a method of fixing the movable contact 430 to the second horizontal terminal piece 4202B, a method such as caulking, screwing, and welding can be used for example.

Here, in FIGS. 41 and 42, the movable contact 430 includes a movable contact main body 431, and the movable contact main body 431 includes a first contact unit 4311A that comes into contact with the first fixed terminal 420A. The first contact unit 4311A includes a plurality of first contact pieces 4312A that come into contact with the first fixed terminal 420A.

To be more specific, the movable contact main body 431 is formed by using a plate member 4331 that has an approximately rectangular shape when viewed from the thickness direction. The plate member 4331 has a shape in which notches 4331a opened on the tip side and both sides in the thickness direction (up-down direction) are arranged in the short direction (longitudinal direction) at the other end (right side in FIGS. 41 and 42) in the longitudinal direction (left-right direction). That is, the plate member 4331 has a shape in which a plurality of projecting pieces 4331b separated by the notches 4331a are formed on the other side in the longitudinal direction.

While fixing one end of the plate member 4331 having such a shape to the second horizontal terminal piece 4202B, the plurality of projecting pieces 4331b at the other end are opposed to the first fixed contact 424A of the first fixed terminal 420A. Thus, the plate member 4331 serves as a movable contact main body 431 having a plurality of first contact pieces 4312A. The movable contact main body 431 (movable contact 430) is fixed to the second horizontal terminal piece 4202B while being biased upward.

The case 20 can be formed entirely of an insulating material, or can be formed partially of a conductive material. In this event, it is preferable that at least a portion of the case 20 to which the fixed terminals (first and second fixed terminals 420A and 420B) are fixed is formed of an insulating material. Further, at least a portion of the case 20 to which the coil unit 310 and the yoke 350 are attached may be formed of a magnetic material.

Furthermore, in FIGS. 41 and 42, a partition member 480 is disposed in the case 20. The partition member 480 is made of an insulating material such as resin or ceramic and is formed in an approximately rectangular box shape with an open top, and separates a space where the first horizontal terminal piece 4201A of the first fixed terminal 420A, the second horizontal terminal piece 4201B of the second fixed terminal 420B, and the movable contact 430 are located from a space where the armature 385 is located. An insertion hole 480a for inserting the shaft 380 is formed in the bottom wall of the partition member 480.

With such a configuration, when the coil 330 is not energized, the armature 384 is held in a state of being separated from the yoke 350 by the upward biasing force of the movable contact 430. In this event, the movable contact 430 is set in a state (off state) of being separated from the first fixed terminal 420A.

When the coil 330 is energized from the off state, the armature 384 is attracted to the yoke 350 against the elastic force (elastic restoring force) of the movable contact 430 by the electromagnetic force, and moved downward so as to approach the yoke 350. As the armature 384 is moved downward, the movable contact 430 coupled to the armature 384 via the shaft 380 is displaced so as to bring the plurality of first contact pieces 4312A into contact with the first fixed contact 424A. Thus, the first and second fixed terminals 420A and 420B are electrically connected to turn on the electromagnetic relay 1 (contact device 10).

Thus, the same advantageous effects as those achieved with the electromagnetic relay 1 and the contact device 10 described in the above embodiment can also be achieved.

Note that it is also possible to provide no second fixed terminal 420B in the electromagnetic relay 1 of the type shown in FIGS. 41 and 42.

Although the preferred embodiment of the present invention has been described above, the present invention is not limited to the above embodiment, and various modifications are possible.

For example, a contact device can be formed by appropriately combining the configurations described in the above embodiment and modified examples thereof.

The present invention is also applicable to a contact device having three or more fixed terminals.

Also, the specifications (shape, size, layout, and the like) of each fixed terminal, movable contact, and other details can be appropriately changed.

This application claims priority based on Japanese Patent Application No. 2017-188532 filed on Sep. 28, 2017, the entire contents of which are incorporated herein by reference.

### INDUSTRIAL APPLICABILITY

The present invention can provide a contact device capable of further reducing electromagnetic repulsion force acting between a fixed terminal and a movable contact, and an electromagnetic relay equipped with the contact device.

1. A contact device comprising:
a first fixed terminal;
a movable contact that comes into contact with and away from the first fixed terminal by moving relative to the first fixed terminal; and
a drive unit that moves the movable contact, wherein
the movable contact includes a movable contact main body having a first contact unit that comes into contact with the first fixed terminal, and
the first contact unit includes a plurality of first contact pieces that come into contact with the first fixed terminal.

2. The contact device according to claim 1, wherein at least one of the plurality of first contact pieces is provided so as to be movable relative to the other first contact pieces.

3. The contact device according to claim 2, wherein, in a state where the first contact unit is in contact with the first fixed terminal, the plurality of first contact pieces are pressed against the first fixed terminal independently of the other first contact pieces by a biasing member.

4. The contact device according to claim 1, wherein
the movable contact main body includes a plurality of first movable-side plate parts having the first contact pieces formed thereon, and
the plurality of first movable-side plate parts are arranged so as to be lined up in a direction intersecting with a moving direction of the movable contact.

5. The contact device according to claim 1, wherein
the movable contact main body includes a plurality of first movable-side plate parts having the first contact pieces formed thereon, and
the plurality of first movable-side plate parts are arranged so as to be line up in a moving direction of the movable contact.

6. The contact device according to claim 4, wherein a first partition wall is interposed between two adjacent first movable-side plate parts.

7. The contact device according to claim 1, wherein the movable contact includes a first outer movable contact main body disposed around the first contact unit of the movable contact main body.

8. The contact device according to claim 7, wherein
the first outer movable contact main body is provided so as to be movable relative to the movable contact main body in the moving direction of the movable contact, and
when the movable contact is separated from the first fixed terminal, the first outer movable contact main body is disposed closer to the first fixed terminal than the movable contact main body.

9. The contact device according to claim 7, wherein
a first gap is provided between the movable contact main body and the first outer movable contact main body, and
when the movable contact is in contact with the first fixed terminal, the first fixed terminal has its tip entering the first gap.

10. The contact device according to claim 1, further comprising:
a second fixed terminal that is arranged in a state separated from the first fixed terminal and that is switched between conduction and non-conduction with the first fixed terminal by the movable contact, wherein
the movable contact main body includes a second contact unit that is electrically connected to the first contact unit and comes into contact with the second fixed terminal.

11. The contact device according to claim 10, wherein the second contact unit includes a plurality of second contact pieces that come into contact with the second fixed terminal.

12. The contact device according to claim 11, wherein at least one of the plurality of second contact pieces is provided so as to be movable relative to the other second contact pieces.

13. The contact device according to claim 12, wherein, in a state where the second contact unit is in contact with the second fixed terminal, the plurality of second contact pieces are pressed against the second fixed terminal independently of the other second contact pieces by a biasing member.

14. The contact device according to claim 11, wherein
the movable contact main body includes a plurality of second movable-side plate parts having the second contact pieces formed thereon, and
the plurality of second movable-side plate parts are arranged so as to be lined up in a direction intersecting with a moving direction of the movable contact and a direction in which the first fixed terminal and the second fixed terminal are arranged.

15. The contact device according to claim 11, wherein
the movable contact main body includes a plurality of second movable-side plate parts having the second contact pieces formed thereon, and
the plurality of second movable-side plate parts are arranged so as to be lined up in a moving direction of the movable contact.

16. The contact device according to claim 14, wherein
the movable contact main body includes a plurality of first movable-side plate parts having the first contact pieces formed thereon,
the plurality of second movable-side plate parts are each formed integrally with the first movable-side plate part, and
a plurality of plate members, each having the first contact piece on one side and the second contact piece on the other side, are arranged in alignment.

17. The contact device according to claim 14, wherein a second partition wall is interposed between two adjacent second movable-side plate parts.

18. The contact device according to claim 11, wherein the movable contact includes a second outer movable contact main body disposed around the second contact unit of the movable contact main body.

19. The contact device according to claim 18, wherein
the movable contact includes a first outer movable contact main body disposed around the first contact unit of the movable contact main body, and
the first outer movable contact main body and the second outer movable contact main body are integrally formed.

20. The contact device according to claim 18, wherein
the second outer movable contact main body is provided so as to be movable relative to the movable contact main body in the moving direction of the movable contact, and
when the first fixed terminal and the second fixed terminal are in a non-conductive state, the second outer movable contact main body is arranged closer to the second fixed terminal than the movable contact main body.

21. The contact device according to claim 18, wherein
a second gap is provided between the movable contact main body and the second outer movable contact main body, and
when the first fixed terminal and the second fixed terminal are in a conductive state, the second fixed terminal has its tip entering the second gap.

22. An electromagnetic relay comprising the contact device according to claim 1.
